(19) United States
(12) Patent Application Publication
(10) Pub. No.: US 2008/0208907 A1
(43) Pub. Date: Aug. 28, 2008

(54) Employment recruiting

(75) Inventors: Frank J. Tolve, San Mateo, CA (US); Greg Henson, San Mateo, CA (US)

Correspondence Address: THE LAW OFFICE OF ANTHONY M. PALAZZOLO JR., 285 PENDLETON HILL ROAD, NORTH STONINGTON, CT, 06359, US

(73) Assignee: INQHIRE, a California Corporation

(21) Appl. No.: 11/710,341

(22) Filed: Feb. 23, 2007

(51) Int. Cl. G06F 7/00

(52) U.S. Cl. 707/104.1

(57) ABSTRACT

The disclosure includes recruiting systems having a job definitions database (the definitions having subject-level job criteria and offerings), a workforce-profile database of individual profiles (the profiles having subject-level individual qualifications and individual preferences), an information manager, and a communications port for access to the system. The information manager interacts with the job definitions database, the workforce-profile database and the communications port to permit bi-directional subject-level matching between the job definitions database and the workforce-profile database and to permit information and queries to pass through the communications port. The disclosure also includes methods of matching individuals with job definitions that use systems and apparatus of the type described above. The methods include comparing job criteria of the job definitions database with qualifications of the workforce-profile database, and identifying individuals qualified for a job definition in response to detecting a match between predetermined ones of the criteria and the qualifications.

### BACKGROUND OF THE INVENTION

1. Field of the Invention

The present invention is directed to systems, processes, apparatus and software for efficient employment recruiting. More particularly, the invention relates to improvements in employment recruiting resulting from improved techniques for matching prospective employees having certain subject-level job qualifications and/or preferences with job definitions having certain subject-level criteria and/or benchmarks. Accordingly, the general objects of the invention are to provide novel systems, methods, apparatus and software of such character.

2. Description of the Related Art

In the last decade or two of the information age many fields of human endeavor have seen accelerating changes and improvements. Among the most important reasons for such advances has been the widespread availability of and advancements in information technology such as personal computers and the Internet. However, one area that has resisted profound change in this time is the field of employment recruiting. In particular, this field has not yet seen the magnitude of productivity increases resulting from computerized automation, as has virtually every other area of modern life in industrial societies. Accordingly, significant aspects of current employment recruiting practice involve archaic approaches to manually performing various tasks on the basis of non-quantified supposition and anecdotal information.

Naturally, some attempts have been made to automate/computerize some aspects of the field of recruiting. For example, some early efforts to improve individual sourcing involved warehousing résumés and related information in centralized employee databases. Such efforts allowed basic keyword searching capabilities, for example via the Internet, of text-based résumés to thereby allow prospective employers to find prospective employees with qualifications that match requirements of the job openings. Examples of such websites include Monster.com, Hot Jobs.com, Career Builder.com, Dice.com, etc. One potentially significant benefit of such web-based systems is that they are able to reach far more potential employers and potential employees. This vastly increases the number of participants that may benefit from reaching one another.

However, the basic technology underlying such systems is still based on browsing and/or rudimentary keyword searches of text-based résumés and only serves two basic functions. First, they may serve as electronic bulletin board systems for posting help wanted advertisements. This method is little better than, and essentially is, an electronic form of conventional help wanted classified ads customarily placed in newspapers for centuries. The second entails basic keyword searching of a centralized prospective employee database in the hope of finding qualified personnel who have previously posted their résumés. However, unless carefully utilized, keyword searching is a blunt instrument for detecting whether a prospective employee is qualified for a given position. This is, in part, because the prospective employees and prospective employer are not constrained in the use of their respective terminology and the inherent imprecision of such unconstrained use of language leads to both under-inclusion and over-inclusion when such searches are conducted. This effect is magnified still further by the existence of synonyms, homonyms, euphemisms and other linguistic complexities. Despite these serious deficiencies, the long-felt but unfulfilled need for improvements in this field have made such websites widely popular.

Somewhat counter-intuitively, the popularity of such websites actually makes them victims of their own success. For example, employers utilizing such websites have learned through experience that these websites are likely to inundate hiring departments with résumés and other information from either marginally qualified or obviously unqualified individuals. A related problem is that basic keyword searching is the only initial screening mechanism. Once they have received initial “results”, hiring personnel must then devote substantial time and resources to manually screening these search “results.” Yet another related problem is that jobs and/or résumés too often remain on such websites long after a prospective employee has found employment. Thus, even if a qualified individual is discovered using rudimentary keyword searching, there is still a chance that the, otherwise qualified, individual may be unavailable. In short, the time, effort, and expense associated with separating the many unqualified and/or unavailable individuals from the few qualified and available individuals have proven to be more trouble than it is worth.

Applicant tracking systems (ATSs) have also been available to prospective employers for some time. For the most part, ATSs are administrative tools that facilitate the assignment of job requisitions, the tracking of EEO data required by the Office of Federal Contracts Compliance (OFCCP), as well as comprehensive activity reporting. With ATSs, promising individuals are tracked after unqualified individuals have been manually culled and the interview process has begun. More advanced ATSs may provide for some question and answer capability, but all lack the ability to create the sort of sophisticated questions that are necessary to determine the qualifications of highly skilled knowledge workers. Moreover, they still rely on human intervention to determine which individuals are worthy of further consideration. Importantly, ATSs provide no integrated process to assist in the selection process. Under such regimes, activities are disjoint, not process-driven and collaborative. Examples of such applicant tracking systems include ProHire, Kennexa, Taleo, Ceridian, etc. These, and other tools like them, have been designed to track the flow of qualified individuals through the recruiting process, but are incapable of both the a priori identification of such individuals and the means to encourage them to apply for a job. Restated, such applicant tracking systems are observers, not agents, of an automated recruiting process.

In sum, one critical deficiency of the prior art is that very little to no automation exists in a conventional recruiting process. Indeed, the few advances that have been achieved in the sourcing phase and the use of recruiting websites have actually created inefficiencies/needless work in the selection phase because an ever increasing number of under-qualified individuals must be manually screened out. Further, while conventional applicant tracking systems exist, they too have provided few, if any, improvements in productivity.

Accordingly, there exists a need in the art for intelligent automation in the individual sourcing, screening and selection phases of the employee recruiting process.

Additionally, there exists a further need in the art for integrated sourcing, screening and selecting systems and processes.

Further, there exists a further need in the art for improved systems and methods for more accurately and more quickly separating qualified individuals from unqualified individuals.

There exists an additional need in the art for more standardized systems and methods for sourcing, screening, and selecting prospective employees.

### SUMMARY OF THE INVENTION

The present invention satisfies the above-stated needs and overcomes the above-stated and other deficiencies of the related art by providing systems and apparatus having a job definitions database (the definitions having predetermined subject-level job criteria and offerings), a workforce-profile database of individual profiles (the profiles having corresponding predetermined subject-level individual qualifications and preferences), an information manager, and a communications port for access to the system. The information manager interacts with the job definitions database, the workforce-profile database and the communications port to permit bi-directional subject-level matching between the job definitions database and the workforce-profile database and to permit information and queries to pass through the communications port.

The present invention also satisfies the above-stated needs and overcomes the above-stated and other deficiencies of the related art by providing methods of matching individuals with job definitions that use systems and apparatus of the type described above. The methods include comparing job criteria of the job definitions database with qualifications of the workforce-profile database, and identifying individuals qualified for a job definition in response to detecting a match between predetermined ones of the criteria and the qualifications.

One aspect of the preferred invention is directed to an automated employment recruiting system that integrates and streamlines several heretofore distinct aspects of the recruiting process. The preferred system enables prospective employers to source, screen, and select prospective employees in a fully integrated manner. This, in turn, permits them to fill open positions with qualified candidates in a fraction of the time and cost of conventional methods and/or systems. These benefits arise from advances in five primary areas: (1) job definition setup; (2) automated sourcing; (3) automated screening; (4) automation-assisted selection; and (5) comprehensive reporting.

The preferred job setup methods and apparatus provide a wide range of tools to assist prospective employers with instantiating job definitions within the system that represent real world job openings. For example, each prospective employer is preferably provided with a customizable job template library that it may use as the starting point for creating specific job definitions. Further, the methods and apparatus preferably include customizable individual dialogs that keep individuals informed of their progress while they are under consideration. Also, the methods and apparatus preferably allow multiple recruiters to collaborate on a job definition and, optionally, conditions job activation on managerial approval.

The preferred automated sourcing provided by the invention yields streamlined access to qualified prospective employees. This can be accomplished through (1) access to a workforce-profile database populated with information relating to prospective employees, the information being maintained in accordance with a predetermined subject level data retention system; and/or (2) customizable invitations that enable prospective employers to create standard invitations.

The invention also preferably provides at least partially automatic screening and evaluation. This may be achieved by the use of (1) precise screening that permits instant determination of qualified prospective employees; (2) in-depth profiling capable of performing sophisticated, competency-based evaluation; and (3) alternative scenario accommodation that permits evaluation of the impact of changing screening criteria.

The invention also preferably provides at least partially automated selection of the best individuals that, in turn, permits rapid identification of the best employees. More particularly, the invention may offer this advantage by providing (1) standardized individual-data summaries; (2) automated notifications/communications; (3) individual ranking and assessments; (4) note sharing/collaboration between interviewers, managers, and/or recruiters; and (5) decision support tools to speed evaluation and employee selection.

The invention may also preferably provide comprehensive reporting capabilities for providing in-depth job and individual information at a glance. Such capabilities may include (1) OFCCP-compliant record keeping, including archiving of questions, responses, and notes; (2) EEOC reporting that permits viewing of EEOC profiles in a variety of ways; (3) an integrated GUI for presenting job summary and/or detail reports; and/or (4) individual tracking summary and/or detail reports.

Naturally, the above-described methods of the invention are particularly well adapted for use with the above-described systems and apparatus of the invention. Similarly, the systems and apparatus of the invention are well suited to perform the inventive methods described above.

Numerous other advantages and features of the present invention will become apparent to those of ordinary skill in the art from the following detailed description of the preferred embodiments, from the claims and from the accompanying drawings.

### BRIEF DESCRIPTION OF THE DRAWINGS

The preferred embodiments of the present invention will be described below with reference to the accompanying drawings where like numerals represent like steps and/or structures and wherein:

FIG. 1 is conceptual overview diagram of one preferred embodiment of the employment recruiting system of the present invention;

FIG. 2 conceptually illustrates the Exchange portion of the embodiment shown in FIG. 1;

FIG. 3 shows a more detailed conceptual overview diagram of the embodiment of the invention shown in FIG. 1;

FIG. 4 is quasi-physical and quasi-logical representation of the preferred employment recruiting system of the present invention;

FIG. 5 is an overview of the process for creating various aspects of the CASE portion of present invention;

FIG. 6 is a screen-shot illustrating the creation of various communications/dialogs that may be presented to prospective employees using the present invention;

FIG. 7 is a screen-shot illustrating the creation of various communications/invitations that may be presented to prospective employees using the inventive employment recruiting system

FIG. 8 is a screen-shot illustrating the creation of communications/rejections that may be presented to individuals using the present invention;

FIG. 9 is a screen-shot illustrating the creation of Exchange communications/invitations that may be presented to Exchange members and referees of Exchange members;

FIGS. 10-11 are screen-shots illustrating the creation and/or editing of industry/function subjects in accordance with one preferred embodiment of the present invention;

FIGS. 12-13 are screen-shots illustrating the creation and/or editing of questions for use with the present invention;

FIG. 14 is table showing question type definitions for questions used with the employment recruiting system of the invention;

FIGS. 15, and 16a-16c are screen-shots illustrating the creation and/or editing of a canonical job template for use with the present invention;

FIG. 17 illustrates the preferred steps for provisioning a prospective employer in accordance with the present invention;

FIGS. 18-19 are screen-shots illustrating some of the prospective employer provisioning steps generally set forth in FIG. 17;

FIG. 20 illustrates additional steps for provisioning prospective employer in accordance with the invention;

FIGS. 21 through 24 are diagrams and screen-shots illustrating the steps for instantiating/activating an employer-specific job definition in accordance with the present invention;

FIG. 25-29 are diagrams and screen-shots illustrating the steps for an invited non-Exchange member to apply for an activated job in accordance with the present invention;

FIGS. 30a and 30b illustrates the preferred steps for a prospective employee to initiate membership in the Exchange and to complete topical surveys as a portion of the membership initiation in accordance with the present invention;

FIG. 31 is a block diagram illustrating the steps for an invited Exchange member to apply for an activated job in accordance with the employment recruiting system of the invention;

FIG. 32 is a block diagram illustrating the anonymous pre-qualification features in accordance with one aspect of the present invention;

FIG. 33 is a logic representation of the back-end processing that occurs that occurs during execution of the diagrams shown in FIGS. 31 and 32;

FIGS. 34 through 41b are diagrams and screen-shots illustrating various dossier access, display and modification features in accordance with a preferred embodiment of the present invention;

FIGS. 42 through 49 are screen-shots illustrating various job summary and job detail reporting features in accordance with the present invention;

FIG. 50 depicts the preferred manner of propagating revisions to the employment recruiting system of the present invention; and

FIG. 51 depicts the preferred manner of re-screening profiles and dossiers responsive to newly lowered and/or eliminated job criteria.

### DETAILED DESCRIPTION OF THE PREFERRED EMBODIMENTS

### Employment Recruiting System Overview

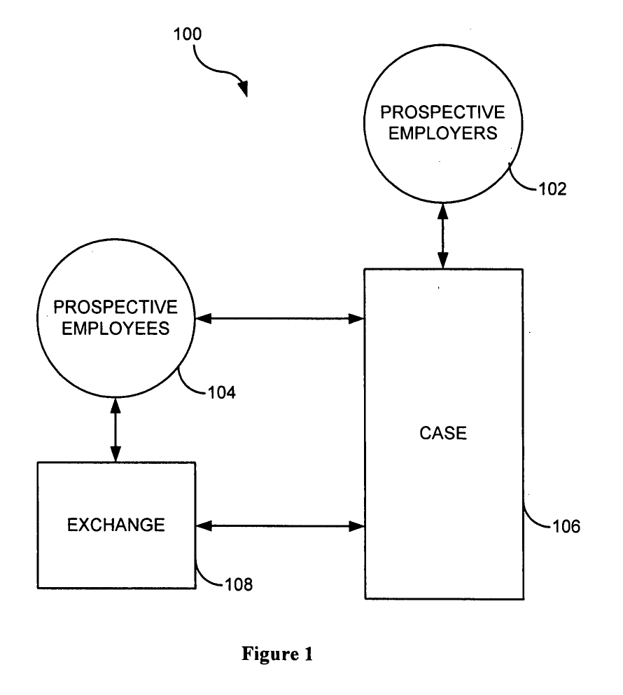

FIG. 1 shows an overview of the basic employment recruiting system 100 for efficiently bringing together prospective employers 102 and prospective employees 104. As shown, the system utilizes a computer automated screening and evaluation (CASE) component 106 and, optionally, a workforce-profile database 108 (hereinafter sometimes referred to as the “Exchange”). In its preferred form, system 100 attracts prospective employees 104 to the Exchange 108 where they become Exchange members by providing certain personal information and by completing a desired number of topical surveys in a predetermined format. The member may return to the Exchange to modify his profile and the profile may be automatically modified if/when the member uses other aspects of system 100. In this way, the Exchange becomes a dynamic repository of information regarding the prospective employees' skills and interests. In particular, Exchange member information (qualifications and preferences) is preserved in a data structure referred to as a profile containing the Exchange member's responses to a plurality of questions presented through the Exchange. Each of these questions contains predetermined “subjects” that correspond to “subjects” used by prospective employers in creating job definitions and in searching the Exchange. Therefore, it is a simple and efficient matter to determine whether certain qualifications and preferences stored in the Exchange 108 correspond with certain job criteria and offerings captured in plural job definitions stored in CASE 106.

Prospective employers 102 are attracted to CASE where, after an initial provisioning stage, they may create job definitions for one or more of their job openings. Each job definition is created with a plurality of questions containing predetermined “subjects” that correspond to particular “subjects” used to elicit information from the prospective employee as they provide such information to their Exchange profiles. Since various aspects of these profiles and job definitions correspond to one another on an elemental/subject level, the profiles and job definitions can be compared to one another in various ways and with a high degree of granularity to thereby (1) inform the prospective employees 104 when a suitable job opening may be available; and (2) inform the prospective employers 102 when a qualified prospective employee wishes to be considered for a job opening. Since the Exchange 108 and CASE are preferably dynamic, various techniques can be used to periodically query the Exchange for new members and/or to notify Exchange members when relevant job definitions have been newly activated. Furthermore, once one or more prospective employees and prospective employers engage in direct communications, CASE 106 may be used to facilitate the application/interview process and, preferably, to provide various reports on particular individuals and/or on the aggregated interview process.

As set forth in great detail throughout, CASE 106 preferably operates in conjunction with the Exchange 108 to enable automated sourcing and screening of prospective employees, on the one hand, and personnel collaboration, reporting and EEOC/OFCCP compliance for the prospective employers, on the other. Moreover, the inventive employment recruiting system yields exceptional returns because it enables employers to accelerate hiring cycles, thereby avoiding substantial inefficiencies that have heretofore plagued hiring efforts.

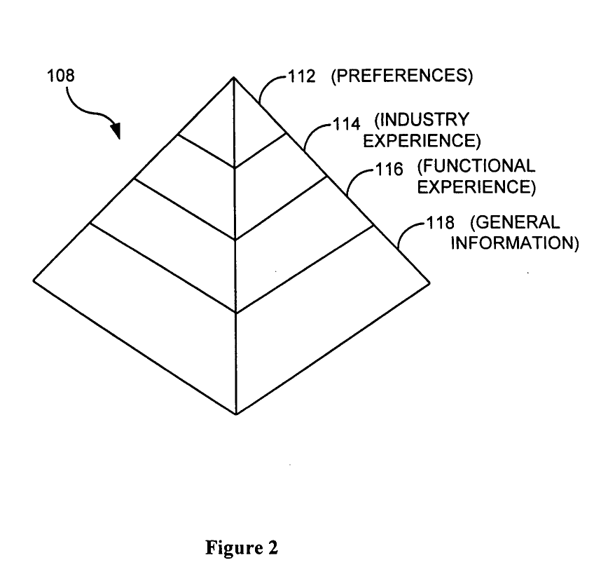

As symbolically represented by the pyramid of FIG. 2, workforce-profile database 108 preferably enables each prospective employee to become an Exchange member by building a personal profile containing salient information about his experience, skills, and knowledge. Additionally, each profile may include the Exchange member's preferences for such things as location, salary, type of job, etc. Maintained in a secure data warehouse, the profiles may be compared by CASE 106 to the criteria prospective employers set for their job definitions. Responsive to various matching conditions discussed in detail below, the qualifications (as embodied in respective one of the profiles) of every Exchange member may, if desired, be compared to the criteria of every job (as embodied in respective ones of the job definitions) of every employer. When an Exchange member qualifies for a job opening and when a job opening also satisfies the Exchange member's stated preferences, the member may be automatically notified of the job opportunity. If the Exchange member chooses to apply for that position, he may reveal his identity to the prospective employer by responding to an invitation to thereby apply, through CASE, for the job opening. Otherwise, he may maintain his anonymity by declining to respond to the invitation.

The process of creating a profile is preferably simple and easy. A prospective Exchange member is first presented with a series of questions that enables the new member to describe his general background and employment preferences. Then the new member will be asked to select and complete one or more predetermined surveys designed to capture detailed information about the Exchange member's functional experience (or skill set). The Exchange 108 preferably also includes a large number (over 175) of these industry-specific surveys that delve more deeply into each Exchange member's background at both an industry and functional level. Each of these surveys preferably includes questions constructed from predetermined “subjects” that correspond to the “subjects” that are used by prospective employers to construct the questions in the job definitions. While the Exchange survey questions themselves may be identical to the questions that appear in an activated job definition, they also may be phrased in broader terms to elicit more information from the Exchange member. This is because the initiation of an Exchange membership is not necessarily in conjunction with application for a specific job. In fact, it is expected that many job definitions (of differing criteria and offerings) may be added to the recruiting system after any given profile may have been created. Accordingly, the questions presented to a new Exchange member are ideally intended to extract as much information about that individual's skills, regardless of the criteria of any one or more pre-existing job definitions. Thus, a new Exchange member profile will likely contain more information about an Exchange member than may be relevant to any one job definition. Regardless of how similar (or different) the Exchange survey questions are to the questions used in a particular activated job, however, the important point is that both are constructed of the same predetermined “atomic/elemental” subjects. In this way, information contained in the workforce-profile database can be subsequently used to determine whether any members may be qualified for a later activated job definition. Similarly, information received during application for an active job can preferably be used to update/supplement an Exchange member's profile in the workforce database. Those of skill in the art will appreciate that this bi-directional flow of information automatically aggregates thereby improving the entire employment recruiting system with virtually every use.

Focusing again on FIG. 2, the Exchange 108 will become a highly structured repository of information for Exchange members wherein each profile reflects the preferences 112, industry experience 114, functional experience 116 and general information 118 for each of the Exchange members. The subject-level member preferences 112 map to subject-level job definition offerings. The subject-level industry and functional qualifications (experiences) 114 and 116 map to subject-level job definition criteria. Ideally, the Exchange will provide a prospective employer with virtually everything they would want to know about an Exchange member without the member having to do anything more than to (1) provide the initial enrollment information to the Exchange 108, and (2) agree to the release of his information to a particular employer for consideration for a particular job opening.

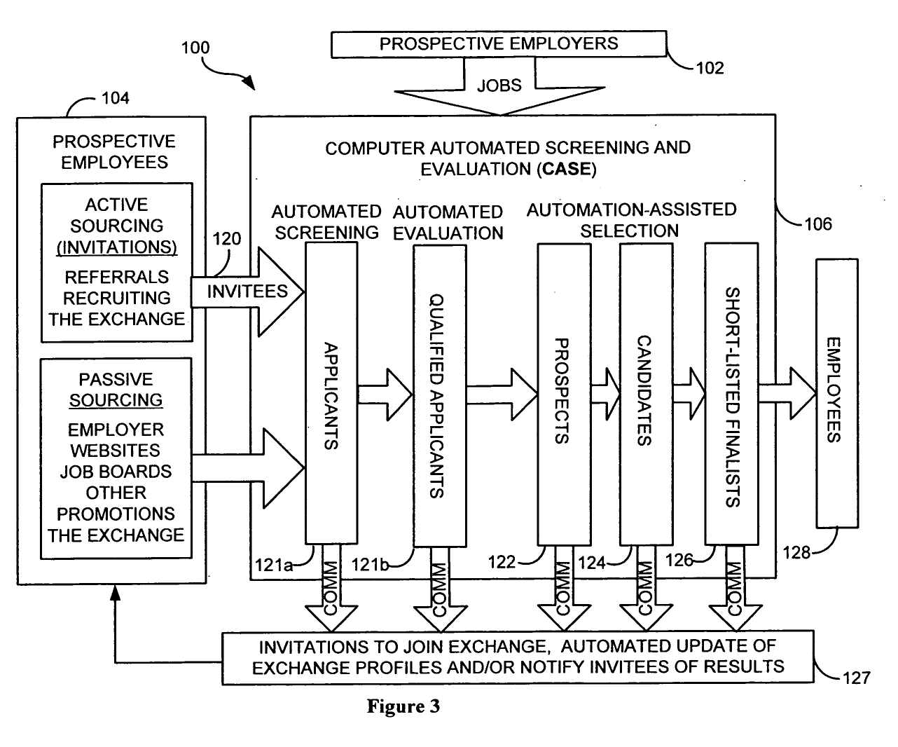

FIG. 3 shows a more detailed conceptual diagram of the embodiment of the invention shown in FIGS. 1 and 2. Again, as shown therein, system 100 uses multiple input sources, including the Exchange 108, and CASE 106 to match prospective employers 102 and prospective employees 104. In particular, prospective employees 104 may be actively sought to apply for job openings using referrals, various conventional recruiting techniques, invitations, the Exchange 108, etc. Additionally, prospective employees 104 may be sought to apply for job openings through employer websites, job fairs, third-party job boards, other promotions, the Exchange 108, etc. The recruiting system 100 offers many individual processing features that may depend, in part, on whether the individual (1) is an Exchange member, (2) has entered the system for the first time to apply for a specific job opening, (3) is not an Exchange member but has applied for a specific job and is returning to apply for another job opening, or (4) is an Exchange member, has applied for a specific job and is returning to apply for another job opening. Accordingly, individual processing is preferably somewhat different in each of these circumstances as will be described in detail below.

Nonetheless, some individual processing may be generalized regardless of how prospective employees are attracted to system 100. In particular, invitees 120 that elect to apply for a job opening preferably first enter an automated screening stage where their status is elevated to that of applicants 121a and where they may answer the prescribed screening questions. At this point, the applicants 121a are screened based on the criteria that are dictated by each job's eligibility requirements. Once a given qualified applicant 121b completes the automated evaluation stage, the qualified applicant's 121b status is elevated to that of prospect 122 and he may then complete a number of additional job-specific evaluation questions, enter his educational and employment histories and upload his résumé. His responses will then be captured in CASE 106 as a job-specific dossier and made available to the prospective employer who activated the relevant job. At this point, a prospect 122 enters the automation-assisted selection phase. A prospect 122 may then advance through the relevant prospective employer's interview and selection process to become a candidate 124, a short-listed finalist 126 (on the Short-List), and, potentially, an employee 128 of the employer 102. Throughout this process the dossier will be supplemented (as new information arises during the application process) and authorized personnel at the prospective employer may view and edit the dossier. Additionally, during the application process, prospective employers 102 and prospective employees 104 may communicate with one another, with CASE 106 and the Exchange 108 through various graphical user interfaces (GUIs) and other means of communications such as e-mail, voice mail (for example VOIP) and video. Depending on a number of factors and as discussed in detail below, communications 127 may involve a wide variety of messaging (text, voice and video) for a number of purposes and may be automatically or manually generated. A few examples of such communications include invitations for an individual to join Exchange 108 (if he is not already a member), automated-update of an Exchange member's profile (if he is already a member) and/or notices to short-listed candidates 126 indicating the results of his consideration for the relevant job opening.

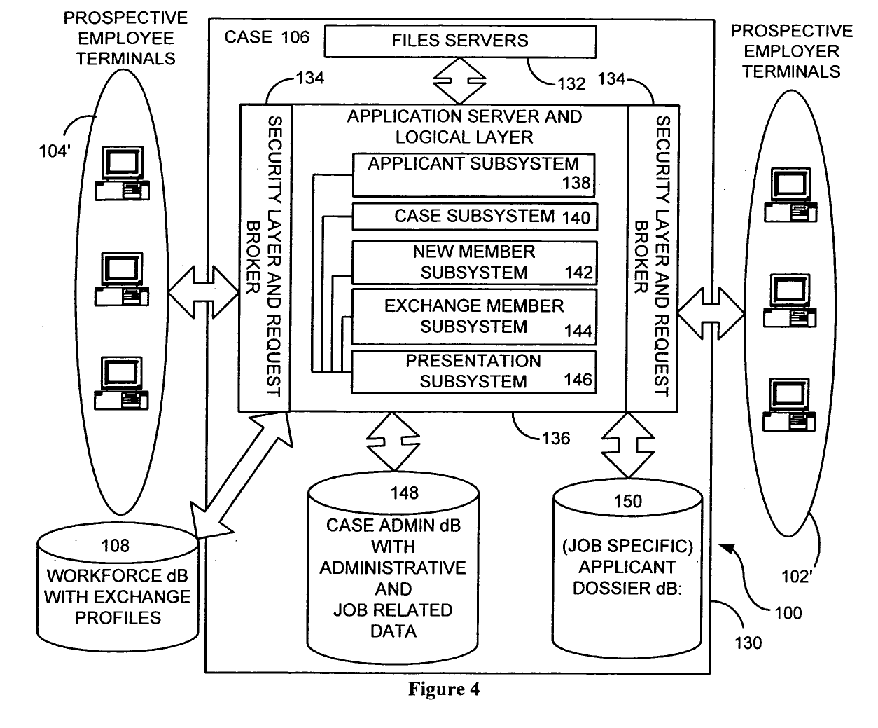

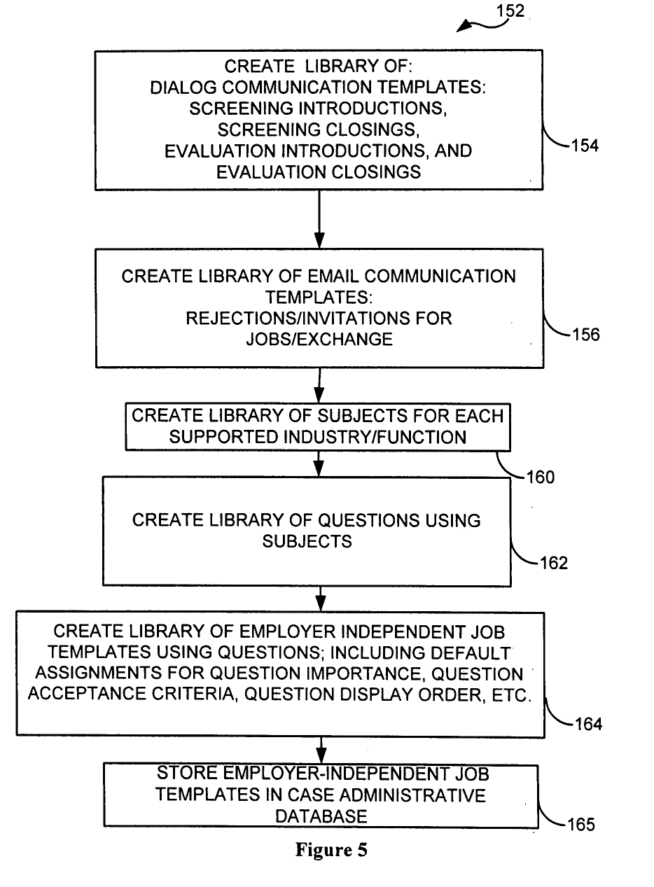

FIG. 4 is quasi-physical/quasi-logical representation of the preferred employment recruiting system of the present invention. As shown therein, remotely located plural prospective employees and plural prospective employers may be communicatively linked with CASE 106 using some form of conventional communications appliance and via some form of conventional communications link. These are preferably computer terminals, 102′ and 104′ respectively, running some type of browser (such as Internet Explorer, Netscape, Firefox, etc.) and the Internet. Those of ordinary skill in the art will readily appreciate that a wide variety of other conventional communications appliances (such as blackberries, cell-phones, PDA's, etc.) may be used to communicate with CASE 106. Similarly, those of ordinary skill in the art will appreciate that a wide variety of other conventional communications links (such as dedicated lines, microwave links, telephone lines, local or wide-area networks, etc.) may be used to communicate with CASE 106.

Regardless of the details of the communications media used, communications are sent and received at CASE 106 via a security layer and request/response broker 134 to ensure orderly communications processing (request routing and response generation) and that both inbound and outbound communications are free of viruses, worms, adware and other malware. The particular form in which such communications are presented to and received from terminals 102′ and 104′ is determined by presentation subsystem 146. In particular, subsystem 146 preferably uses logic and a java-based meta-language to dynamically generate responses in the appropriate format. For example, such responses may represent HTML browser pages with embedded java script and pointers to associated cascading style sheets; each of which, in turn, may be dynamically generated. The preferred system preferably uses a meta-language that provides an abstracted multi-format generator that can generate presentation output in a number of industry-standard formats (html, xml, xhtml, WirelessML, video, etc.) without requiring separate java code for each desired format; thereby allowing the presentation-layer to be developed with little or no consideration to the final format of the desired communication.

Also as shown in FIG. 4, CASE 106 also preferably includes file servers 132 for maintaining a variety of information provided by individuals and/or Exchange members that may also (for data redundancy/recovery and system performance/scalability) be included in databases 108, 148 and 150 discussed below. For example, such information may include résumés that have been uploaded into the system in any of the many widely used document formats (such as .html, .xhtml, .pdf, .doc, etc.), or XML data files that represent a snapshot of a job questionnaire relating to a specific applicant, including such items as the assigned questions, the applicable acceptance criteria, the applicant's associated response to each question, and the applicant's success or failure in meeting, and possibly exceeding, the associated acceptance criteria. Other examples of applicant-specific XML files include educational histories, employment histories, contact information, and dossier-related notes provided, for example, by the assigned recruiter(s), hiring manager(s) and interviewers. In short, all system data, applicant-related or otherwise, is captured in XML files regardless of its availability in a related database. This provides significant opportunities for both data recovery and for improved system performance and scalability. Also note that all database and fileserver-based data is automatically duplicated in real-time to provide automatic and user-transparent system fail-over capability, as well as significantly greater system performance and scalability opportunities. The applicant subsystem 138 executes automated applicant screening and selection functions (such as the logic to capture education data, employment history data, résumés, etc.) and provides the associated communications/dialogs. The CASE subsystem 140 preferably provides the logic for the creation, modification and other management of all subjects, questions, job templates, job definitions, surveys, profiles, communication templates (dialogs, invitations, rejection notices, etc.) and all associated libraries. The new member subsystem 142 preferably provides the logic for the processing of new Exchange members including the execution of member registration, introductory surveys, and topical surveys. The Exchange member subsystem 144 preferably provides the logic for all processing of existing Exchange members including the addition and/or modification/update of survey data, preference data, education data, employment history data, résumés, etc.

As noted above, presentation subsystem 146 preferably provides the logic and meta-code to dynamically generate and present, for example, browser pages to the employer and employee terminals 102′ and 104′. Additionally, subsystems 138 through 144 are, in the preferred embodiment, all linked to the presentation subsystem 146 such that inbound and outbound communications/information to and from terminals 102′ and 104′ are/is processed by subsystem 146 and either (1) passed to one or more of subsystems 138-144, or (2) received from one or more of subsystems 138-144.

Also as shown in FIG. 4, data warehousing for the preferred recruiting system 100 is provided by databases 108, 148 and 150. Although these databases have been conceptually divided for purposes of explanation, those of ordinary skill will recognize that they may be provided as a single database or divided otherwise as desired. Databases 108, 148 and 150 may be implemented as virtually any desired relational database and are, preferably, implemented in accordance with the ANSI (American National Standards Institute) SQL92 standard. Examples of such databases include Oracle, Microsoft SQL Server, IBM dB2, Sybase, etc. CASE 106 most preferably utilizes Oracle Enterprise Edition version 10.2.0.2. As conceptually divided in FIG. 4, the workforce-profile (Exchange) database 108 contains Exchange member data (as discussed throughout) and pointers to additional data/files stored on one or more of file servers 132 described above. This information may include information captured during completion of the introductory and topical surveys (as part of membership initiation/profile creation, discussed in detail throughout) and/or during automatic updating of member(s) profile(s) that occur(s) during the job application process (also discussed in more detail throughout).

As noted above CASE 106 also includes a (job specific) Dossier Database 150 and associated file services that, generally, contains various information captured in connection with a particular application/interview process for a particular individual and an activated job definition. If, in a particular case, the individual is an Exchange member, his Exchange profile may serve as the basis for creating an individual dossier when the Exchange member is invited by a prospective employer to (and actually does) apply for a specific activated job. When this occurs, information in the Exchange member's profile will be added to the Dossier Database 150 in the form of a pre-populated dossier that may be expanded and/or modified as specific job application process proceeds. As discussed below, additional information captured during the application/interview process may also be used to update/supplement the Exchange member's profile. Thus, the flow of information between Exchange profiles and applicant dossiers is, preferably, an ongoing and bi-directional process. If the individual, in a particular case, is not also an Exchange member, a new dossier is instantiated and is populated as the application/interview process unfolds. Regardless of whether pre-population of the dossier occurs, however, each instantiated dossier will record events occurring and information collected as an individual progresses through the application/interview process to become, a prospect, a candidate and those making the short-list. All of the subject-level information in each dossier is preferably preserved in accordance with predetermined EEOC regulations governing retention requirements for such information.

As noted above, CASE 106 will also preferably include a CASE administration database 148. Database 148 contains a variety of prospective employer administrative and job-related data. Such administrative data may include prospective employer personnel data (such as names, titles, contact information, access authorization level, etc.), prospective employer identification data (such as name, contact information, description of company and products or services, company history, logos, etc.). Such job related data may include company-specific dialogs and other communications, job templates, job definitions, job-specific personnel assignments (such as the recruiter(s), hiring manager(s) and interviewers), and various processing reports, etc.

Collectively, the various components described with respect to FIGS. 1-4 above provide a complete and highly efficient employment recruiting system 100 that generally permits prospective employers to post jobs and find/process the most qualified individuals. Additionally, system 100 permits prospective employees to quickly and easily find/attain suitable positions by joining the Exchange, after which they will be automatically informed of job openings for which they are provisionally qualified.

### Case Creation/Maintenance by a System Creator/Administrator

With joint reference to FIGS. 5 through 16, the process for creating various canonical aspects of CASE 106 will be described below. It will be appreciated that, on the highest level, CASE 106 contains a generic/canonical infrastructure of components that may be created, used and maintained by a system administrator. The system administrator preferably selects and uses portions of this canonical infrastructure to provision new prospective employers as appropriate. For example, CASE 106 preferably contains libraries of predetermined subjects (elemental components of the canonical infrastructure), predetermined questions (formed based on the subjects), and predetermined job templates (formed based on the questions) that are narrowly tailored to various industries and jobs and functions within each of the supported industries. Thus, for each supported industry, construction of CASE 106 first entails breaking an industry into a hierarchy of jobs in that industry, identifying the most important skills for each of the jobs, identifying the most important terminology (subjects) for each of the skills in each job skill-set. Once this has been completed, the terminology (subjects) can be used to construct questions that efficiently probe a prospective employee's mastery of the skills needed for various jobs. These questions can be aggregated to thereby construct job templates that probe a prospective employee's mastery of all of the skills expected of a qualified employee for a particular job. When fully constructed CASE 106, thus, ideally includes a library of job templates (each of which anticipates all of the subjects that should be explored with an individual for each job of interest) that may serve as the basis for and/or an exemplar of the ideal questioning process for each job of interest.

Further on the highest level, CASE 106 will preferably also include a library of dialog communications that may serve as the basis for and/or an exemplar of expected communications with prospective employees during the application process. As will become clear, such communications are generally not dependent on particular industries and/or jobs and, thus, need not be created on a job-by-job basis.

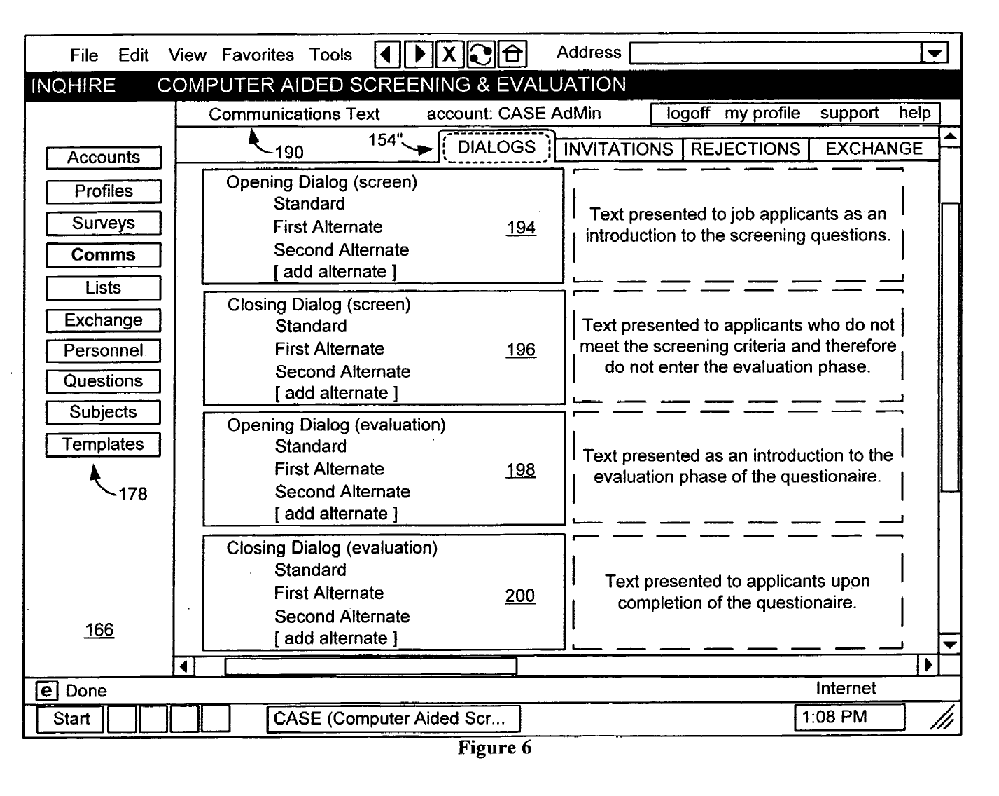

FIG. 5 provides a more specific overview of the process 152 for creating a variety of canonical CASE components that may be subsequently used in Exchange 108 communications as well as in the application/interview process. As shown therein, process 152 begins at block 154 where a library of various dialog communications is created. Such communications may be used in screening surveys and in evaluation surveys and may include dialog communications, screening introductions, screening failures, evaluation questions, introductions, and closing communications. The communications text screen-shot 190 of FIG. 6 shows an administrator's graphical user interface 166 for use in specifying the dialogs for the screening and selection phases of the application process. Along the left-hand side of the screen-shot of FIG. 6 are a number of function buttons 178 that enable a system creator/administrator to access various tools for creating and/or updating CASE 106. In particular, buttons 178 are provided for accessing functional modules associated with managing ACCOUNTS, PROFILES, SURVEYS, COMMUNICATIONS, LISTS, EXCHANGE, PERSONNEL, QUESTIONS, SUBJECTS, and TEMPLATES. The purpose and usefulness of these various features will become apparent to those of ordinary skill in the art as the description of the invention proceeds below. In the case of FIG. 6, the communications (Comms) button 178 has been selected to display the communications module screen 190. DIALOG tab 154″ has also been selected to access the screening opening and closing dialog windows 194 and 196 as well as evaluation opening and closing dialog windows 198 and 200. The purpose of each dialog is specified in the right hand side of the screen-shot. As shown, each of the dialog windows 194 through 200 permits a system creator/administrator to specify the default dialog and a number of alternate dialogs that may be used to communicate with prospective employees. These may then be added to the communications library of the CASE admin database 148 (and associated file server subsystem) and prospective employers may later select from among these dialogs during instantiation of a new job definition.

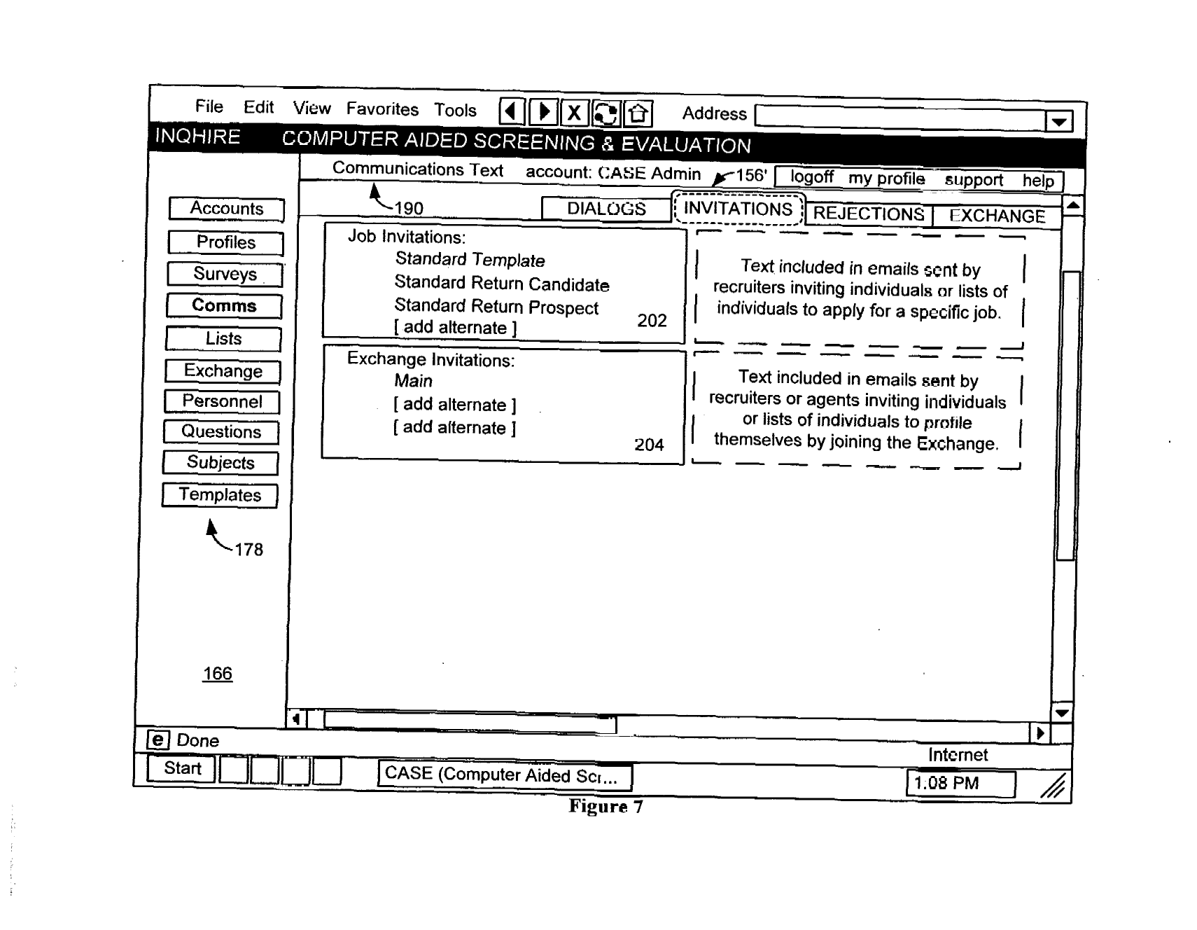

With these dialogs now specified, the process of FIG. 5 then passes to block 156 where a number of e-mail communication templates are added to the communications library of the CASE administrative database 148 and associated file server subsystem. Such e-mail communication templates may include rejections and/or invitations to apply for job openings and/or to join the Exchange 108. The communications text screen 190 is shown in FIG. 7 with the INVITATIONS tab 156′ having been selected. As shown therein, job invitations window 202 and Exchange invitations window 204 are presented, thereby enabling a system creator/administrator to create and/or update e-mail invitations as desired. The purpose of such invitations is set forth in the windows to the right of invitation windows 202 and 204. Once specified these communication templates may be added to the communications library of the CASE admin database 148 and associated file server subsystem.

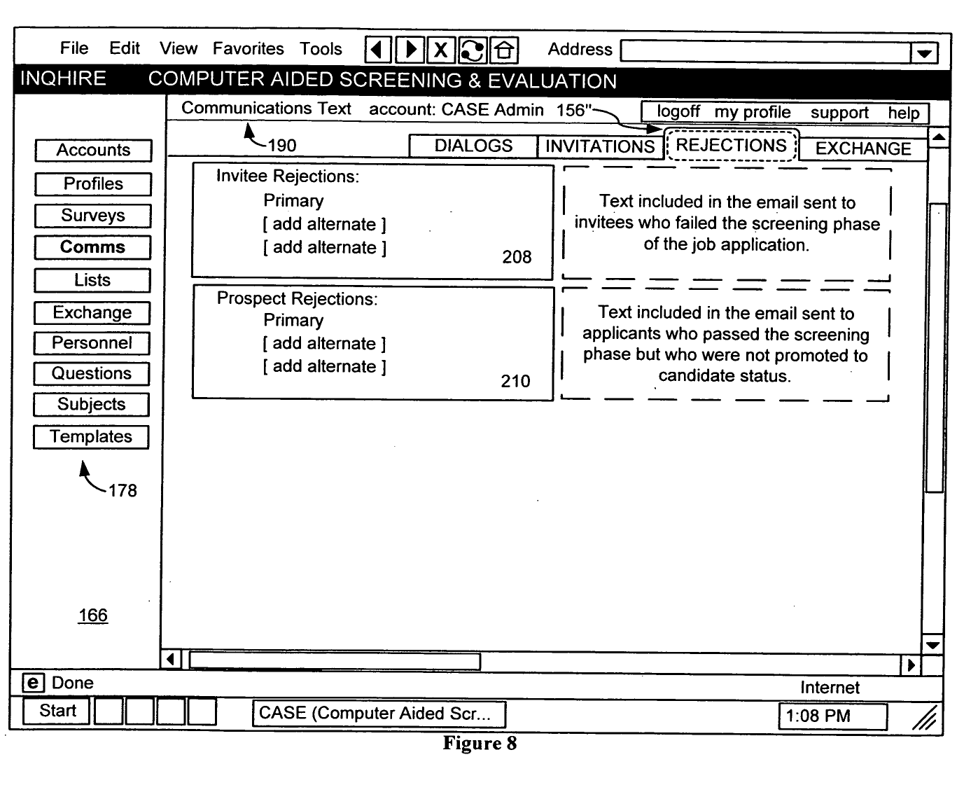

With reference now to the screen-shot of FIG. 8, there is shown the communications text screen with the REJECTIONS tab 156″ having been selected. As shown therein, applicant rejections window 208 and prospect rejections window 210 are presented, thereby enabling a system creator/administrator to create and/or update e-mail rejection templates as desired. The purpose of such rejections is set forth in the windows to the right of rejection windows 208 and 210. Once specified, these communication templates may also be added to the communications library of the CASE admin database 148 and associated file server subsystem.

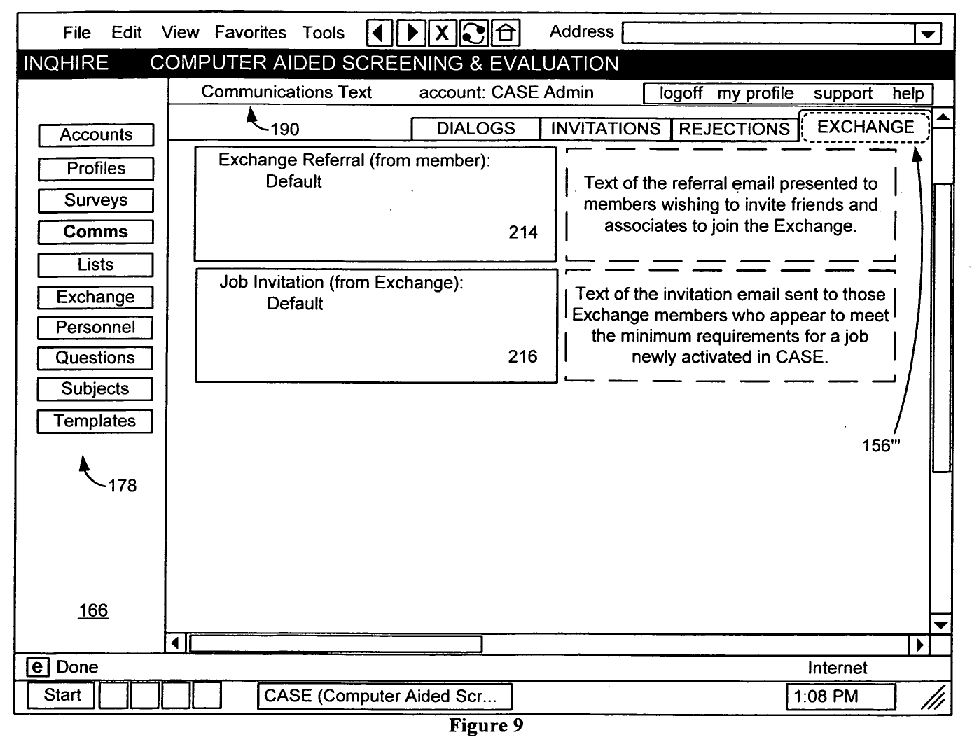

With reference now to the screen-shot of FIG. 9, there is shown the communications text screen with the EXCHANGE tab 156′″ having been selected. As shown therein, the Exchange referral window 214 and the job invitation (the invitation being directed to an Exchange member) window 216 are presented, thereby enabling a system creator/administrator to create and/or update these communication templates as desired. The purpose of such communications is set forth to the right of windows 214 and 216. Once specified, these communication templates may also be added to the communications library of the CASE admin database 148 and associated file server subsystem.

With the desired communication templates having been created in block 156 of FIG. 5, the process then passes to block 158 where a hierarchical library of industries and functions within those industries is created. More particularly, for each industry that will be supported by CASE 106 a number of functional positions typically found in that industry will be specified. Further, their hierarchical relationship will be specified. With the industries and job functions to be supported now created, the process passes to block 160 where a library of subjects for each industry/function is created. Each subject will refer to a concept typically important in a given industry/function and utilize commonly understood terminology

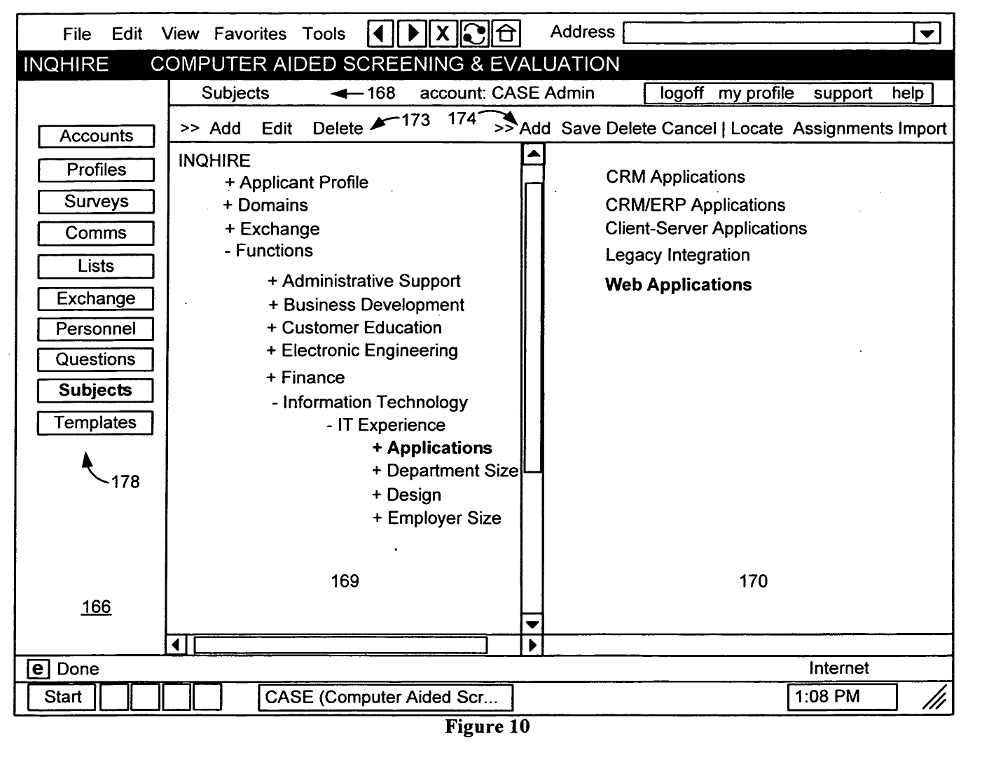

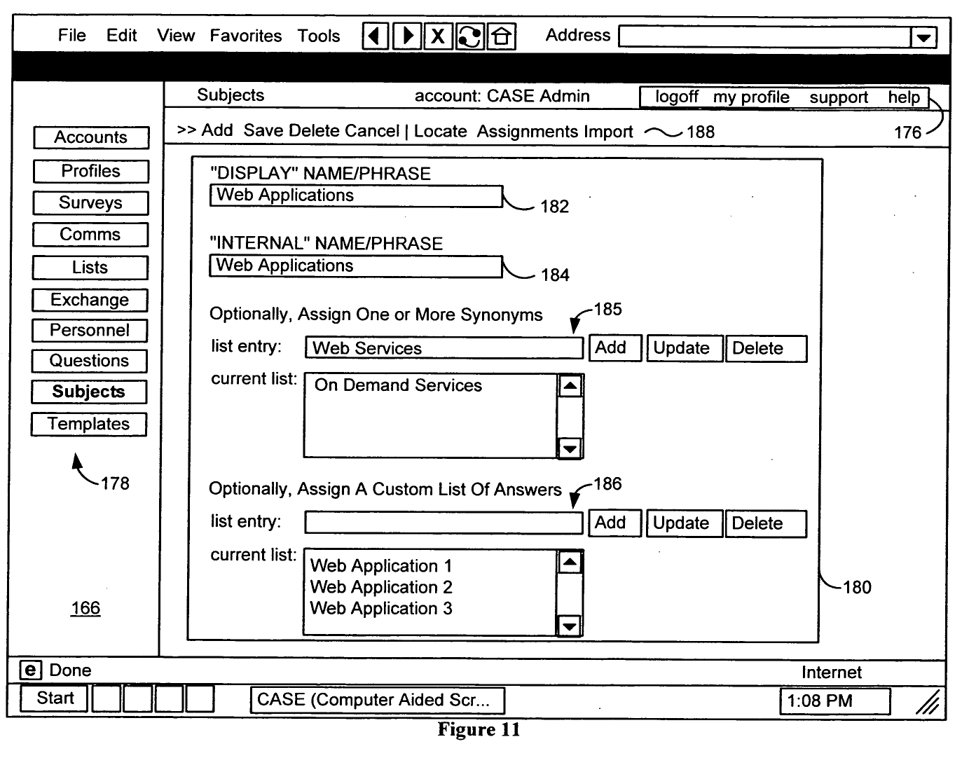

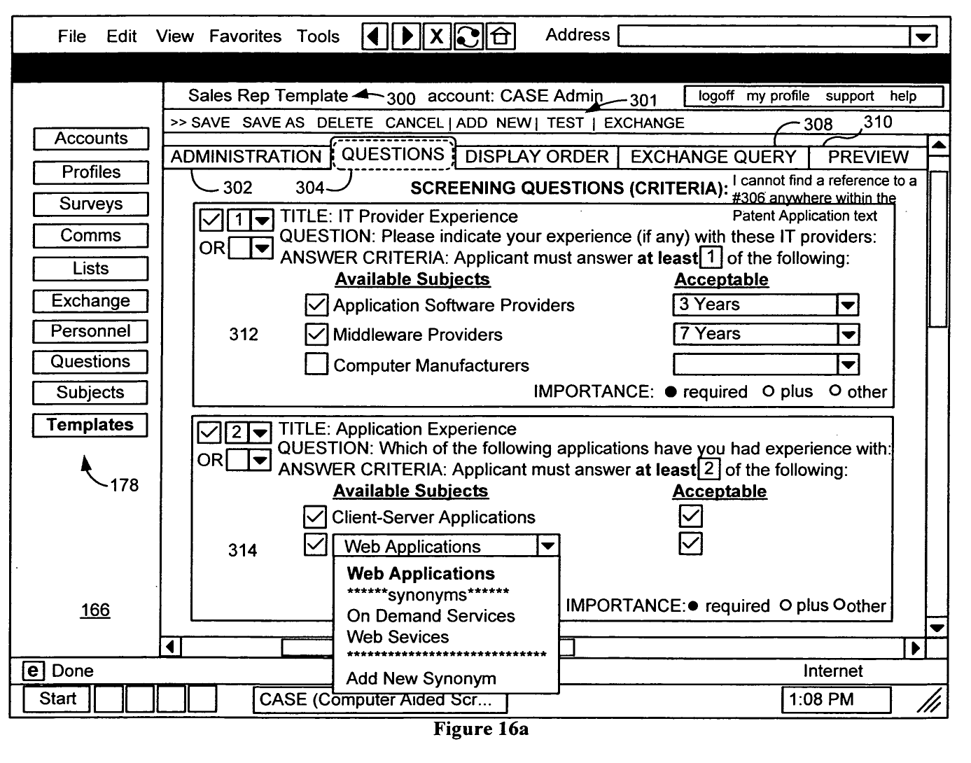

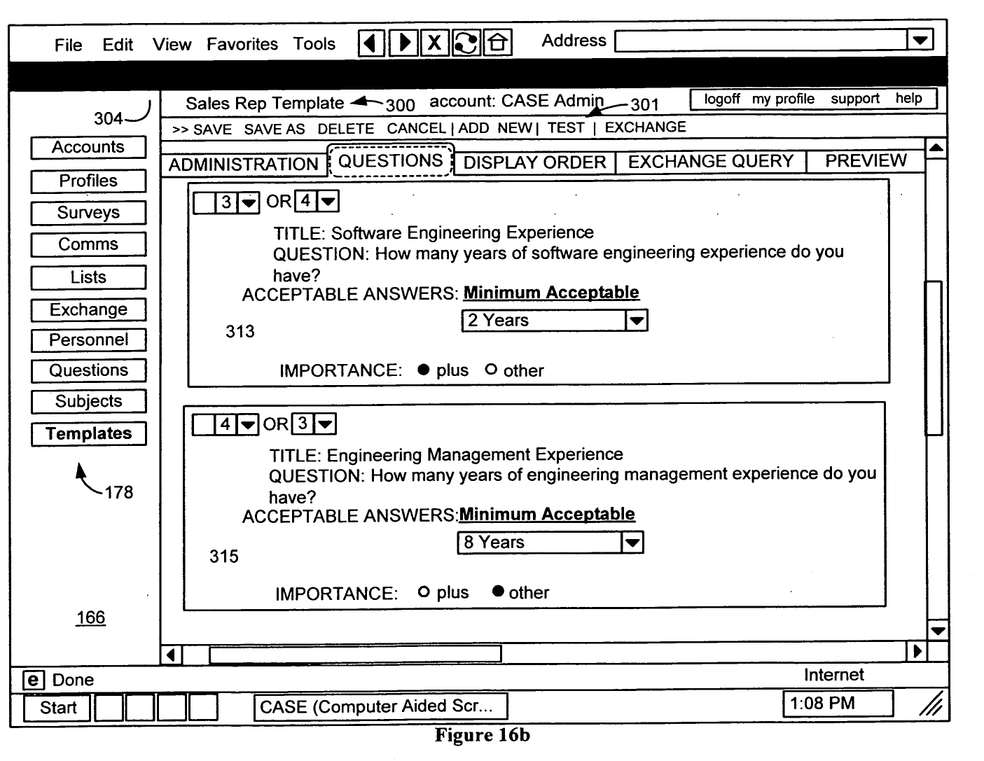

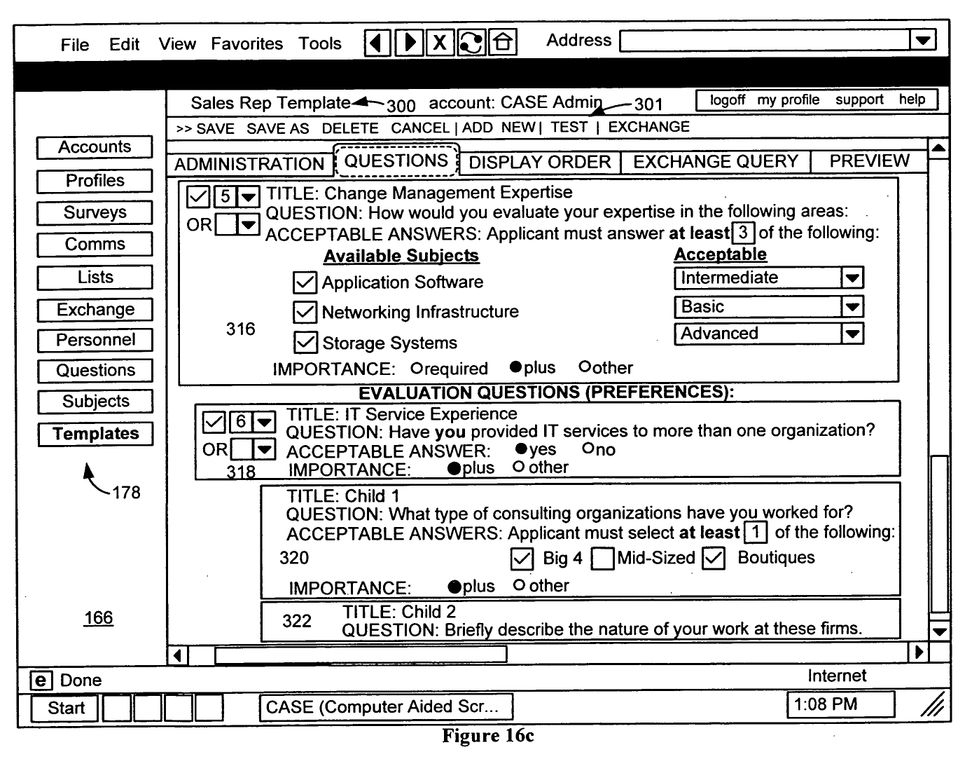

FIG. 10 shows system creator/administrator graphical user interface 166 with the “Subjects” button 178 having been selected to display the “Subjects” screen 168. The left hand window 169 shows an industry/function hierarchical tree structure that was created in block 158 described above with the job function “Applications” selected. The right hand window 170 shows a list of subjects that relate to the selected job function, with the “Web Applications” subject having been selected. In this state, the functional links 173 and 174 may be selected to execute the function indicated. For example, after selecting the “Applications” function of window 169, selection of the add button 173 enables the system creator/administrator to add subcategories for additional subjects that relate to the chosen category “Applications”; existing subjects relating to the category, if any, are simultaneously displayed in window 170. Once at least a rudimentary hierarchical subcategory library structure has been generated, subjects are created and added to one or more subcategories by employing the add button 174. FIG. 11 illustrates how the subject “Web Applications” would be created in screen 180, where the system creator/administrator can define/update the “Web Applications” subject and, optionally, create, modify and/or organize a custom list of selectable values by employing fields 182 through 186. For example, in the state shown in FIG. 11 one synonym (On Demand Services) for the Display-Name (Web Applications) has been created and linked to the display name for optional inclusion in a desired question as described in more detail with respect to FIGS. 16a and 16b. Another synonym (Web Services) is in the process of being created and linked to the Display-Name via field 185. Linking predetermined synonyms to a given subject in this way allows the system 100 to recognize the subject by any one of these equivalent terms. With continuing reference to FIG. 11, it is noted that the functional buttons 188 and 176 may be selected to execute the respective functions identified therein. Once created, these subjects may be added to the subjects library of the CASE admin database 148 and associated file server subsystem for future use. By repeating this process for each supported industry/function, the system creator/administrator can create and/or modify various subjects used throughout the rest of the CASE system 106.

Having created the desired library of subjects, process 152 of FIG. 5 passes to block 162 where a library of questions is created using the subjects identified above. Each question is assigned a question type by specifying the answer metrics for the question and each question may be linked to other questions by specifying the familial status of the question.

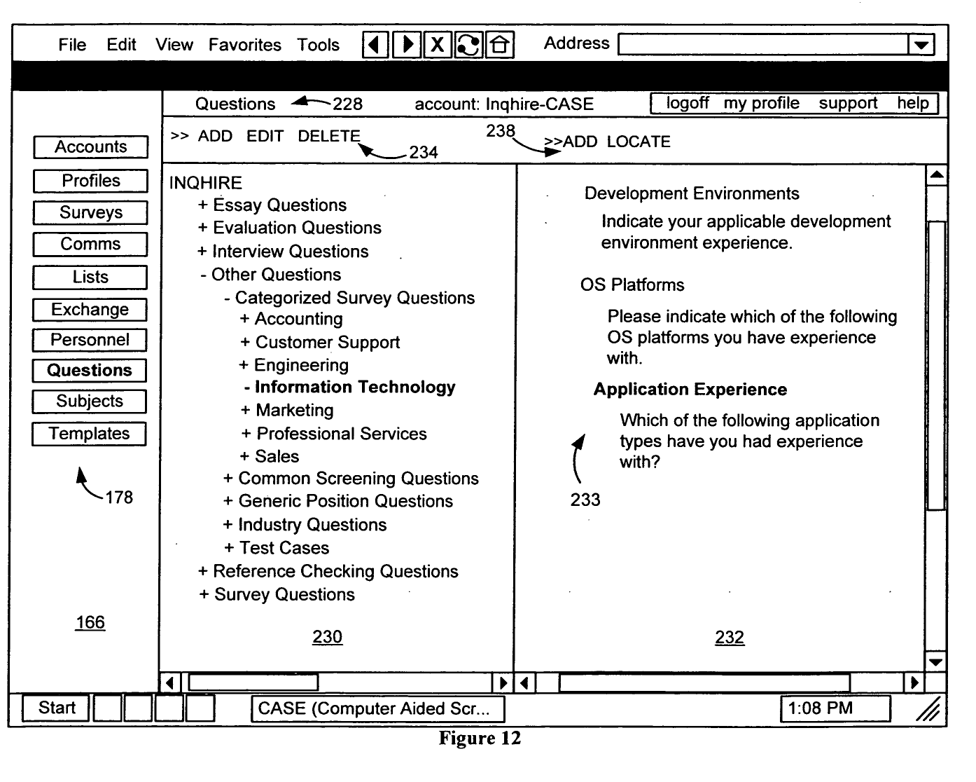

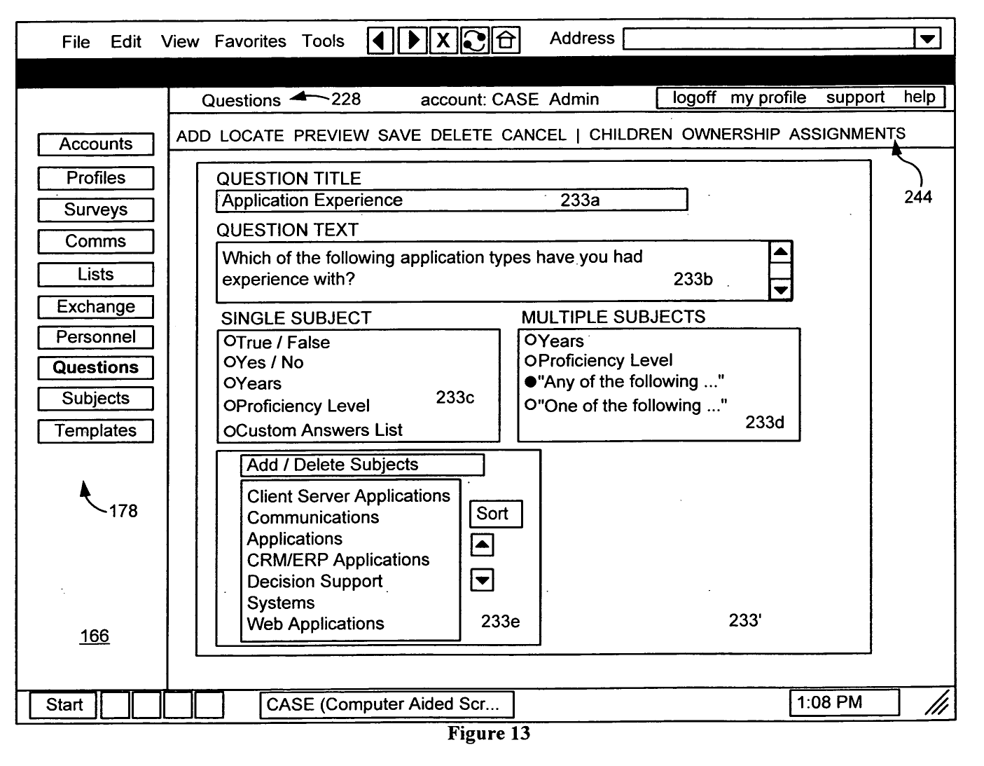

FIG. 12 shows the system creator/administrator graphical user interface 166 with the “Questions” button 178 having been selected to display the Questions screen 228. The left hand window 230 shows a list of question categories that was created in block 160 of FIG. 5. The right hand window 233 shows three representative questions (with respective question titles) with the “Application Experience” question title having been selected. By comparison, FIG. 13 shows interface 166 in which “Application Experience” has been selected to present question-creation window 233. As shown therein, field 233a and 233b display the particular title and question that was selected. Additionally, the type of acceptable responses for the question has been specified by selecting the appropriate features of boxes 233c and 233d. Further, having specified that an appropriate response to the question may include multiple predetermined subjects, those subject values have been specified in box 233e. Accordingly, the right hand window 232 displays the “Information Technology” questions that were previously created. These questions may be deleted, added to, modified, etc. as desired using functional links 238. Restated, the functional links 234 and 238 may be selected to execute the function indicated. For example, after selecting the “Application Experience” question title and after selecting the “EDIT” control 234 system creator/administrator may edit the “Application Experience” question by modifying the question details as presented in window 233′ of FIG. 13. Thus, the system creator/administrator can define/update the selected question by entering the desired information in fields shown therein. Further, the functional links 244 may also be selected to execute the respective functions identified therein. This process may be repeated as desired/necessary to prepare the appropriate question and these questions may be captured in the CASE admin library for future use. In this way, the system creator/administrator can create and/or modify various questions (containing various predetermined subjects as discussed above) for use throughout the rest of the CASE system 106.

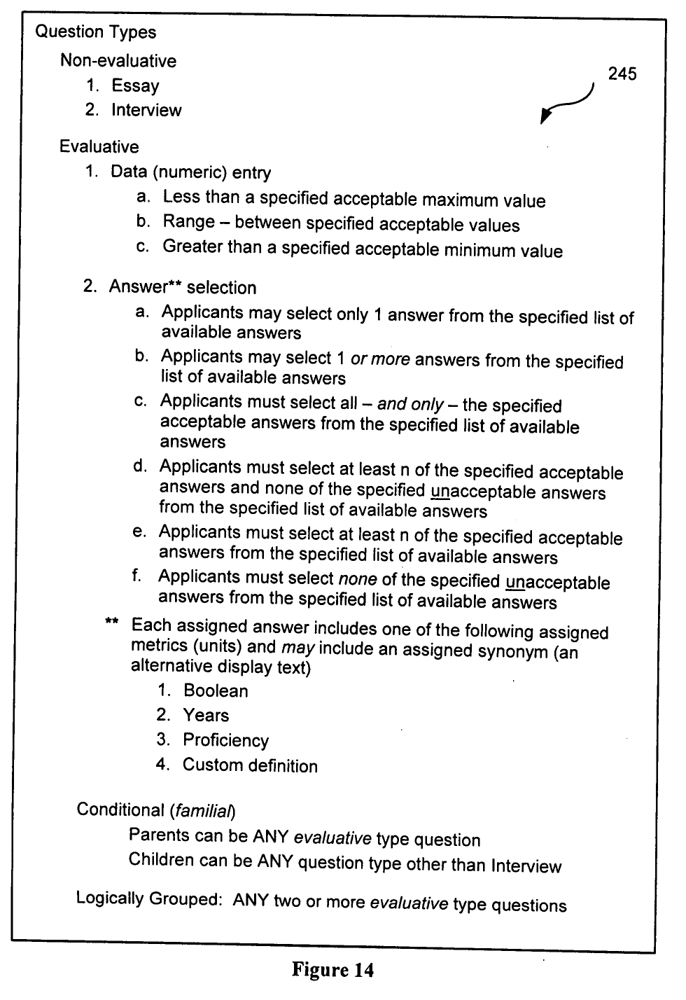

A list of preferred question types utilized in the preferred embodiment of the invention is shown in table 245 of FIG. 14. Question types fall into two broad categories: evaluative and non-evaluative (for example, essay questions or questions intended to be assigned to an interviewer). Evaluative questions are further subdivided into Data Entry and Answer Selection type questions. The evaluative questions (whether data entry or answer selection) are unique because they support the concept of question subjects and, therefore operate at two levels simultaneously. Subjects represent atomic (self-defining), context-insensitive (question independent), multi-dimensional (each subject automatically inherits multiple selectable orthogonal dimensions including—but not limited to—years of experience, proficiency, customized answer lists, and Boolean), and reusable definitions of data of interest to both potential employers and potential employees (applicants). Therefore, on one level evaluative questions may be taken literally as an expression of specific information being sought. However, at the assigned subjects level, they provide an intimate connection to The Exchange. In so doing they provide a priori knowledge of an Exchange member's responses to any job or survey-specific question via the question's assigned subject(s) irrespective of the manner or the context in which the evaluative questions were posed. Moreover, such evaluative questions may—and typically do—include the assignment of multiple subjects, thereby allowing one question to capture numerous applicant-related data points of value to a prospective employer. It will be appreciated that the various question types shown therein dictate the type of response that may be provided and, in some cases, dictate the actual values that may be selected or entered (e.g., true/false, yes/no, lists, etc.). For example, in the case of numeric entry question types (e.g., Evaluative types 1a,b,c), a given question may permit a response to be any natural number within a specified finite range of values, a natural number greater than a specified value, a natural number less than a specified value, etc. Other question types, such as the non-evaluative “Essay” type, support free-form narrative responses of any length. Still other question types limit acceptable responses to be one, some, all or none of the specified acceptable and/or unacceptable answer(s) selected from a list of available answers (e.g., Evaluative question types 2a-f). Those of ordinary skill will readily appreciate the qualities of the other question types noted in Table 245.

Further flexibility in the CASE question capabilities is offered by the ability to relate multiple questions with one another. For example, questions that may otherwise be considered as distinct from one another may be logically grouped together to permit, for example, a response to any one of such combined questions to satisfy a specified corresponding criterion. Additionally, questions may reflect familial (parent/child) relationships so that questions that logically do, or do not, flow from prior questions may be presented appropriately. It will be understood that during the CASE 106 system creation stage, the above-noted question types will be assigned to the questions as they are created primarily as a means of specifying the type of acceptable answers that can be associated with a given question. By contrast, the specific value(s) or answer(s)—from those available—that a prospective employer desires to include in a specific job template or job definition, as well as what values or which answers (and their associated values) are to be considered acceptable and/or unacceptable are defined both separate from and subsequent to a question's creation.

In the case of the “Application Experience” question shown in FIG. 13, the question represents an evaluative “list of available answers and associated subjects”. It will be appreciated that the question entitled “Application Experience” of FIG. 13 could have been modified to represent a type 2.a.2 “single subject years” by changing the question text, deselecting the “MULTIPLE SUBJECTS” entry, selecting the “SINGLE SUBJECT” “Years” entry and saving the modified question. It will also be appreciated that the assigned metric/units (years, proficiency, Boolean, custom assigned answers list) associated with this same question can easily be selected/modified as desired. It will be further appreciated that any of the subjects assigned to this particular question can be simultaneously assigned to any number of other questions of the same or different question type; therefore, an applicant's response to a particular subject that has been assigned to any question within any job definition or survey represents an autonomous and consistent data point regardless of the question to which it was assigned. Further, details regarding question types and creation will become even more apparent with the discussion of template creation below.

Returning again to FIG. 5, after the question library has been created, process 152 passes to block 164 where a library of the employer-independent job templates is created using the previously specified questions, dialogs, etc. Each such job template generally represents a generic or canonical job definition for a given industry/function. In addition to comprising a group of representative questions, each template may include an importance level associated with each question, default criteria for acceptable answers, question titles, and dialogs and other communications that may be presented to a prospective employee. In a preferred form of the present invention, such templates will serve as the basis for customized job definitions for each prospective employer provisioned on CASE 106 to facilitate the creation/activation of job definitions that correspond to particular job openings at a particular prospective employer.

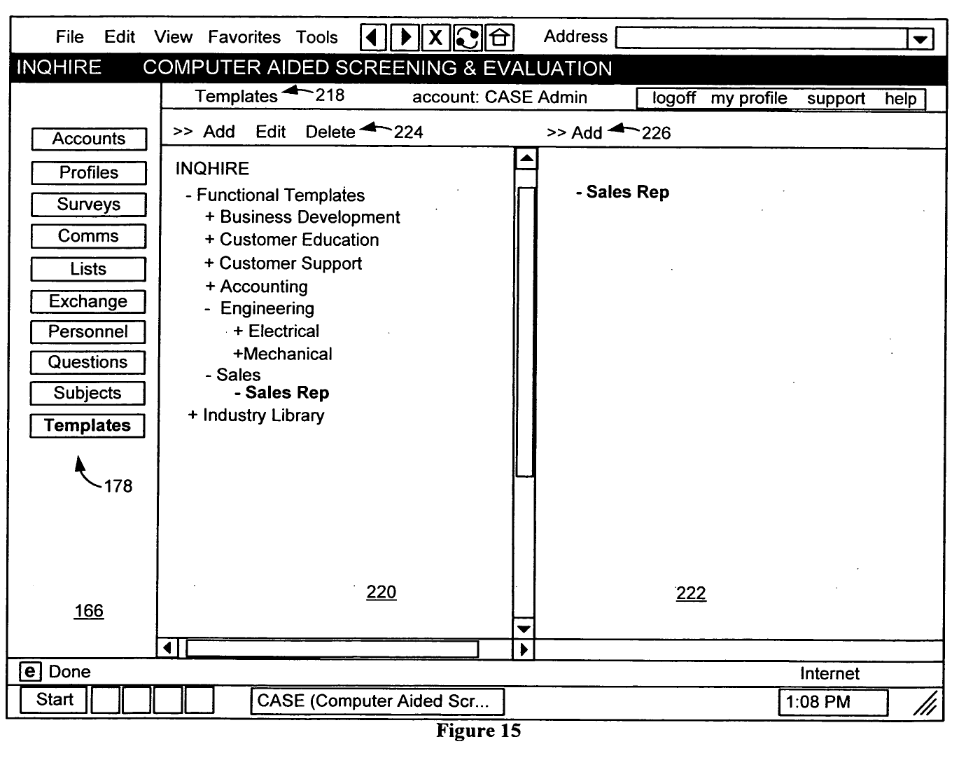

The screen-shot of GUI 166 shown in FIG. 15 includes the “Templates” screen 218 with a left hand window 220 and a number of “Templates” that have been created by a system creator/administrator. As shown, the “Sales Rep Template” has been selected in the left hand window 220 and added to the right hand window 222 by selecting one of functional links 224. The template may be edited by a system creator/administrator in a manner similar to that discussed above with respect to questions and the employer-independent templates may be stored in the CASE administrative database 148 (see FIG. 4) and associated file server subsystem for subsequent recall and use as desired.

With primary reference now to FIGS. 16a, 16b, and 16c, there is shown the CASE Administrative GUI 166 with three screen-shots of a previously created “Sales Rep Template” 300, the QUESTIONS tab 304 having been selected to display a number of representative questions included in this template. For purposes of illustrating certain features, this template reflects selection of acceptable response values and other features that would not typically be specified upon creation of a canonical template. As shown, template screen-shot 300 includes first and second screening questions 312 and 314, each of which includes a question title, question text, a selectable list of available answers, a selectable list of optional answer (subject) synonyms, specified acceptable answer criteria and an assigned question importance level. Since these questions form the screening portion of the template, the acceptable answers represent answer requirements (criteria) that must be met for an individual to proceed to the evaluation portion of the template. As shown, two of the three possible answers have been selected to indicate that, as instantiated, only these two answers are relevant (and thus will be included in the question at it appears to an applicant) in question 312. The associated minimum years of experience has been specified and the importance level has been set to “required,” again indicating that individuals that do not meet these minimum standards will be screened out. It is noted that question 312 is an example of a type 2.e.2 question (see FIG. 14) using three subjects: Application Service Providers; Middleware Providers; and Computer Manufacturers. It is also noted that questions 312 and 314 have been selected with a check in the top left-hand corner. This configuration reflects the fact that canonical job templates are designed to be comprehensive and, therefore, will typically have both more questions—and more subjects per question—than may be desired in any particular instantiated job definition. Checking a question indicates that the question will appear in an instantiated job and omitting a check omits the question from an instantiated job. Checking or un-checking a subject within a question indicates that the subject will be, respectively, displayed within or omitted from the associated question in a job template or an instantiated job definition. All selected subjects for which an acceptable value (acceptance criteria) has been specified indicates that the specified criteria are to be applied by CASE to each applicant's associated response. Any selected subjects for which an acceptable value (acceptance criteria) has not been specified instructs CASE that such a comparison is not desired and that each applicant's response should simply be captured and reported. Furthermore, each assigned subject within an assigned question may include one or more synonyms; thereby allowing the job template and/or job definition creator/administrator to select—or add/define—a synonym for any subject; thus, allowing the displayed text associated with any assigned subject to more accurately reflect that which is readily understood within any specific industry, discipline or company. The question numbering in the top left hand corner of each question indicates the question ordering in an instantiated job. Further, every question preferably includes the ability to link to one or more other questions as indicated by empty numbering box in the left hand corner. This is discussed in greater detail with respect to FIG. 16b below. It should be appreciated that each of the aforementioned designations can be achieved during job template creation, as well as during any subsequent job instantiation (job definition). Question 314 of FIG. 16a is an example of a type 2.e.1 question (see FIG. 14) containing the following three subjects: Client-Server Applications; Decision Support Systems; and Web Applications.

Questions 313 and 315 of FIG. 16b together form an example of two Grouped type 2.a.2 questions (see FIG. 14). As indicated in the top left-hand corner of questions 313 and 315, they are joined together with a Boolean “non-exclusive or” operator and they represent the third and forth questions to be presented. In contrast to the screening-stage questions 312 and 314 of FIG. 16a, questions 313 and 315 are included in the post-screening evaluation-stage of the job definition's questionnaire and, thus, their IMPORTANCE levels have been designated as “plus” and “other”, respectively.” Question 313 is a type 2.a.1 question containing the subject: software engineering. Question 315 is a type 2.a.1. question containing the subject: engineering management. It is noted that questions 313 and 315 are not checked in the left-hand corner, indicating that these questions are to be omitted from an instantiated job definition.

Question 316 of FIG. 16c is an example of a type 2.e.3 question (see FIG. 14) containing the following three subjects: Application Software; Networking Infrastructure; and Storage Systems. It is noted that question 316 is checked in the left-hand corner, indicating that the question is to be included in an instantiated job definition.

Questions 318, 320 and 322 of FIG. 16c together illustrate a familial question structure with parent question 318 and child questions 320 and 322. Questions 318 and 320 are evaluative in nature and, thus, they have an assigned IMPORTANCE level while Question 322 is a non-evaluative Essay type question. Question 318 is a type 2.a.1 question; question 320 of FIG. 16c is an example of a type 2.e.1. question (see FIG. 14) containing the following three subjects: Big4; Mid-Sized; and Boutiques. Question 322 is a non-evaluative type 1 (essay) question that represents a request for a narrative response. It is noted that an applicant is exposed to the one or more assigned child questions only if his response to the associated parent question first meets or exceeds the specified acceptance criteria associated with the parent question. In that event, the associated assigned child questions are displayed thereby obviating the need for the applicant to respond to questions that, based on his response to the parent question, either do not apply or for which his answers can be deduced. It is also noted that questions 318-322 are checked in the left-hand corner, indicating that the questions are to be included in an instantiated job definition.

From the forgoing, those of ordinary skill will readily appreciate that Template 300 may have also contained any combination of additional questions (and associated additional subjects) represented by any of the question types included in FIG. 14. Further, such questions may be ordered, modified, and otherwise changed by a system creator/administrator after they have been created as shown in FIG. 13. Further, additional prospective employer-specific questions may be created and/or modified directly from within the Job Template (as well as Job Definition) module. In addition to creating and assigning questions, a system creator/administrator will assign a unique title, a number of communications dialogs and communications e-mail templates to each template using the template GUI 300. As each job template is created or modified, it is stored (see block 165 of FIG. 5) in the CASE Administrative database 148 and file server subsystem (see FIG. 4).

### Propagation of Question Revisions

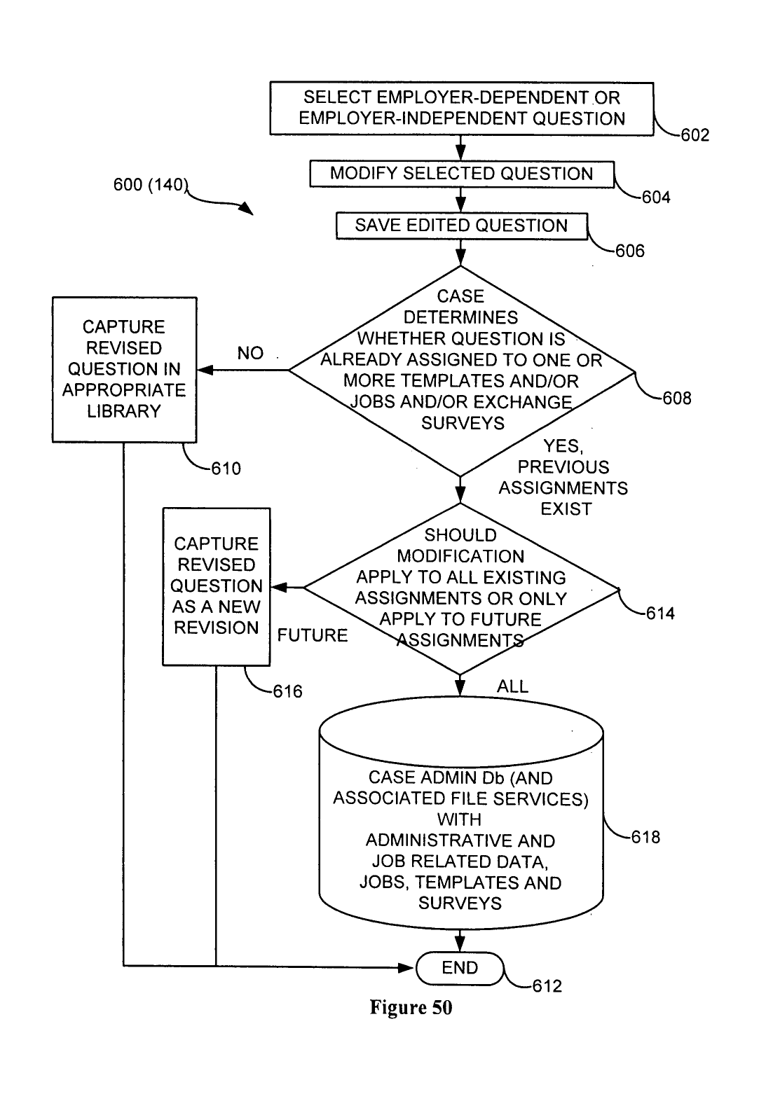

FIG. 50 depicts the preferred manner of propagating question revisions to the employment recruiting system of the present invention. Based on the discussion above, it will be appreciated that the employment recruiting system 100 of the present invention is a highly dynamic system in which the additions, improvements, and other modifications are made to the system as new information becomes available, for example, from prospective employers and prospective employees. One area in which improvements are expected to be a common occurrence is in the number and content of questions supported by CASE 106. Changes to these questions present difficulties because they may be assigned to one or more (in an identical or a related form) of the following (including but not necessarily limited to), (1) the canonical templates; (2) the Exchange surveys; and (3) employer specific job templates (4) employer specific job definitions. Accordingly, an efficient means for propagating updated questions appearing/used in different aspects of employment recruiting system 100, such as the process 600 of FIG. 50, helps facilitate this aspect of the invention. As shown therein, updated question propagation process 600 begins when a CASE administrator selects an employer-dependent or an employer-independent question at block 602. The administrator may modify the selected question at block 604, save the edited question at block 606, and proceed to block 608 where CASE 106 determines whether the question has already been assigned to one or more canonical templates and/or job definitions and/or Exchange surveys. If not, the process passes to block 610 where the revised question is simply captured in the appropriate library and the process ends at block 612. Where one or more previous assignments do exist, however, the process passes to block 614 where a determination is made whether the modification should apply to all existing assignments or only to future assignments. If only future assignments, the revised question is simply captured as a new revision at block 616 and the process passes to block 612 where it terminates. If the revised question is to apply to all existing assignments as well, the process passes to block 618 where the CASE Administration Database 148 and file server subsystem (see FIG. 4) is updated so that the newly revised question is substituted for the prior version of the question in all of the job definitions, templates, and Exchange surveys in which the prior version of the question previously appeared. Finally, the process passes to block 612 where it terminates. The logic for propagating question revisions in accordance with the invention shown and described with respect to FIG. 50 is preferably provided by the CASE sub-system 140 as shown in FIG. 4. Those of ordinary skill in the art will readily understand how to code such functionality based on the description contained herein.

### Prospective Employer Provisioning by System Creator/Administrator

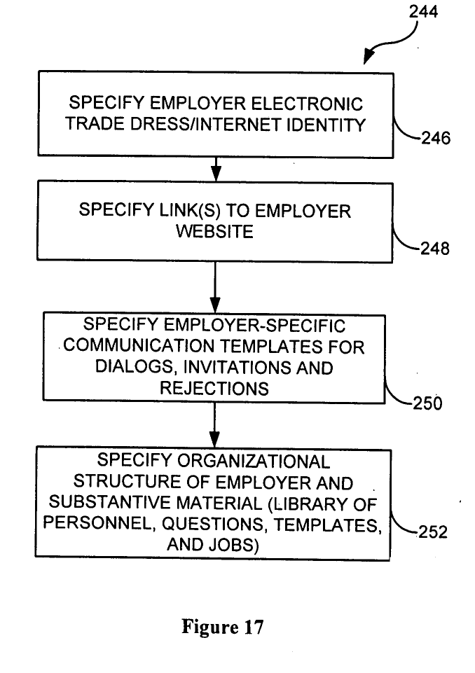

The preferred prospective employer provisioning process 244 is set forth in general terms in FIG. 17. With joint reference to FIGS. 17 through 24, the prospective employer provisioning process will now be described. There are preferably two general aspects of employer provisioning in accordance with the invention: (1) specifying administrative matters such as defining the prospective employer's business identity and structure; and (2) creating an employer-specific job template library based on the canonical template library.

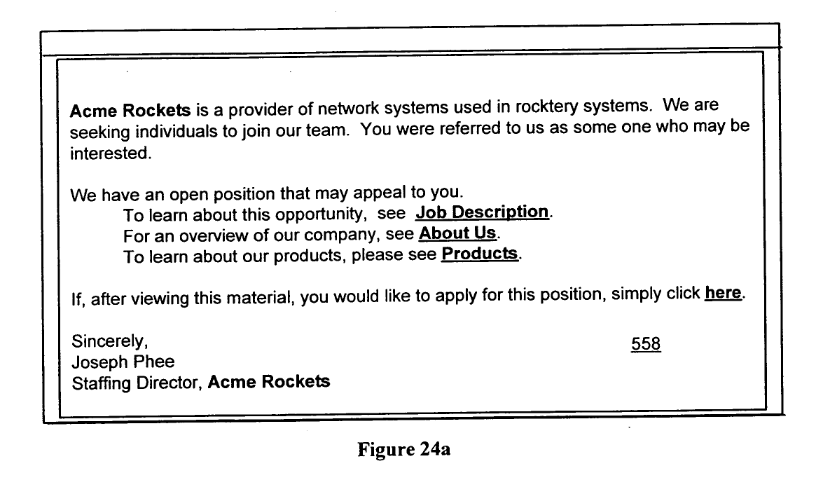

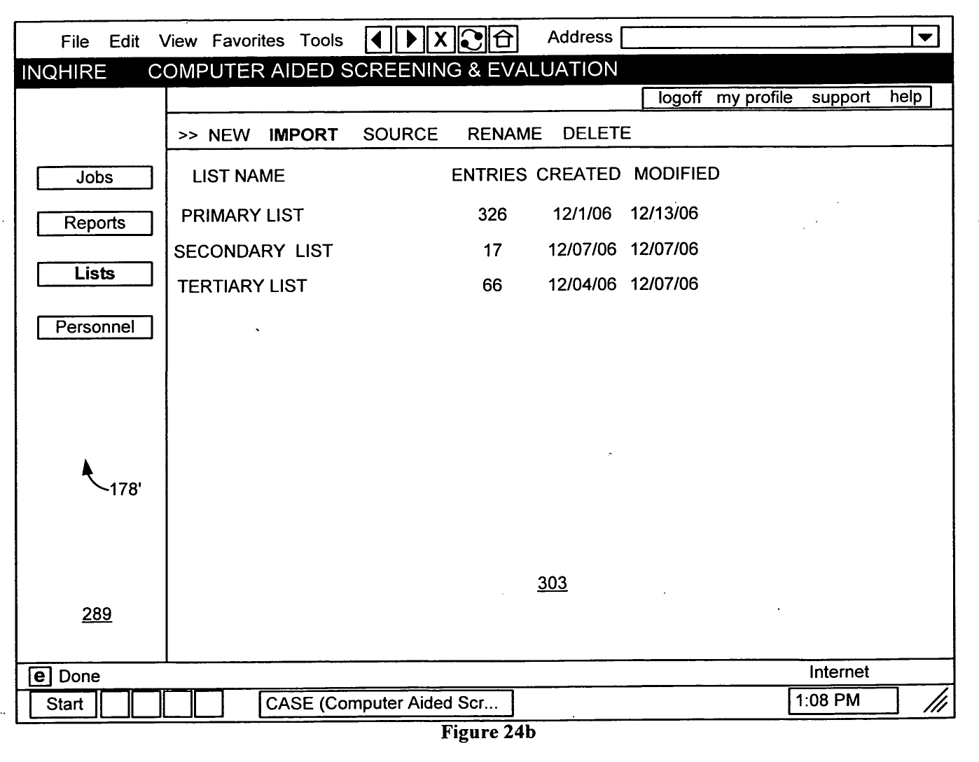

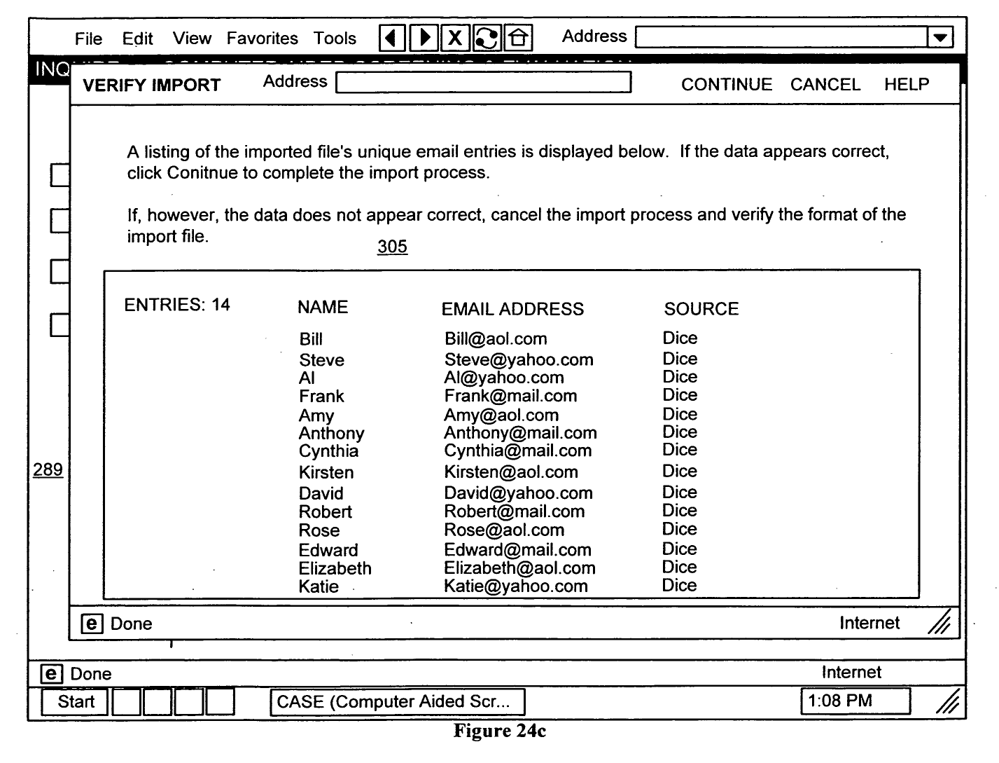

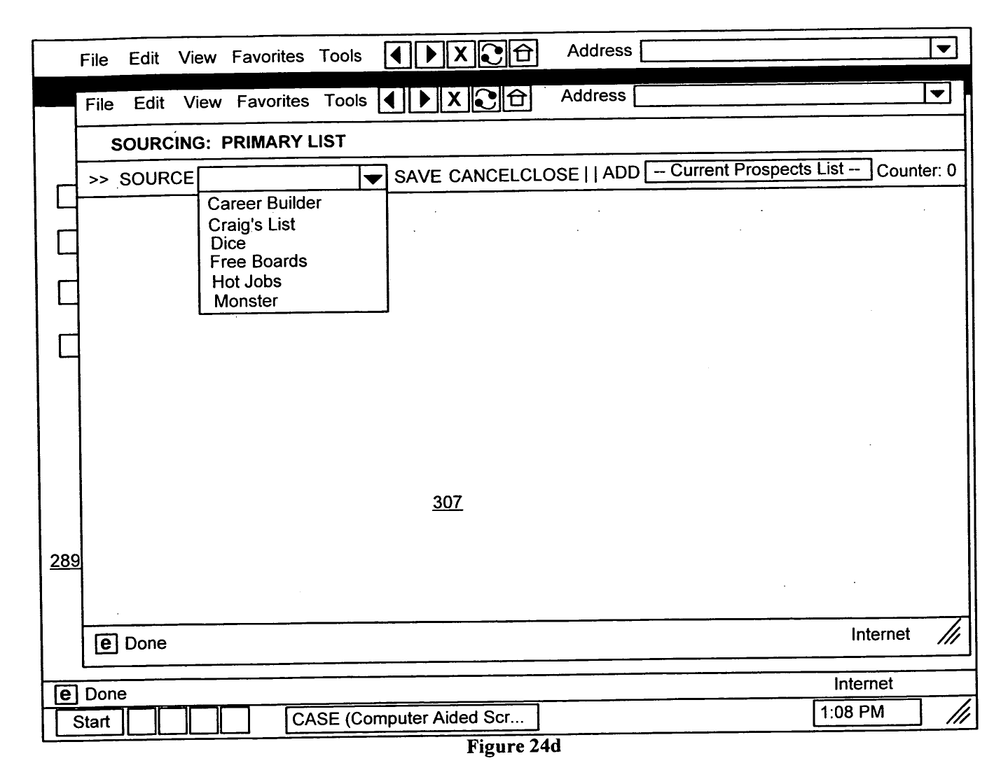

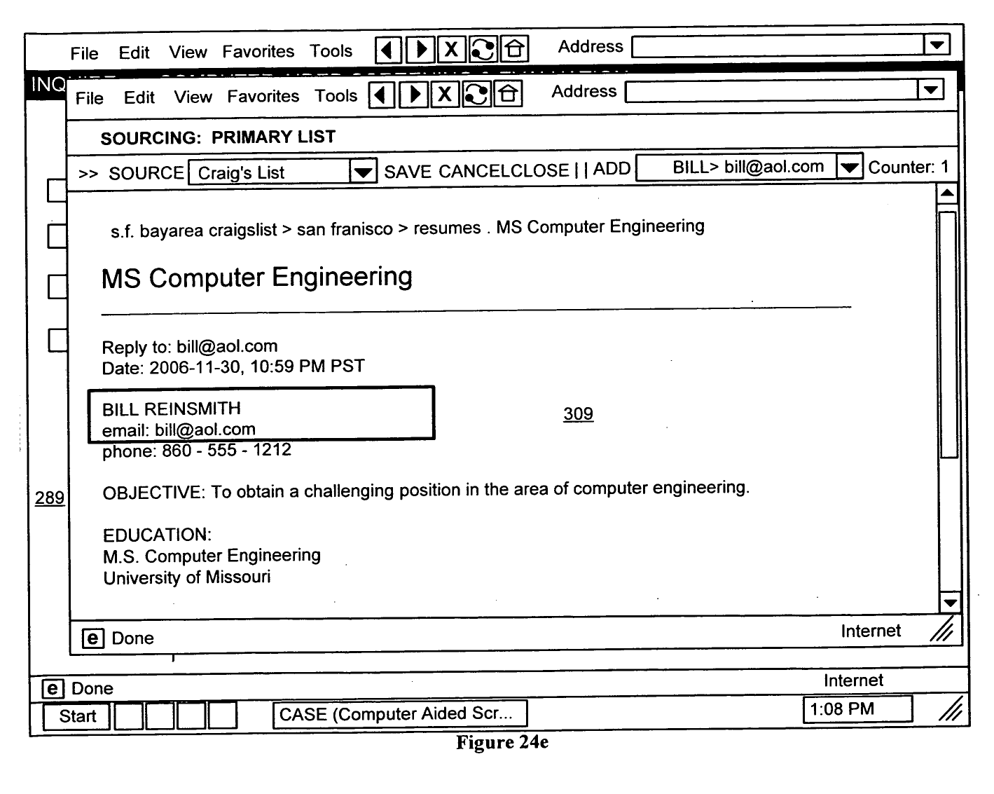

More specifically, and as shown in FIG. 17, the employer provisioning process 244 (preferably conducted by a system creator/administrator based on information provided by a prospective employer) begins at block 246 where the prospective employer uploads any desired files, images and/or other information to the CASE administration database 148 and file server subsystem (see FIG. 4). Such information will be subsequently used by CASE to emulate the employer's identity to thereby project the employer's presence while CASE is acting as an agent to communicate with prospective employees. Once this is completed, the process passes to block 248 where links pointing to About Us and Products and/or Services on the employer's website are captured. These links will be used for a number of purposes such as to direct applicants, Exchange members, etc. to predetermined information posted on the employer's website (see, e.g., FIG. 24 for an example of such an e-mail).

The provisioning process then passes to block 250 where a prospective employer specifies the communications dialogs, invitations and rejections that are to be used in communicating with individuals. In particular, the communications discussed above with respect to CASE creation may be selected for use (either with or without modifications) in automatic communications by a particular employer. The automated communications system is discussed in detail below.

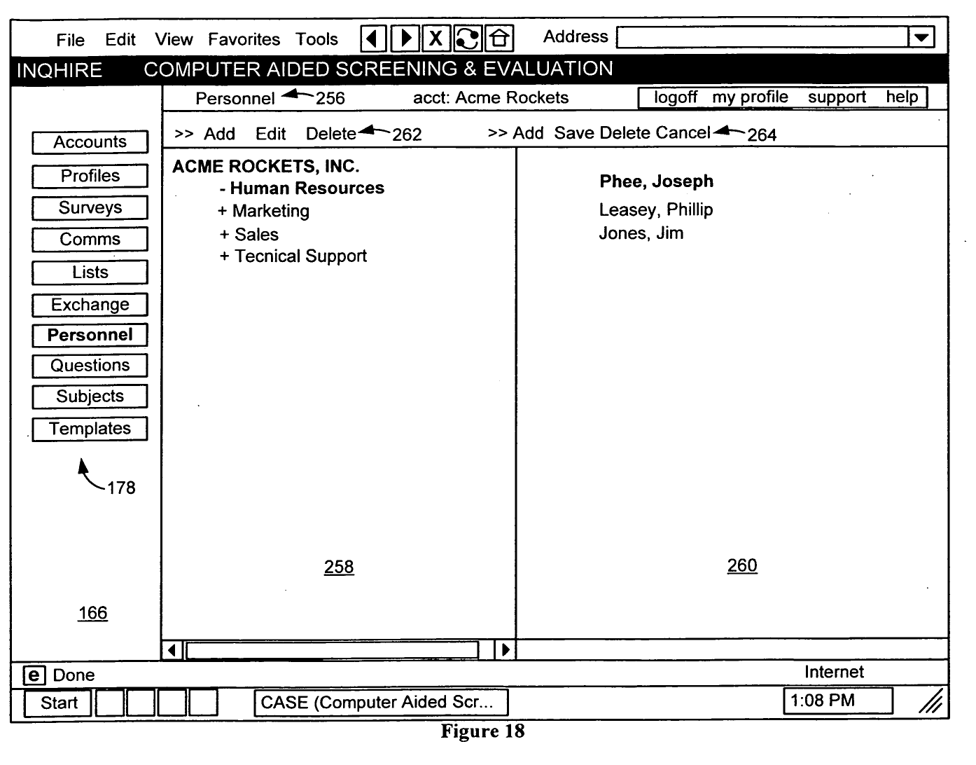

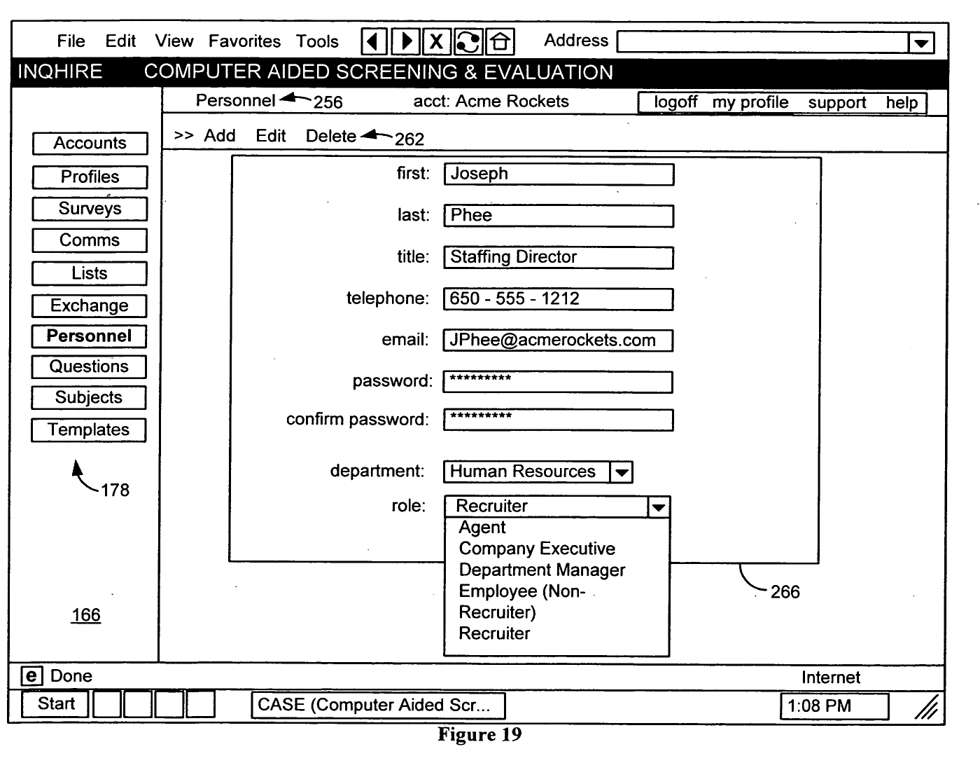

The provisioning process then passes to block 252 where a prospective employer specifies a variety of substantive and administrative information. The administrative information may include its organizational structure, a list of personnel that are expected to participate in recruiting (hiring managers, interviewers, recruiters, etc.), authorization levels for each of the aforementioned personnel, etc. This step is reflected in Personnel screen-shot 262 shown in FIG. 18. As shown, the Personnel button 178 has been selected displaying left and right hand windows 258 and 260 for employer ACME ROCKETS, INC. Window 258 shows four departments that have been provisioned with the Human Resources department having been selected to thereby display the names of three ACME ROCKETS employees in window 260. By selecting one such employee, Joseph Phee, in window 260 the system creator/administrator can create/access that employee's more detailed information as shown in FIG. 19. In particular, window 266 of FIG. 19 shows a variety of contact information for the selected employee. More importantly, window 266 identifies the employee's password, department and role, all of which dictate the employee's authorization level and access to the various aspects the employer-specific template library, activated jobs, applicant dossiers, reports, etc. Returning now to FIG. 17, once an employer specifies various information noted above, the information will be stored in an employer-specific database 150 and file server subsystem and will be used in the processes of creating/activating new jobs and of processing individuals.

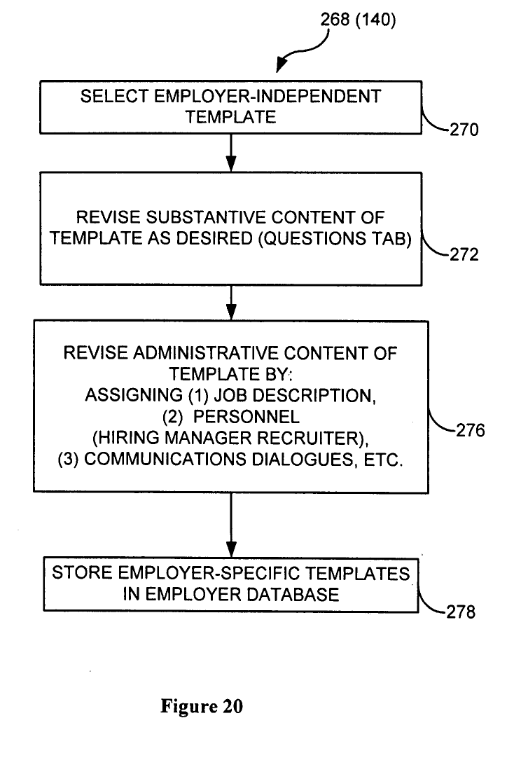

With reference now to FIG. 20, step 252 of employer provisioning process 244 will be described in greater detail. In particular, process 268 for creating employer-specific job templates begins with block 270 where an appropriate employer-independent template is selected. The substantive content of the selected template is revised at block 272 by selecting the QUESTIONS tab 304 of GUI 166 and by revising the content of the canonical questions contained therein as desired. Further, the administrative content of the selected template may be revised at block 276 as desired by selecting the ADMINISTRATION tab 302 of GUI 166 and adding/changing the appropriate values. Such revision may include modifying the job description, assigning various personnel for the prospective employer, and specifying the appropriate communications dialogs. Finally, the process passes to block 278 where the, now completed, employer-specific template(s) are stored in the employer database 150 and file server subsystem (FIG. 4). The logic for provisioning a prospective employer in accordance with the invention shown and described with respect to FIG. 20 is preferably provided by the CASE sub-system 140 as shown in FIG. 4 and those of ordinary skill in the art will readily understand how to code such functionality based on the description contained herein.

### Employer Job Instantiation/Activation and Individual Application

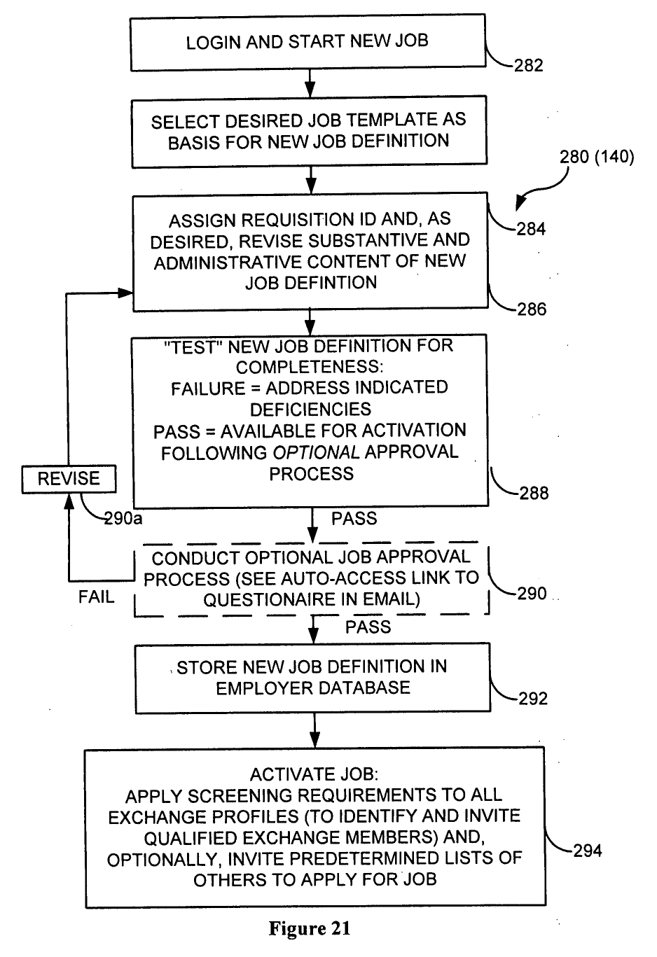

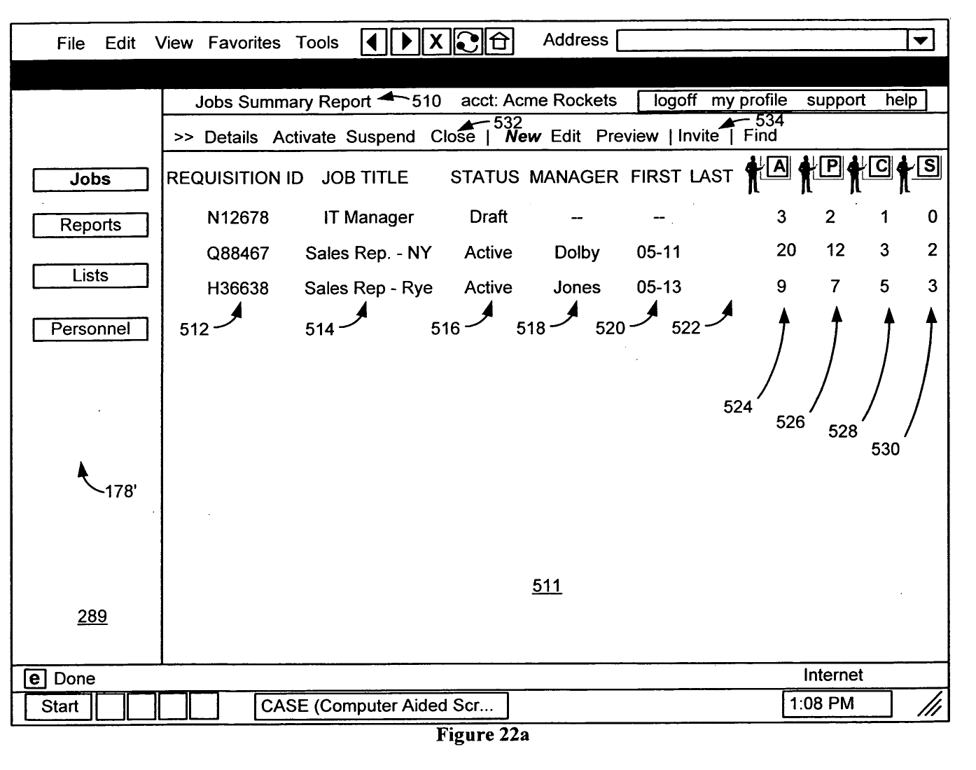

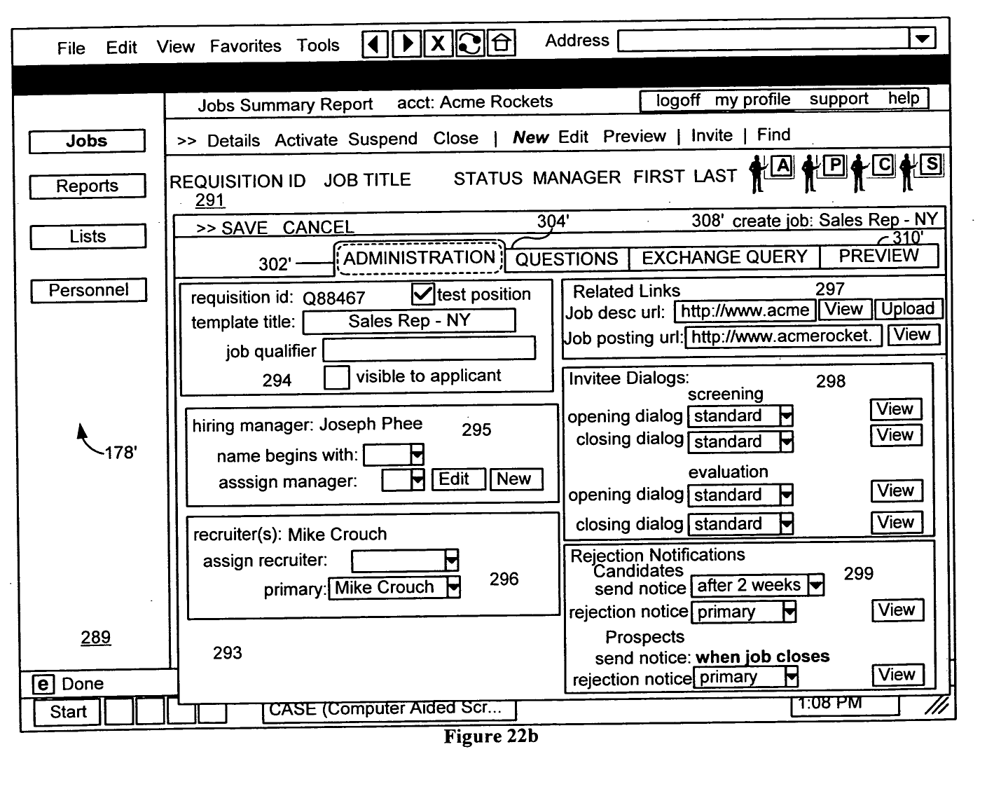

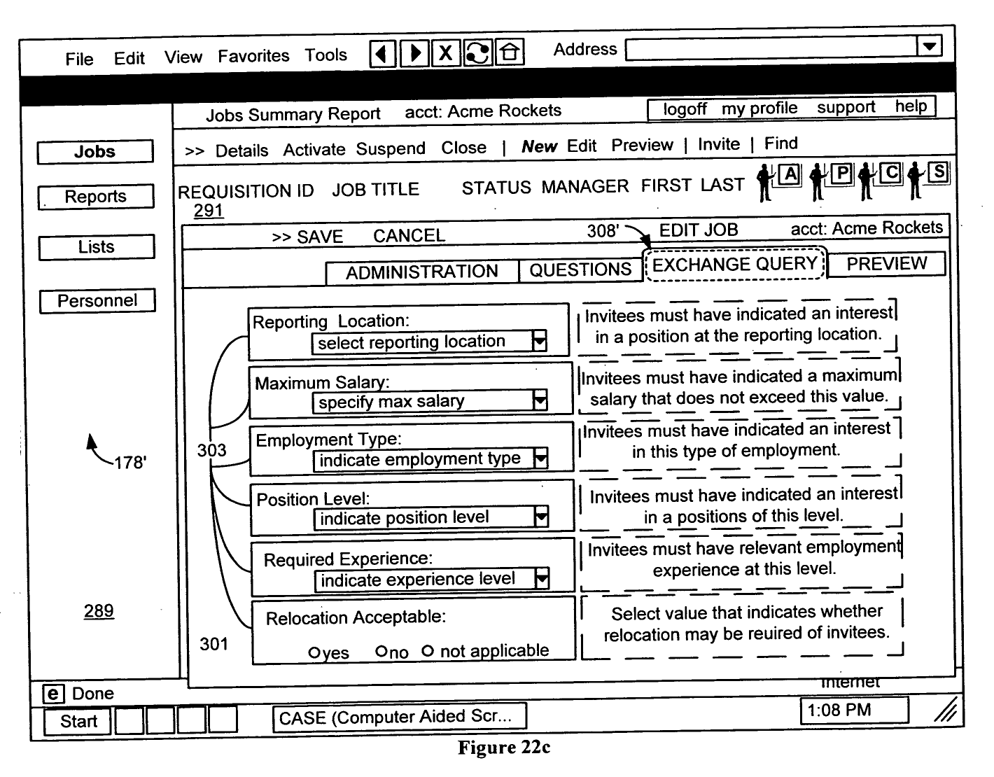

Once the CASE system has been created and a prospective employer has been provisioned, a prospective employer may instantiate a specific job definition that corresponds to a real world job opening/position and activate that job definition. The preferred process 280 for creating/activating an employer-specific job definition in accordance with the present invention is shown in FIGS. 21 through 24. As shown in FIG. 21, process 280 begins at block 282 where an authorized individual logs into CASE 106, selects the “New” control to create a new job and is presented with an employer GUI 289 as best seen in FIG. 22a. GUI 289 preferably includes function buttons 178′ and the default Jobs Summary Report screen 291 of FIG. 22a. Jobs button 178′ is the default selection. It will be appreciated that function buttons 178′ can be used by an employer to navigate through GUI 289 in a manner similar to the correspondingly labeled function buttons 178 of GUI 166 (see, e.g., FIGS. 6-13, 15-16 and 18-19). Naturally, the fact that there are fewer buttons 178′ than buttons 178 reflects the fact that less functionality is built into GUI 289 since CASE usage is less complex than CASE creation and/or administration. The Jobs Summary Report screen 291 provides the employer with a general overview of all job definitions created and/or activated as well as a status overview for individuals as they progress. A more detailed discussion of the various features available to an employer will be presented below. With respect to FIG. 22b, this figure shows a new job window 293 that is presented in response to selection of the “new” control 534 in the upper position of screen 291 of FIG. 22a. Window 293 includes job creation/modification tabs ADMINISTRATION 302′ (activated by default), QUESTIONS 304′, EXCHANGE QUERY 308′, and PREVIEW 310′. More particularly, when an authorized employee chooses to create a new job, the employee is presented with one or more Tabs—each of which containing a list of employer-specific job templates (created by the CASE administrator for the employer). Upon selection of the most appropriate job template, the template is retrieved from the employer database and window 293 is presented with the predetermined/default values presented in the appropriate fields. In the preferred embodiment, windows 294 through 299 are provided so that the employer may revise the information presented therein, respectively requisition ID; hiring manager identification; recruiter identification; link(s) to other sources of information on the job opening; applicant dialogs; and rejection notices. Preferably, the various drop-down lists of windows 294 through 299 provide the employer with a simplified way of selecting from the list (specified during provisioning) of all possible values. Similarly, the “View” buttons provide the employer with a simplified way of viewing (preferably with pop-up windows) the various selections. Completing/revising this information corresponds to the steps of blocks 284 and 286 of FIG. 21 except for revision of the template questions which will be discussed immediately below. The logic for provisioning a prospective employer in accordance with the invention shown and described with respect to FIG. 20 is preferably provided by the CASE sub-system 140 as shown in FIG. 4 and those of ordinary skill in the art will readily understand how to code such functionality based on the description contained herein.

The Exchange Query tab 308′ enables the authorized employee to specify selection criteria that enables the Exchange to perform further refinements in choosing appropriate prospects for a job. Such criteria are seldom, if ever, included in questionnaires presented to applicants, yet they can materially affect the suitability of an individual. For example, individuals of great skill and experience would obviously qualify for entry level positions, but inviting them to apply would be silly, if for no other reason than that individual's income expectations would greatly exceed what the employer is willing to pay. By allowing the authorized user to specify qualifying criteria such as location, position level, and income, the Exchange can then do the sort of precision matching the employer desires.

The Preview tab 310′ is provided to the authorized user as a convenient way to review the questionnaire through the eyes of the applicant. Among other things, it provides a valuable sight audit of the questionnaire that assists the user in quickly determining questionnaire completeness.

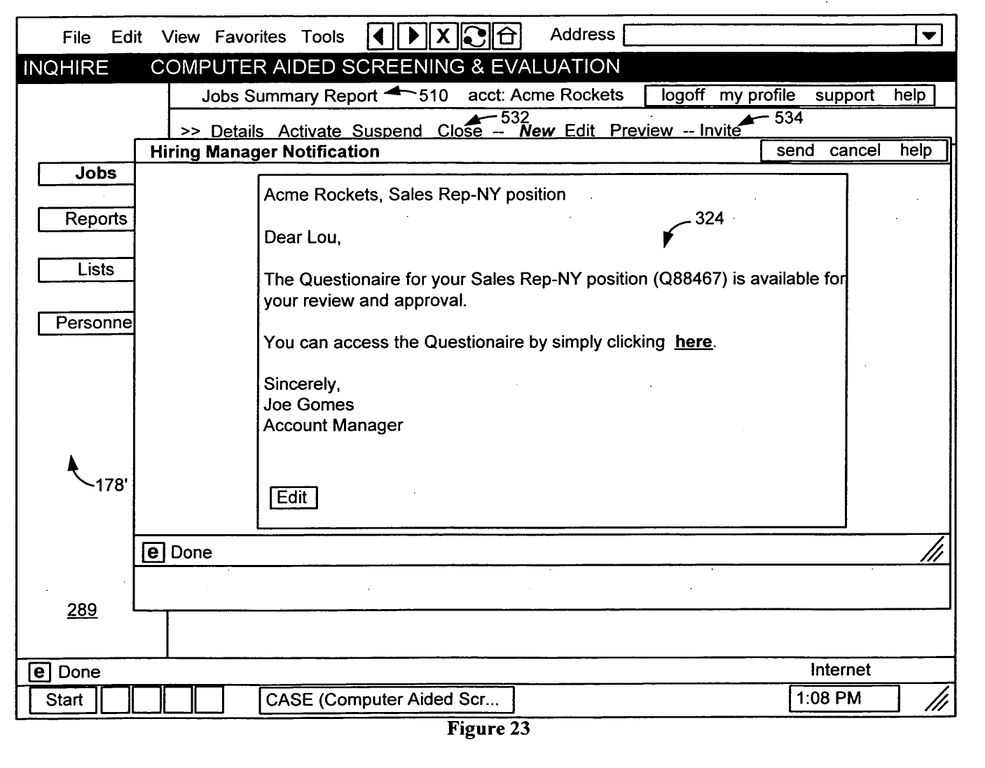

Upon completion of the administrative information of window 293, an employer may select QUESTIONS tab 304′ to access the questions and specified answers contained in the selected job template. In response, CASE 106 will retrieve the appropriate questions from the CASE administration database 148 and file server subsystem of FIG. 4, and present the same for revision as desired. Revision may consist of any combination of one or more of the following possible actions: addition, modification, or elimination of one or more questions; question display order modifications; transfer of one or more questions between the screening and evaluation phases of a questionnaire; the addition, modification or elimination of one or more logical “OR” links between one or more questions; addition, modification or elimination of one or more the available question answers as defined within each assigned question as it relates to the specific job template or job definition; addition, modification or removal of one or more question subject synonyms; addition, modification or removal of both overall question acceptance criteria and that associated with each assigned answer; and modification of any question's designated importance level. During the step of substantive revision, GUI 289 looks and functions substantially similar to that of GUI 166 as shown in FIGS. 16a, 16b and 16c and as described with respect thereto. Upon revision, the process of FIG. 21 passes to block 288 where the job template may, optionally, be “tested” for logical consistency and completeness. Testing is explicitly accomplished by using the Test control 301 shown in FIGS. 16a, 16b and 16c that preferably appears within a job template (anytime) or within a job definition (either prior to activation or following its suspension from an activated state) and when Questions tab 304 has been selected. When the test feature is invoked, CASE 106 will immediately determine if any incomplete or logically inconsistent states exist within the job template or job definition's associated questionnaire (both the screening and evaluation stages); and will describe to the user both the location and nature of each problem. If any problems are detected and reported at this point the employer will resolve them. Additionally, such testing is automatically (implicitly) executed during a job definition's activation (or re-activation) and attempted activation prevented until any and all identified issues have been addressed. Then the process 280 passes to block 290 where job approval occurs. In particular, a notice 324 is sent to the employee who has authority to give final approval of the job definition (see FIG. 23). Typically, a recruiter would draft the job definition and a hiring manager would have the authority to approve the job definition as final. This step is preferably automated in that a notice 324 of a predetermined format is automatically generated and sent to the hiring manager. The notice is preferably automatically populated with a salutation to the hiring manager, the title and requisition id of the job definition, the name of the employee that drafted the job definition and a link to the instantiated job definition. Upon receiving the notice, a hiring manager may view the job definition via “one click” access by simply selecting the link embedded within the notice to either approve the job definition or require that revisions be made. If revisions are necessary, the drafter will revise 290a the job definition by completing the steps of blocks 286, 288 and 290 until approval is granted. When approval is granted, the process passes to block 292 where the job definition's state within the CASE database 148 is updated to “Approved”. Finally, the process 280 of FIG. 21 passes to block 294 where the job definition is activated. Activation preferably entails at least the following sub-steps: (1) determining that the job definition is substantively and logically complete (for example; are all necessary personnel assignments complete?; has a job description been assigned?; are all dialog and rejection notice assignments complete?; and, does the implicit questionnaire “test” function described earlier return without any identified problems?), (2) applying the screening requirements to all Exchange profiles (discussed below) to identify and invite a possibly randomized subset of qualified Exchange members to apply for job opening. Following job activation, any recruiter assigned to the job may invite any number of non-Exchange members and to apply for the job opening by employing one or more prospective employee invitation lists that have been created within CASE by one or more recruiters.

An example of an automatically generated e-mail invitation 558 of the type that is preferably sent to qualified Exchange members and/or prospective employees is shown in FIG. 24a. Each email invitation is individually addressed and processed for each invitee and as shown, such e-mails may include information that was previously specified by the prospective employer. Such information would include (1) the name and a description of the prospective employer, (2) a link to the relevant job description/narrative, various links to information about the prospective employer—company overview, product information, etc., and (3) a link that directs the invitee to CASE 106 so that the invitee may begin the application process. As noted above, during employer provisioning, the links to About Us and Products and/or Services were captured. Because these links seldom, if ever, change, CASE 106 can automatically embed these links into the email displayed in FIG. 24a. Job descriptions, by contrast, are more volatile and may be tailored for each new opening. Referring to FIG. 22b, block 297 illustrates how an authorized user would provide the job description to be included in an email such as invitation 558. Clicking the Upload button of block 297 enables the user to browse for the preferred description and to load it into CASE 106, including the automatic conversion to html format any file that is not already in that format. Once captured, a link to this description is automatically prepared and subsequently embedded within each invitation, such as email 558, sent on behalf of the prospective employer.

CASE generates such invitations for Exchange members who have been prescreened based on desired parameters as discussed above, as well as for non-Exchange-member invitees contained within one or more invitation lists created within CASE 106 by employing various techniques. For example, CASE 106 enables authorized users to create invitation lists employing at least two methods: list importation; and direct sourcing. FIG. 24b shows GUI 289 after the Lists button 178′ has been selected, thereby displaying in window 303 any previously created lists and/or providing the opportunity to create one or more new lists. In the case of FIG. 24b, the list library contains three named lists that were previously created. They are displayed with associated creation and modification dates as well as the number of individuals (entries) presently in each list.

During list importation, a list may be imported from external sources in any of a number of delimited formats by selecting the IMPORT button of FIG. 24b. Such lists may include numerous pieces of information. CASE 106 preferably parses the input to preserve at least each individual's name (if available), his email address, and the source of the name, if designated. Pop-up window 305 of FIG. 24c illustrates the imported list verification screen that is presented when a desired list is imported from an external source as a final check before importation actually occurs. Once the list has been imported by selecting CONTINUE, the list appears in the list library shown in window 303 of FIG. 24b.

With direct sourcing, lists are created through a direct connection to external sources such as one of the prior art job boards discussed above. These boards allow users to conduct searches based upon designated search criteria. Whenever the search contains useful results, the individual's name and email address can be directly added to a list as shown in windows 307 and 309 of FIGS. 24d and 24e. Upon adding the desired information and then saving and closing window 309, the desired list will now be incremented (see, e.g., the ENTRIES column of FIG. 24b) by the number of names added through this process.

As lists are being constructed, CASE 106 preferably checks for and eliminates duplicate names and addresses. This shields recipients from receiving duplicate messages from the employer. Note that an authorized user may append additional entries to any list at any time and that a list may be employed repeatedly—with different jobs as well as for the same job. Note further that if a list is employed repeatedly for the same job, CASE automatically excludes any individuals who have already been invited to apply to that job—and if desired, to that potential employer—so as not to inundate a prospective employee with multiple invitations to the same job and, if desired, the same potential employer.

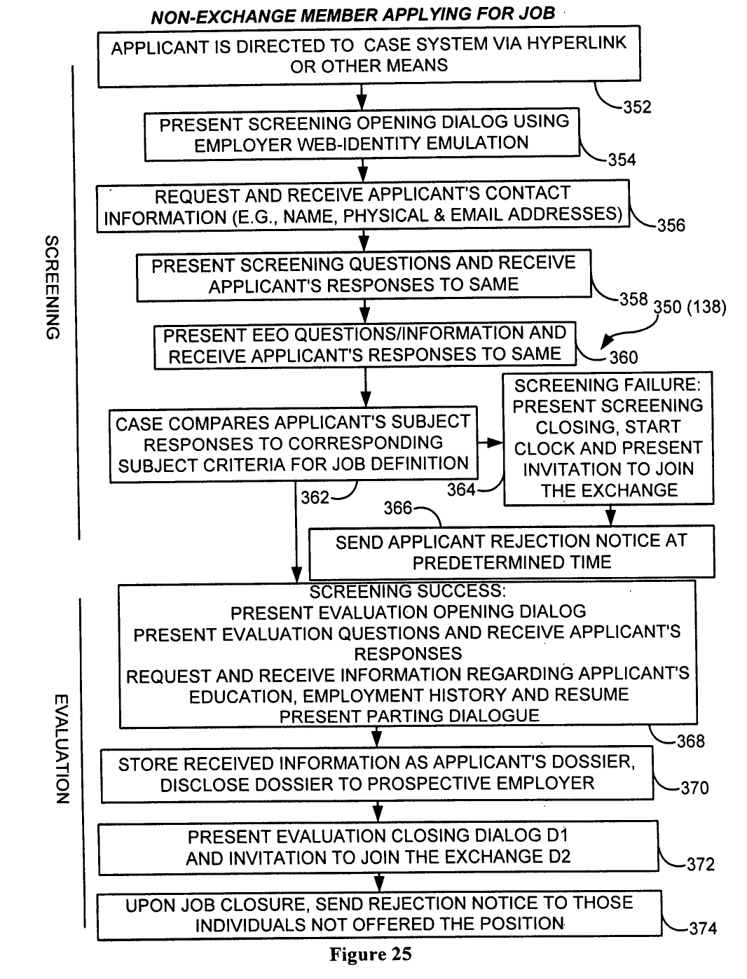

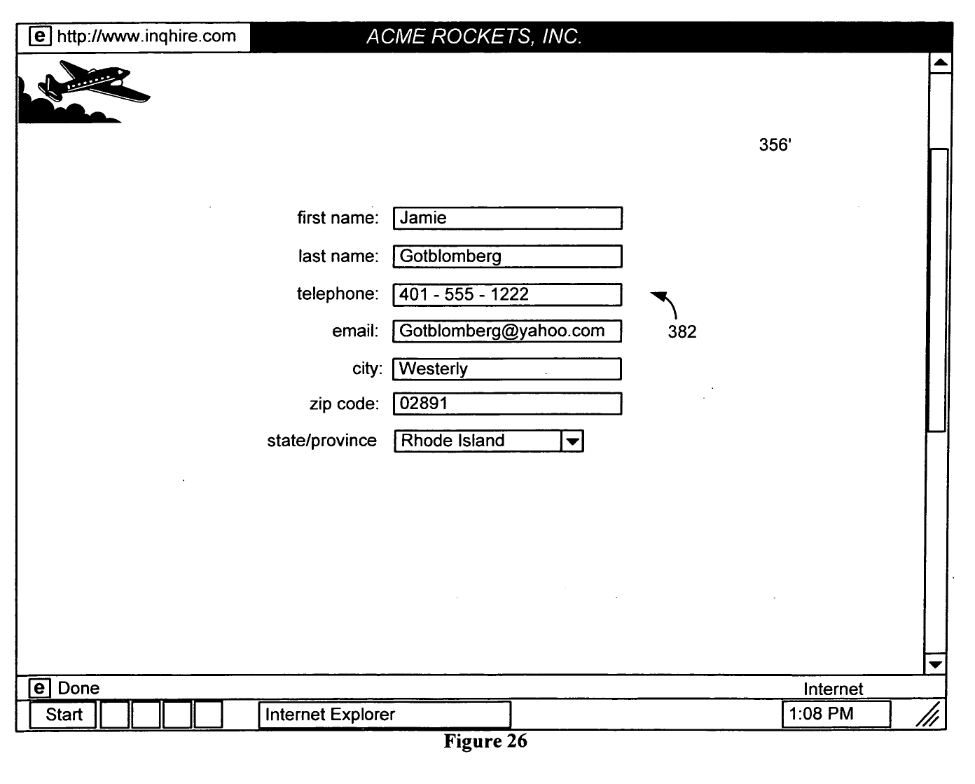

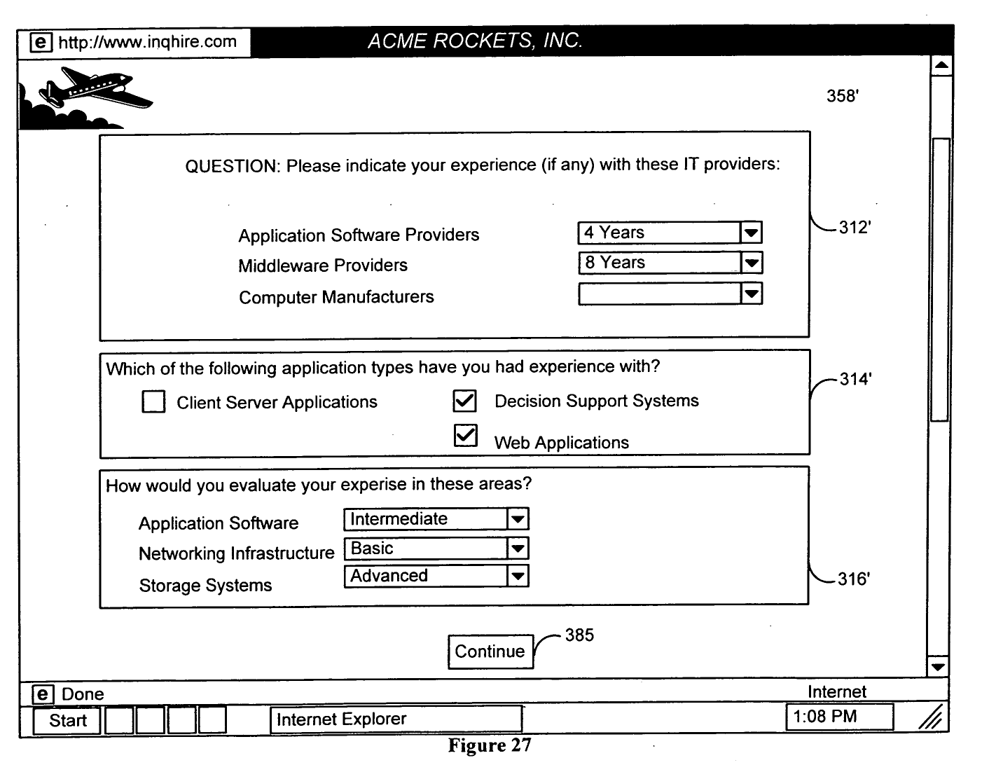

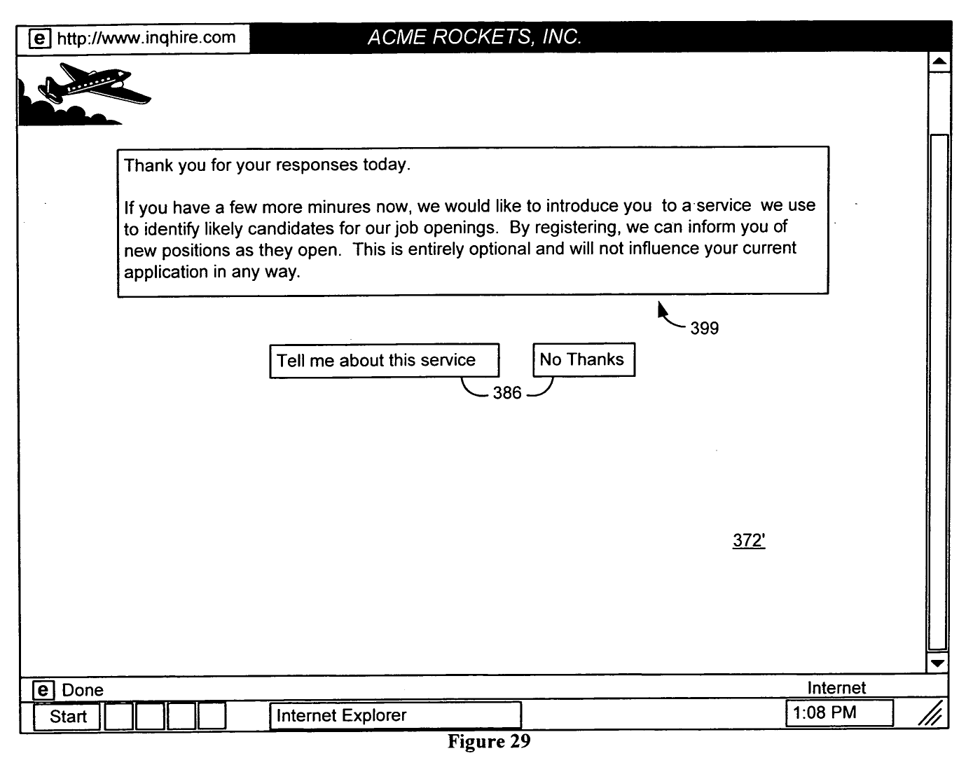

Turning now to FIG. 25, there is shown the general process 350 for applying for an activated job definition in which the individual is an applicant who is not yet an Exchange member. The corresponding applicant GUI screenshots are also presented in FIGS. 26 through 29. As noted immediately above, an invitation 558 preferably includes a link directing the applicant to CASE 106. Upon selection of that link, the applicant is directed to CASE at block 352 and a screening dialog, emulating the prospective employer's web identity, is presented at block 354. CASE would then request and receive the applicant's contact information at block 356 as shown in fields 382 of screenshot 356′ (FIG. 26). The process then passes to block 358 where the predetermined screening questions are presented and the applicant's responses received. The applicant GUI for these screening questions is shown in screenshot 358′ of FIG. 27 where screening questions 312′, 314′ and 316′ are shown with hypothetical responses contained therein. Significantly, these questions correspond to the screening question specified by the prospective employer when revising the relevant job template as shown and described with respect to FIGS. 16a, 16b, and 16c. Then the process passes to block 360 where certain legally mandated information/questions (such as EEOC questions and notices) are presented to the applicant and the applicant's responses thereto are received. The process then passes to block 362 where the applicant's subject-level responses to the screening questions are compared to the subject-level criteria specified in the job definition (see FIGS. 16a, 16b and 16c for specified criteria). If the applicant does not meet the screening criteria, the process advances to block 364 where the predetermined screening closing dialog, including an invitation to join the Exchange if not already a member is displayed; and at which time a rejection notice clock associated with the applicant is initiated. When the rejection notice clock for the applicant reaches the predetermined time, a predetermined notice (preferably via e-mail) will be sent to those applicants that have failed to pass the screen at block 366.

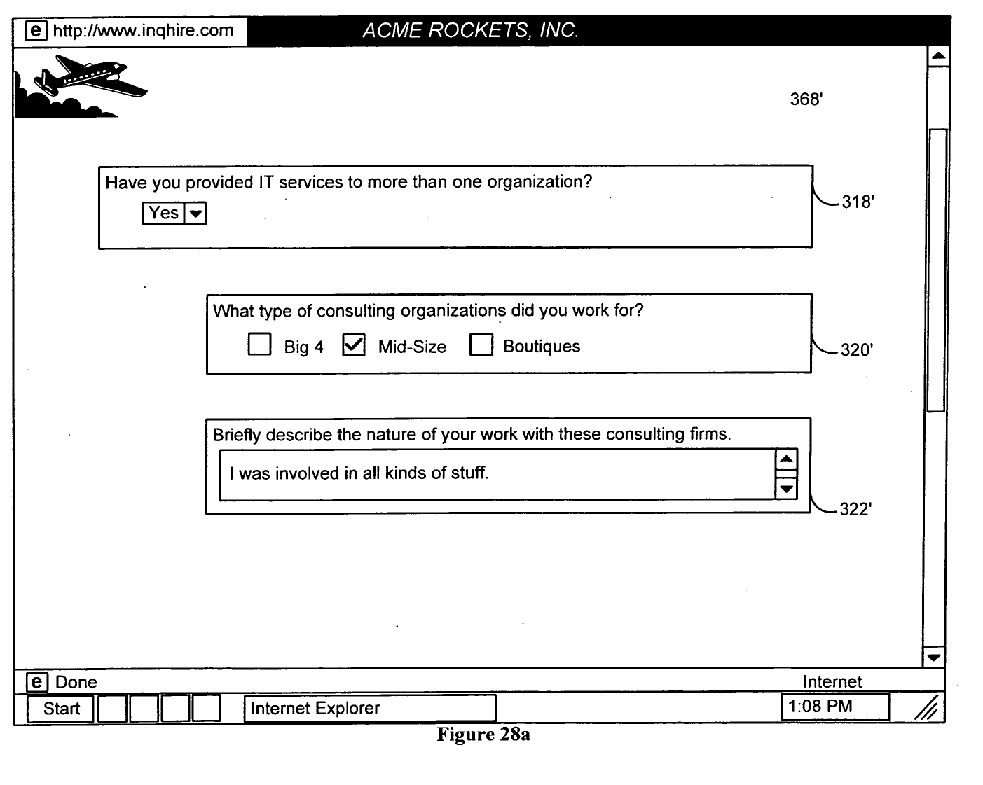

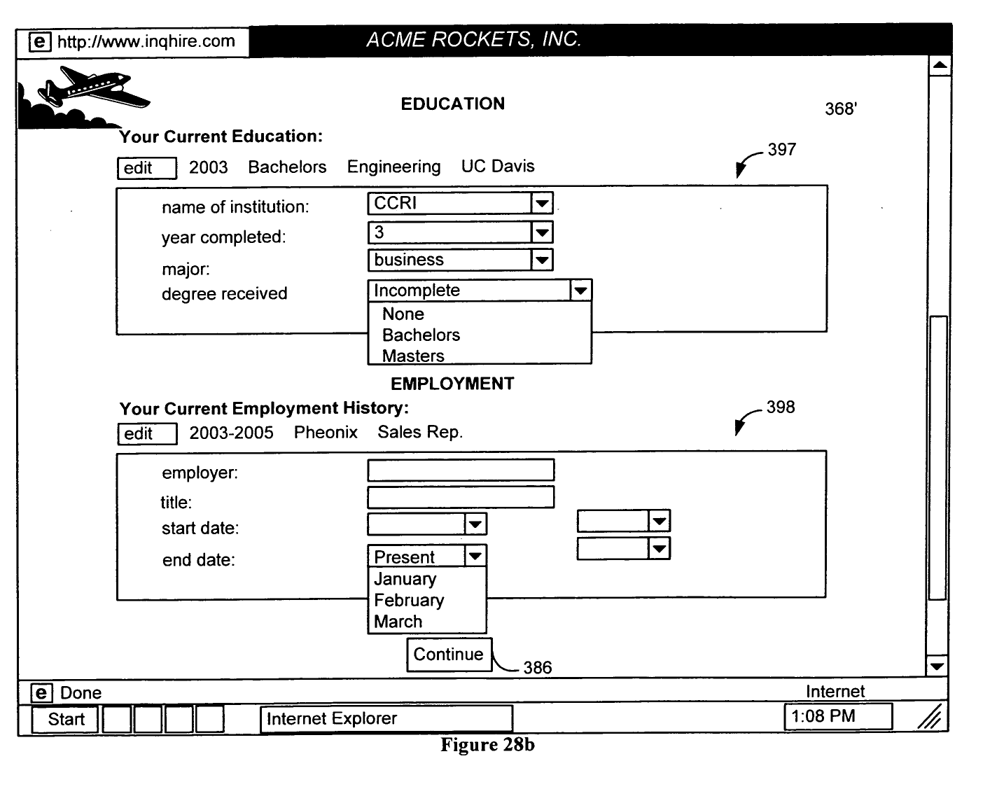

If the applicant meets the screening requirements in block 362, process 350 advances to block 368 where CASE 106 (1) presents the predetermined evaluation opening dialog; (2) presents evaluation questions and receives the applicant's responses; (3) requests and receives information regarding the applicant's education, employment history and résumé; and (4) presents the predetermined parting dialog. As shown in FIG. 28a, screenshot 368′ of the applicant GUI includes evaluation questions 318′, 320′, and 322′ that correspond with questions 318, 320 and 322 as specified by the prospective employer in FIG. 16c. Further, screenshot 368′ of FIG. 28b enables an applicant to provide education and employment data in fields 397 and 398 respectively. Selection of CONTINUE button 386 advances the process to block 370 (FIG. 25) where a dossier is created for the applicant for the job and the applicant's responses and other information are stored therein in the Dossier Database 150 and file server subsystem of FIG. 4. Additionally, the applicant's anonymity is relinquished as the dossier is disclosed to the prospective employer that posted the job definition. Further at block 370, if the applicant is an Exchange member, the applicant's Exchange profile is updated with any newly provided information. The process then passes to block 372 where the applicant is presented with the predetermined evaluation closing dialog. For individuals who are not Exchange members, the closing includes an invitation to join the Exchange; whereas existing members are given an opportunity to review their newly updated Exchange profile. Note that if at any point during the application process an applicant either intentionally (for example, he decides that he would like to complete his application at a later time or date) or unintentionally (for example, due to an internet hiccup or a session timeout) discontinues his application before its completion, CASE automatically preserves all existing data and states so that the applicant can automatically resume the application process from the point at which he previously stopped, as if the interruption never occurred. As the individual advances through the application process, his status changes from Applicant to that of Prospect, Candidate and Short-Listed finalist (on the Short-List). When the employee is selected to fill the job opening from the Short-List, the job definition is closed and a predetermined rejection notice is sent to those individuals who were not offered the position as noted in block 374 of FIG. 25. The logic for processing an individual while applying for a job in accordance with the invention shown and described with respect to FIG. 25 is preferably provided by the APPLICANT sub-system 138 as shown in FIG. 4. Those of ordinary skill in the art will readily understand how to code such functionality based on the description contained herein.

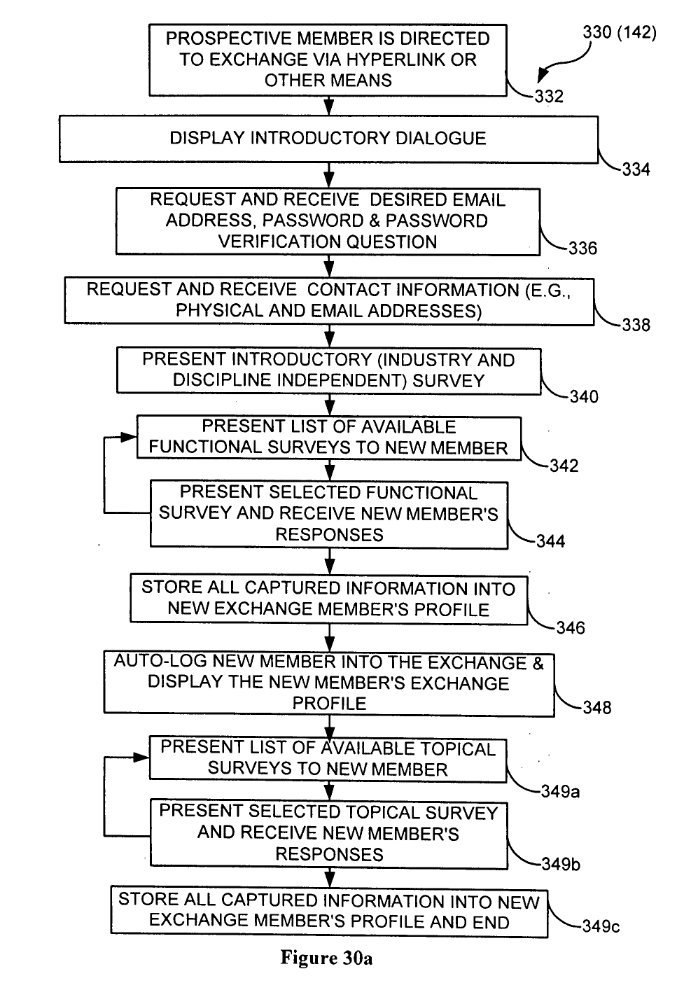

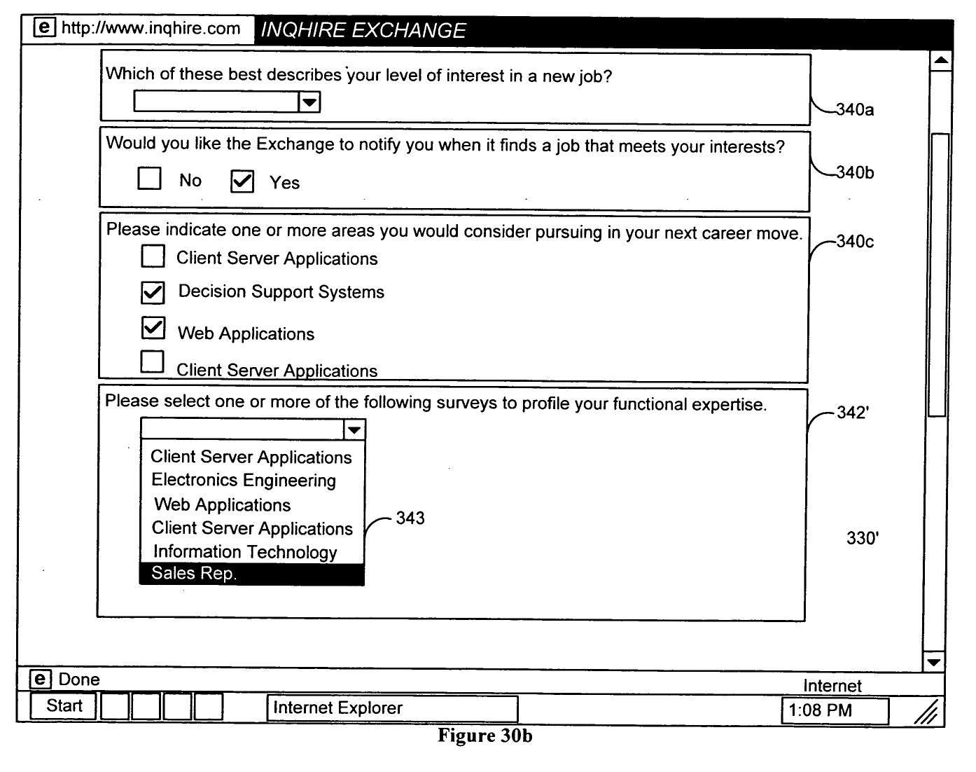

For simplicity, the discussion above has progressed on the basis that the applicant/individual was not a member of the Exchange 108 when responding to an invitation to apply for an activated job. However, certain features of the present invention are not only compatible with applicants that have previously become members of the Exchange 108, but are actually enhanced when the applicant is an Exchange member. These features will become even more apparent from the following description of FIGS. 30a through 33.

Turning to FIG. 30a, there is shown the preferred process 330 for a prospective employee to become a new Exchange member. Note that if an individual is a current or previous job applicant, the individual's newly created member profile automatically includes all relevant data (contact information, question responses, educational history, employment history, résumé, etc.) that were captured during the application process. The process begins at block 332 when an individual is directed to the Exchange via a link and is presented with a predetermined introductory dialog at block 334. At block 336, an e-mail address, password and password verification data is requested of and receive from the new Exchange member. Then further contact information is requested of and received from the new Exchange member at block 338 and an introductory survey is presented at block 340. As shown in the screen-shot 330′ the introductory survey is designed to elicit industry-independent and disciple-independent information from the new member by presenting questions such as those of representative questions 340a, 340b and 340c. At the conclusion of this process, the individual is then requested to profile his primary functional experience at blocks 342 and 344. As shown in screenshot 330′ of FIG. 30b, a window 342′ preferably presents a list of functional surveys 343 that may be selected and completed at blocks 342 and 344 (FIG. 30a). As noted above these industry independent functional surveys are formed from questions having predetermined subjects that correspond to those in the CASE 106 job templates used by prospective employers in activated job definitions. Upon completion of one or more functional surveys, process 330 then preferably automatically logs the new member into the Exchange and presents the member's profile at block 348 so that the member may review his newly created profile and take any further desired actions. For example, the new member may then elect to review and modify his educational or employment histories, to review and update his preferences, to review or add a résumé, and to review or profile his specific industry experience. In this event, process 330 passes to blocks 349a and 349b where a variety of industry-specific (or topical) surveys are presented to the new member for selection and completion. As noted above, these industry specific surveys are formed from questions having predetermined subjects that correspond to those in the CASE 106 job templates used by prospective employers in activated job definitions. Further, they correlate to the industry/job hierarchy of CASE 106 so that the information received from the new Exchange member can be subsequently used to help determine whether the member is qualified for newly activated job definitions. The new member selects and completes any desired number of industry specific surveys and this information is captured into a profile for the member at block 349c and this process ends. The logic for establishing a new Exchange membership in accordance with the invention shown and described with respect to FIG. 30a is preferably provided by the NEW MEMBER and MEMBER ADMINISTRATION sub-systems 142 as shown in FIG. 4. Those of ordinary skill in the art will readily understand how to code such functionality based on the description contained herein.

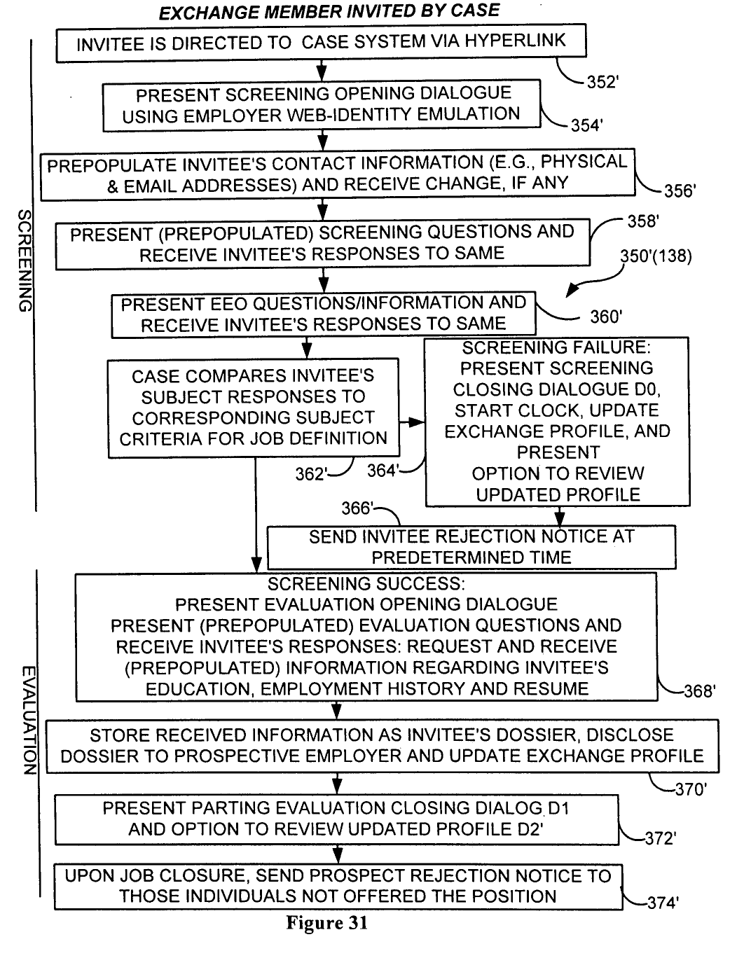

Turning now to FIG. 31, there is shown the general process 350′ for applying for an activated job definition in which the applicant is an Exchange member. While not expressly shown herein, the corresponding applicant GUI is ornamentally and functionally similar to those presented in FIGS. 26 through 29, except as will become obvious from the differences between processes 350 (FIG. 25) and 350′ (FIG. 31). Process 350′ preferably begins at block 352′ when an Exchange member responds to an invitation that includes a link directing the applicant to CASE 106. Upon selection of that link, the applicant is directed to CASE at block 352′ and a screening dialog, emulating the prospective employer's business identity (using slogans and trademarks, logos and other artwork, etc. as specified by the employer) is presented at block 354′. The process then passes to block 356′ where the applicant's contact information is presented and, if appropriate, updates of the automatically pre-populated contact information (based on the information currently available in his member profile) are received. The process then passes to block 358′ where the predetermined screening questions are presented. If the applicant's Exchange profile already contains responses to such questions (for example, because the applicant has already completed an Exchange topical survey that is relevant to the activated job for which he is now applying or because the applicant already answered—as a previous job applicant—this or similar questions containing one or more of the same subjects), the applicant's subject-level prior responses are pre-populated into the relevant fields. The applicant then has an opportunity to revise the pre-populated information and to respond to new questions and the applicant's responses received at block 358′. Then the process passes to block 360′ where certain legally mandated information/questions are presented to the applicant (e.g., in compliance with EEOC requirements) and applicant's responses thereto are received. The process then passes to block 362′ where the applicant's subject-level responses to the screening questions are compared to the subject-level criteria specified in the job definition (see FIGS. 16a, 16b and 16c for representative specified criteria). If the applicant does not meet the screening criteria, the process advances to block 364′ where the predetermined screening closing communication is presented, where a rejection clock is initiated, where the applicant's Exchange profile is updated and where that profile is presented to the applicant so that he may modify it if he so desires. When the clock reaches the predetermined time a predetermined rejection notice will be sent, preferably via e-mail, to the screened-out applicant at block 366′.

If the applicant meets the screening requirements in block 362′, process 350′ advances to block 368′ where CASE 106 (1) presents the predetermined evaluation opening dialog; (2) presents evaluation questions and receives applicant's responses; (3) requests and receives information regarding applicant's education, employment history and résumé; and (4) presents the predetermined parting dialog. If the applicant's Exchange profile already contains any relevant information (for example, because the applicant has already completed an Exchange topical survey that is relevant to the activated job for which he is now applying or because the applicant already answered—as a previous job applicant—this or similar questions containing one or more of the same subjects), the applicant's subject-level prior responses are pre-populated into the relevant fields. The applicant then has an opportunity to revise the pre-populated information and to respond to new questions and the applicant's responses received at block 368′. Also, if the applicant's member profile already includes a résumé, the applicant is provided the opportunity to (1) submit a copy of a résumé that is currently included in the applicant's member profile or (2) submit a résumé that is not currently associated with the applicant's member profile. If the member elects to submit an entirely new résumé, he then has the option of also adding the newly submitted résumé to his member profile. The process then advances to block 370′ where a dossier is created for the applicant for the job and the applicant's responses and other information are stored therein in the Dossier Database 150 and file server subsystem of FIG. 4. Additionally, the applicant's anonymity is relinquished as the dossier is disclosed to the prospective employer that posted the job definition. Further at block 370′, the applicant's Exchange profile is updated with any newly provided information. The process then passes to block 372′ where the applicant is presented with the predetermined evaluation closing dialog and an opportunity to review the newly updated Exchange profile. As the Applicant advances through the application process, his status changes from Applicant to Prospect, to Candidate and to Short-Listed Finalist (on the Short-List). When an Employee is selected to fill the job opening from the Short-List, the job definition is closed and the predetermined rejection notice is sent to those individuals not offered the position as noted in block 374′ of FIG. 31. The logic for processing individuals during the application process in accordance with the invention shown and described with respect to FIG. 31 is preferably provided by the APPLICANT sub-system 138 as shown in FIG. 4. Those of ordinary skill in the art will readily understand how to code such functionality based on the description contained herein.

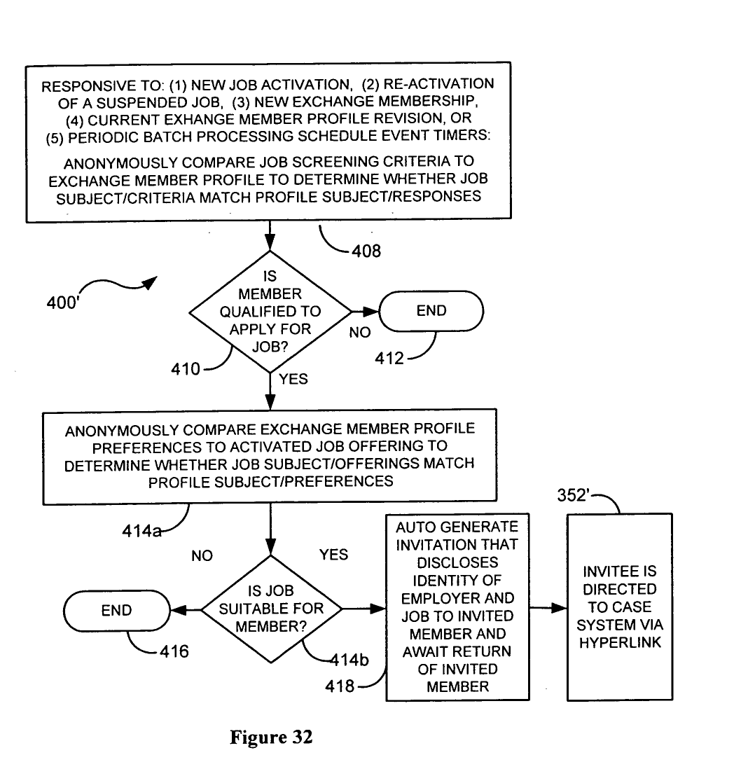

FIG. 32 is a block diagram illustrating the optional anonymous pre-qualification feature of the invention in accordance with one embodiment of the invention. As shown therein, the pre-qualification process 400′ begins at block 408 in response to a new job activation, an existing job re-activation, a new Exchange membership, a current Exchange member profile revision, or a periodic (typically nightly) batch process. This triggers a comparison between job screening criteria and the Exchange profiles, which occurs in an effort to determine whether the job subject-criteria match any profile subject-responses. When the triggering event is a job activation or re-activation, such a comparison preferably occurs between the activated or re-activated job definition and all existing Exchange profiles. When the triggering event is a periodic batch process; such a comparison preferably occurs between all currently activated jobs definitions and all existing Exchange profiles. When the triggering event is due to initiation of a new Exchange membership or due to Exchange member profile revision, such a comparison preferably occurs between the newly created or newly revised member profile and all existing job definitions. When the comparison indicates that a particular Exchange member it is not qualified (at block 410) to apply for a particular job, process 400′ passes to block 412 and terminates with respect to that profile. When the comparison indicates that a particular Exchange member is at least provisionally qualified (at block 410) to apply for a particular job, process 400′ passes to block 414a with respect to that profile. At block 414a, a comparison between the Exchange member profile preferences and the activated job definition occurs to determine if the job definition's subject-level offerings at least meet the provisionally qualified member profile subject-level preferences. If this comparison (block 414b) indicates that a particular job does not meet the member's specified preferences, the process passes to block 416 where it is terminated with respect to that member. Conversely, if the comparison (block 414b) indicates that a particular job meets the member's preferences, the process passes to block 418 where an e-mail invitation that discloses the identity of the employer and information about job to the exchange member is automatically generated. The process then proceeds only if the member, following receipt of the invitation, elects to apply for the job by employing the hyper-link embedded within the email invitation (block 352′) as shown in FIG. 31.

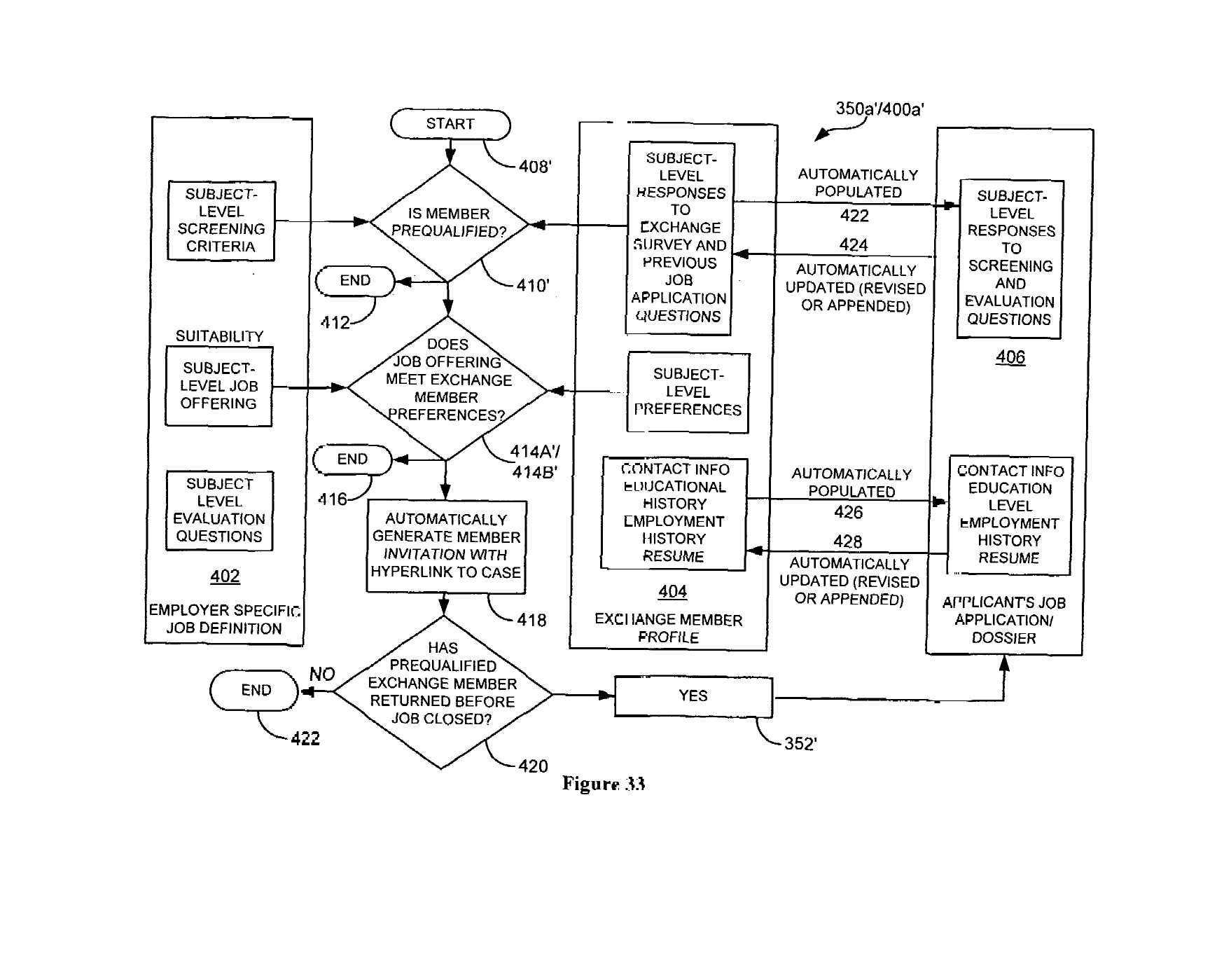

FIG. 33 is a more detailed block diagram of the back-end processing that occurs during execution of the diagrams shown in FIGS. 31 and 32. As shown therein process 350a′/400a′ begins at block 408′ and passes to block 410′ where the screening criteria of the job definition 402 is compared with subject-level Exchange profile 404 to determine whether any Exchange members are at least provisionally pre-qualified for this particular job opening. If not, the process passes to block 412 where it terminates. If so, a comparison occurs at blocks 414a′/414b′ to determine whether the job offering meets or exceeds the Exchange members' preferences, the comparison occurring between the subject-level job offerings of the job definition 402 and the subject-level preferences of the Exchange member profile 404. If not, the process passes to block 460 where it terminates. If so, the process advances to block 418 where an Exchange member invitation having a hyper-link to CASE 106 is automatically generated. Then the process passes to block 420 where a determination is made whether the pre-qualified Exchange member has responded to the invitation before the job definition is closed. If not, the process passes to block 422 where it terminates. Conversely, if the applicant is directed to CASE by a hyper-link at block 352′, the process advances so that additional processing may occur. At this point, a dossier is created to store the applicant's information for this particular job definition. Additionally, the dossier is pre-populated 426 using the member profile subjects/responses and/or subject/preferences and the dossier is pre-populated 422 using the member profile contact information, educational level, employment history, and résumé. Conversely, the Exchange member profile is automatically updated 424/428 as the applicant responds to job definition screening and valuation questions and, optionally, provides updates to the contact information, educational level information, employment history information, a résumé, etc.

### Prospective Employee Dossier/Jobs Data Processing and Reporting

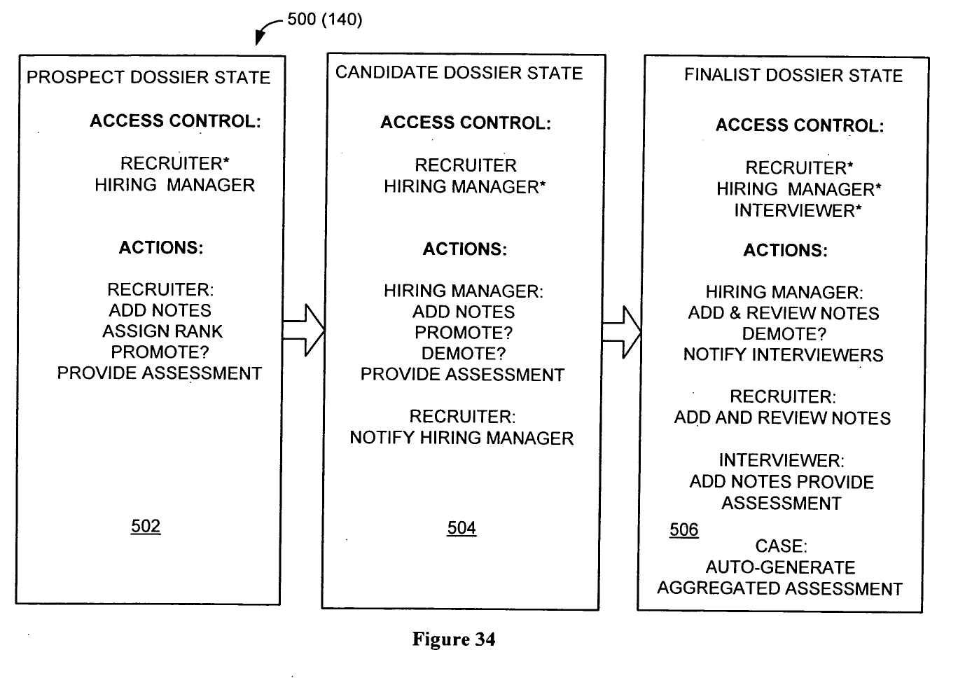

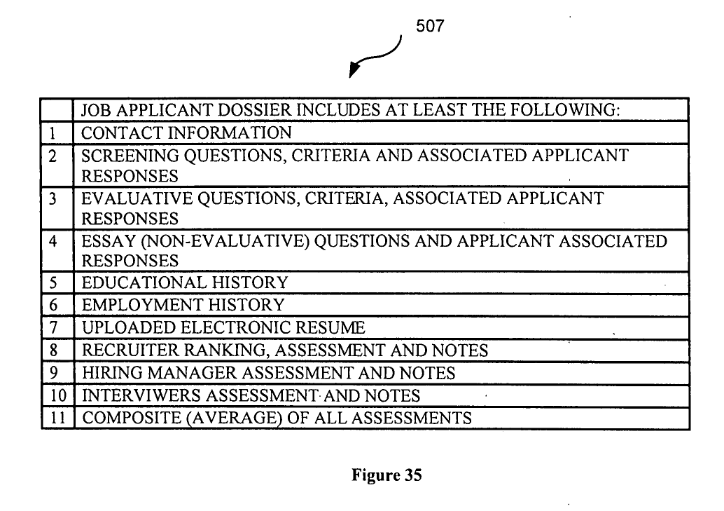

Turning now to the tables 500 and 507 of FIGS. 34 and 35, various details of individual dossier processing and content will be described below. With particular attention to FIG. 34, it will be appreciated that the status of a given dossier will evolve during the application process in a manner that corresponds with the individual's status. As shown in table 500, for example, a given applicant dossier may pass through three additional distinct phases, the prospect dossier phase 502, the candidate dossier phase 504, and the short-listed finalist dossier phase 506 as an individual is sequentially promoted/demoted between the prospect, candidate and short-listed levels. At any point in time, the dossier represents an individual's aggregated information to thereby reflect all of the information provided by the individual as well as any information added by the prospective employer during the application/interview process for both this job application and any previous job applications associated with this individual and prospective employer. The logic for processing an individual's dossier in accordance with the invention shown and described with respect to FIG. 20 is preferably provided by the CASE sub-system 140 as shown in FIG. 4. Those of ordinary skill in the art will readily understand how to code such functionality based on the description contained herein.

At each of states 502, 504 and 506, access to and control over an individual's dossier depends on the authorization level of the person (personnel of the prospective employer) wishing to access the dossier as well and as the state of the dossier itself. In the preferred embodiment, for example, prospect dossier 502, may be accessed either by the assigned primary recruiter or an assigned hiring manager. While the hiring manager may only review, without restriction, any content within the dossier, the recruiter may also take certain actions such as adding notes (narrative assessments) to the dossier, assigning a numerical rank indicating how the individual compares to other identified prospects, promoting the prospect to candidate status, and assigning a non-narrative absolute (non-relative) assessment (for example, an A, B, C, or X) to the prospect. In the candidate state 504, the assigned hiring manager retains access (view capability) to all information contained within the dossier. However, the hiring manager may now also add notes (narrative assessments) to the dossier, promote the candidate to the short-list, demote the candidate to prospect status, and rank the candidate relative to any other identified candidates. While retaining access (view capability) to all information contained within the dossier in the candidate state 504, the assigned primary recruiter may now only notify the hiring manager of the availability of one or more candidates that the recruiter has commended for the manager's review and processing and, at any time, add additional notes.

In the short-listed finalist dossier state 506, the dossier may be accessed by the assigned primary recruiter, an assigned hiring manager, an assigned interview scheduler, and any interviewers that have been assigned to interview the short-listed finalist(s). The hiring manager retains all of the capabilities associated with candidate-status dossiers; plus the ability to assign interviewers to interview the short-listed finalist, to notify any such interviewers of the availability for the dossier for their review, and to designate an individual to act as an interview scheduler who will work with both the short-listed finalist and the assigned interviewers to establish and execute an interview schedule. By contrast, the assigned primary recruiter may only access (view) any information contained within the dossier and add new notes. Assigned interviewers may access (view) any information contained within the dossier excluding any notes, assessments and rankings for which they are not the author. However, an assigned interviewer may add notes to the dossier reflecting the interviewer's impressions of an interview with the short-listed finalist as well as provide an overall assessment of the short-listed finalist. The assigned interview scheduler may only access the short-listed finalist's contact information and information regarding interview scheduling. Finally, CASE 106 automatically generates a composite assessment of the individual absolute assessments provided by the recruiter, and assigned interviewers so that a composite absolute assessment of the short-listed finalist is available as a single letter grade. Grading is done on a weighted average basis, using a 3/2/1 weighting scheme to represent an A, B, and C respectively. In cases where the averages result in fractions, CASE 106 further suffixes the letter grade with a + or −, resulting in nine possible ratings. This granularity ensures that distinctions between candidates can be maintained to an appropriate degree.

With reference now to FIG. 35, there is shown in table 507 the preferred data content of a completed individual dossier. As shown, a preferred dossier preferably includes at least eleven categories of information. These include: contact information; screening questions, criteria and associated individual responses; evaluative questions, criteria and associated individual responses; essay (non-evaluative) questions and associated individual responses; educational history; employment history; uploaded electronic résumé; recruiter ranking, assessment and notes; hiring manager assessment and notes; interviewer assessment and notes; and composite (preferably a weighted average as discussed above) of the assessments of the primary recruiter and all assigned interviewers. As noted above, an individual dossier is intended to evolve throughout the application/interview process and, possibly, to include information spanning multiple job applications—resulting from an applicant who has applied to multiple job openings (activated jobs) associated with a specific potential employer and/or from an applicant whose dossier has been transferred by a potential employer from one job definition (opening) to one or more other job definitions (openings) for alternative or additional consideration. Accordingly, the information contained therein is expected to grow and/or evolve throughout that process.

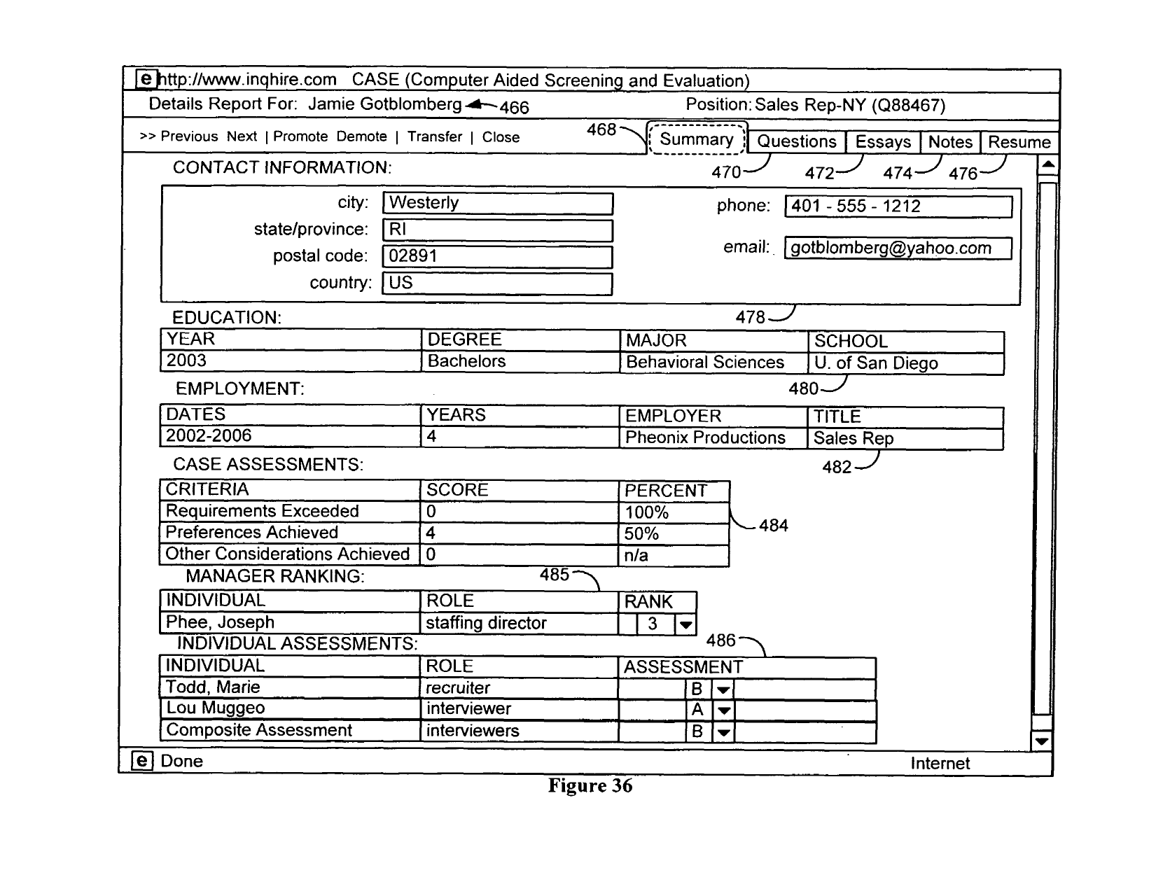

As noted above, the CASE 106 GUI preferably provides a prospective employer with a wide variety of individual monitoring/reporting features. For example, CASE 106 enables authorized personnel of a prospective employer to access a “Details Report” (see screen-shot 466 of FIGS. 36 through 41) that includes the various categories of information included in table 507 of FIG. 35, for each individual dossier created for each current or previously activated job definition stored in the Dossier Database 150 and file server subsystem. When an authorized individual at a prospective employer that has posted a job definition wishes to view a detailed report for an individual, he may launch the CASE GUI by first selecting the desired job followed by the Details command—or by simply selecting the numeric entry listed within any of the four applicant processing states (applicant, prospect, candidate or short-list) and then select the Details Report for the individual of interest. Upon doing so, the GUI produces a screen-shot such as screen 466 of FIG. 36. As shown therein, the Details Report includes tabs for a summary 468, questions 470, essays 472, notes 474, and a résumé 476. Screen 466 also includes the name of the individual and the position for which the individual is applying and the associated requisition number for that job opening. Screen 466 defaults to SUMMARY tab 468 where a variety of information for the individual is displayed in contact information window 478, education window 480, employment window 482, CASE assessments window 484, manager ranking window 485 and individual assessments window 486. The information presented in the Details Report 466 is retrieved from the Dossier Database 150 and file server subsystem and presented for easy viewing. In the case of FIG. 36, the representative Details Report is shown in a final, or near final, state in which the individual has not only completed the job definition, but has also interviewed with several interviewers at the prospective employer and, finally, a composite of assessment has been automatically generated by CASE.

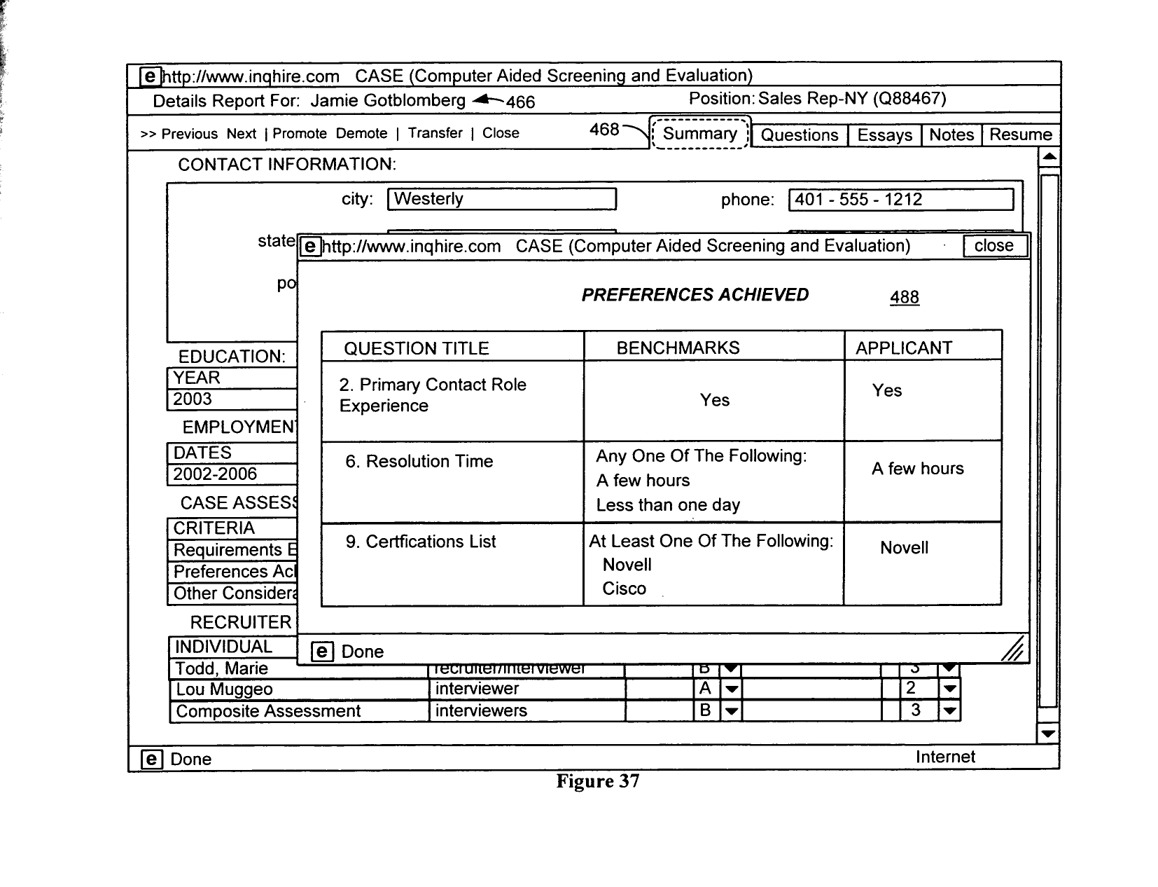

It will be appreciated that a number of the fields displayed within screen 466 are hyper-linked to provide easy access to still more detailed information relating thereto. For example, a prospective employer may select “Preferences Achieved” to launch the PREFERENCES ACHIEVED window 488 of FIG. 37. In response thereto, window 488 presents a convenient table showing all of the evaluation question titles for which the individual met or exceeded the specified benchmarks. Moreover, the specified benchmarks are also presented along with an indication of exactly how the individual responded to the associated questions. Naturally, the information presented in window 488 is drawn from the relevant dossier of Dossier Database 150 and file server subsystem.

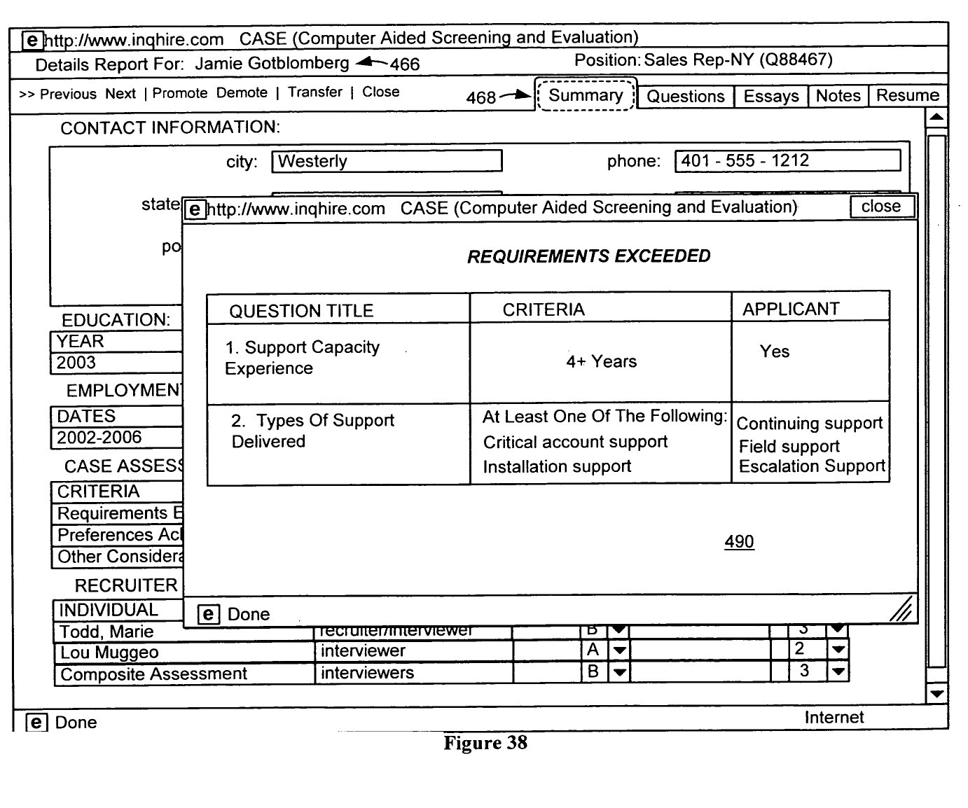

Similarly, selection of the “Requirements Exceeded” activates the REQUIREMENTS EXCEEDED window 490 of FIG. 38. As shown therein, a convenient table is presented showing all of the screening question titles for which the individual met or exceeded the specified criteria. Moreover, the specified criteria are also presented along with an indication of exactly how the individual responded to the associated questions. Again, the information presented in window 490 is drawn from the relevant dossier of Dossier Database 150 and file server subsystem.

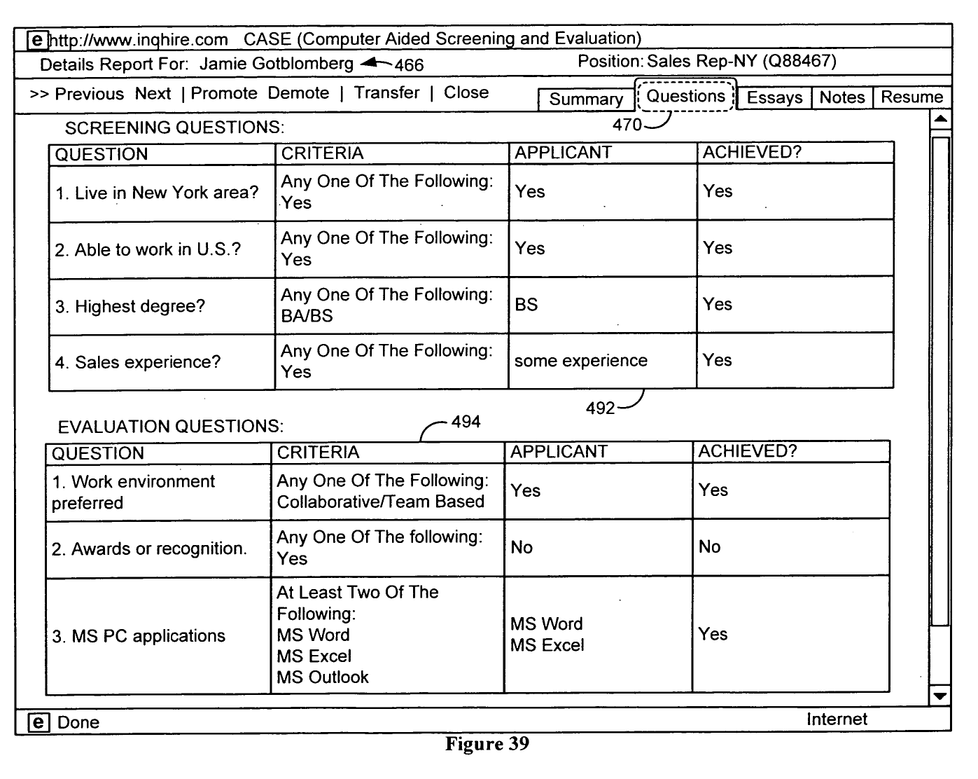

With primary reference now to FIG. 39, there is shown therein a screen-shot showing the status of the Details Report when the “Questions” tab 470 has been selected. As shown therein, selection of the “Questions” tab 470 displays a table 492 showing all of the screening questions presented to and responded to by the individual. In particular, screening questions table 492 includes the actual text of all screening questions presented to the individual, the minimum acceptable criteria for each of those questions, the individual's actual response to those questions, and whether or not the criteria was met. Similarly, the subsequent evaluation questions table 494 includes the actual text of all screening questions presented to the individual, the minimum acceptable criteria for each of those questions, the individual's actual response to those questions, and whether or not the benchmark was met. Again, the information presented is drawn from the relevant dossier of Dossier Database 150 and file server subsystem.

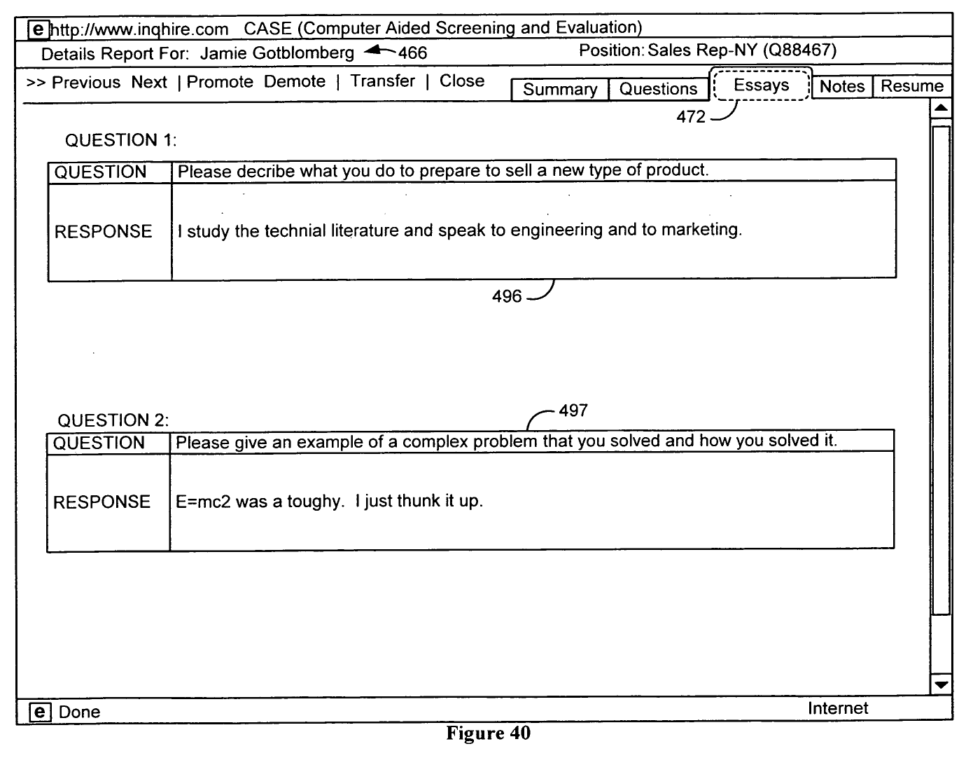

Selection of the “Essays” tab 472, displays a screen including all of the essay questions presented to and responded to by the individual. In the case of FIG. 40, two essay questions 496 and 497 are shown with the actual text of the question as well as the actual text of the individual's response thereto. Again, the information presented is drawn from the relevant dossier of Dossier Database 150 and file server subsystem.

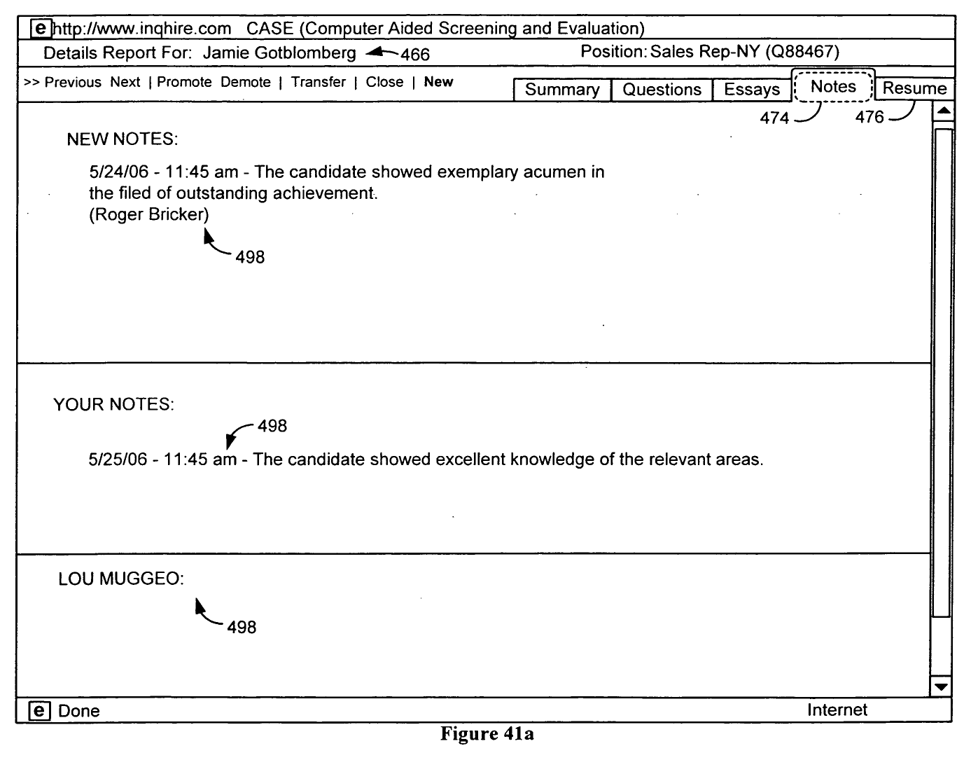

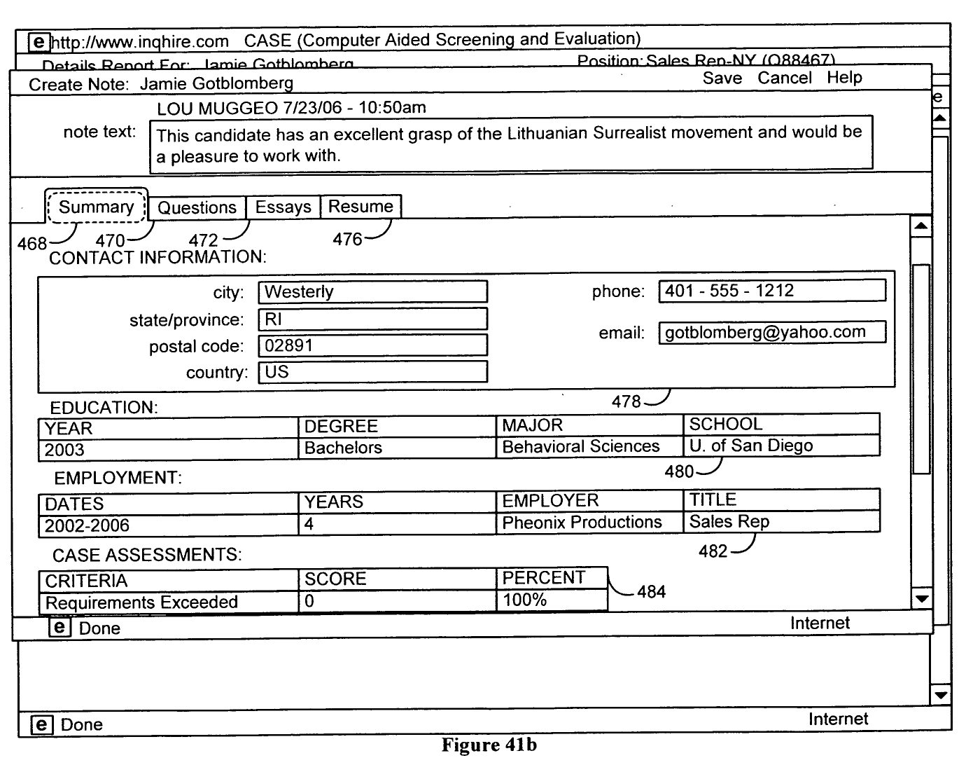

Selecting the “Notes” tab 474 displays a screen including all of the notes input into the individual's dossier during the application process. As shown in FIG. 41a, notes 498 may come from a recruiter, a hiring manager, interviewers, etc. in the form of a narrative and may reflect any information thought significant by the author of the notes. Further, selecting the “New” link will present the “Create Note” screen of FIG. 41b. As shown therein, the Create Note screen provides the user with a free form text field (“note text”) for adding any desired note text, with the SUMMARY 468, QUESTIONS 470, ESSAYS 472, and RESUME 476 tabs and the corresponding information for the selected tab. In the state shown in FIG. 41b, the SUMMARY tab has been selected and the information presented therein is the same as that shown in FIG. 36. Selection of the other tabs will display the information linked thereto, such as that presented in FIGS. 39 and 40. By contrast, the “note text” field will preferably remain visible regardless of which tab is selected. Thus, the user has all of this information at his disposal as he drafts the desired note. Selection of the “Save” link in the upper right-hand corner saves the note and closes the Create Note screen and the newly saved note is added to the other notes (such as those shown in FIG. 41a) for future reference.

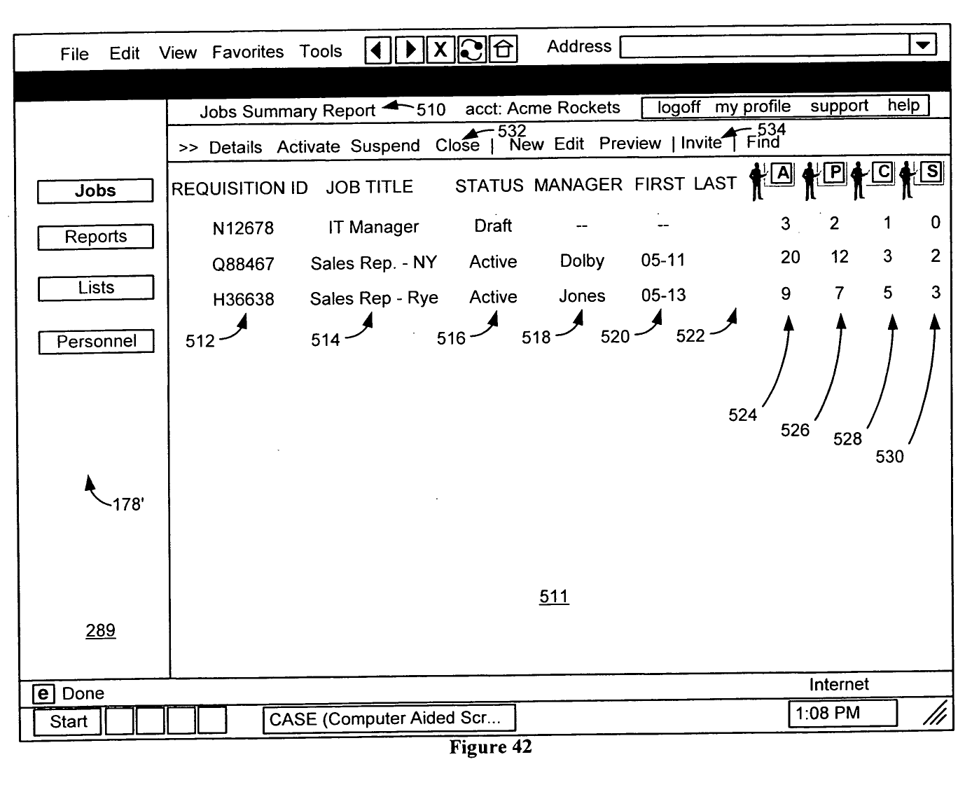

In addition to the Job Details Reports discussed above, CASE 106 enables predetermined authorized personnel of a prospective employer to access a “Jobs Summary Report” (see screen-shot 510 of FIGS. 42 through 50) including the various categories of information included in window 511 of FIG. 42. This Report provides aggregated/overview of information for all of the jobs posted on CASE 106 by the prospective employer. When authorized personnel at the prospective employer wish to view a Summary Report for all employee-recruiting activities, he may launch the CASE GUI and select Job Summary Report 510. Upon doing so, the GUI presents a the communications text screen-shot 510 of FIG. 42 where a prospective employer's hiring manager may specify the dialogs for the evaluation phases of the application process. Along the left-hand side of the screen-shot of FIG. 42 are a number of function buttons 178′ that enable authorized personnel at the prospective employer to access various types of information. In particular, buttons 178′ are provided for accessing JOBS, REPORTS, LISTS, EXCHANGE and PERSONNEL. The purpose and usefulness of these various features will become apparent to those of ordinary skill in the art as the description of the invention proceeds below.

In the case of FIG. 42, the JOBS button 178′ has been selected to display the Jobs Summary Report 510 with window 511. Window 511 provides a variety of information including the job requisition ID 512, the job title 514, the job status 516, the hiring manager's name 518, the date of receipt for the first application 520, and the date of receipt of the last application 522, presented in columnar form for all open jobs of the prospective employer. Furthermore, window 511 shows, in columnar form, the number of applicants 524, the number of prospects 526, the number of candidates 528, and the number of individuals on the Short-List 530 for all of the jobs presented. Further, active buttons 532 and 534 enable authorized personnel to execute the various functions indicated therein. For example, authorized personnel are provided with the ability to activate a job, suspend a job, re-activate a job, close a job, or to provide the details of a job using active buttons 532. Additionally, authorized personnel are provided at the ability to create new jobs, edit existing jobs, preview jobs, and invite prospective employees to apply for various jobs 534.

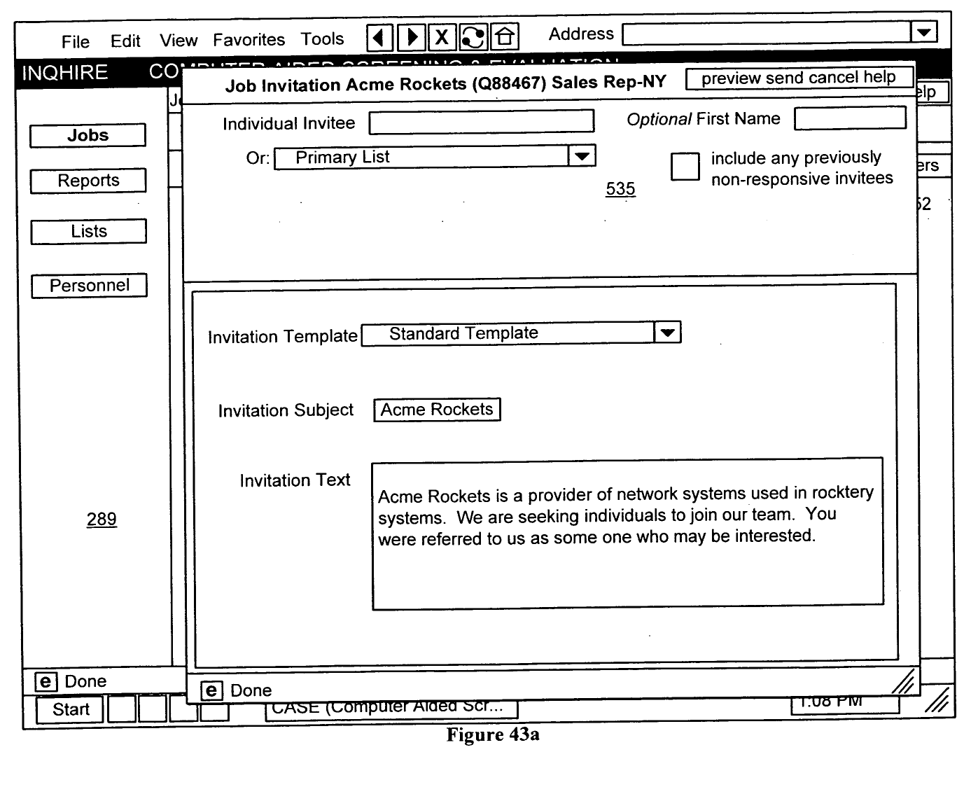

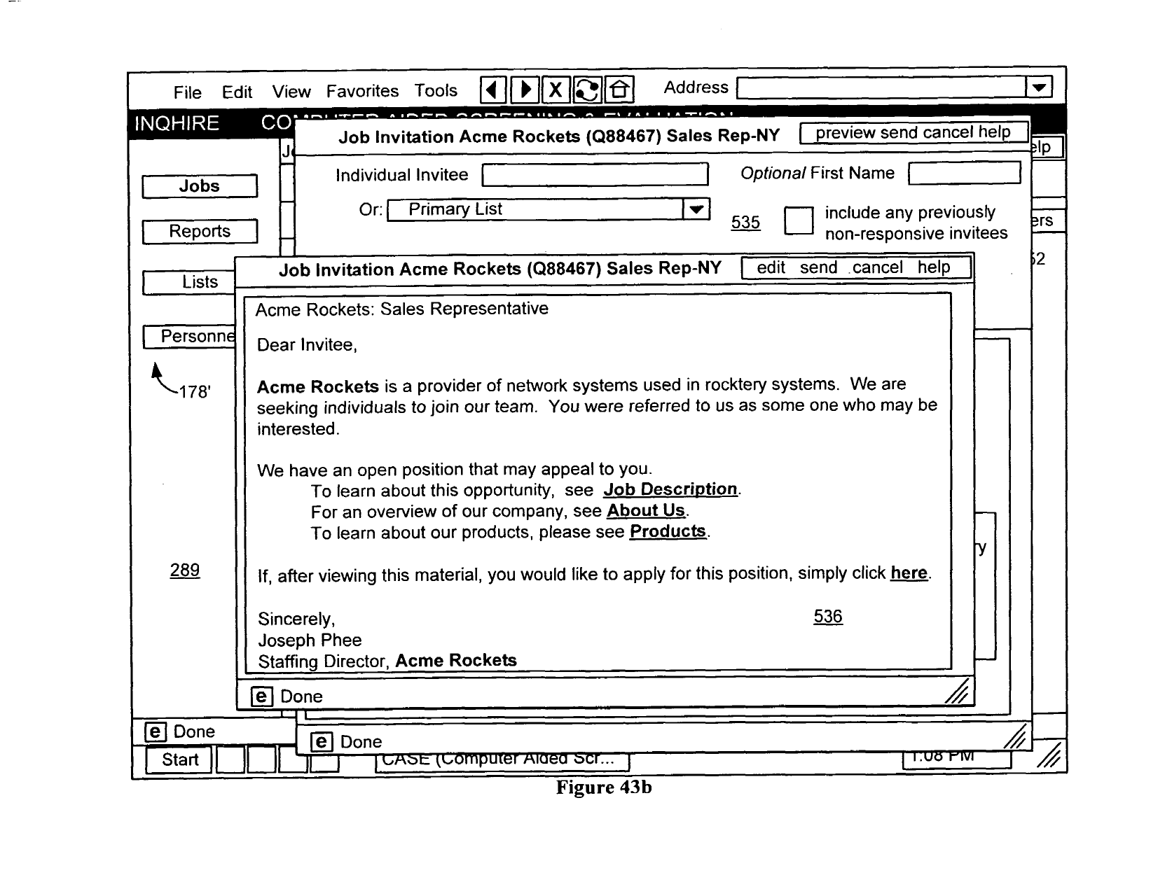

Turning now to FIGS. 43a and 43b, there is shown in FIG. 43a a screen-shot 510 in which the “Invite” button 534 of FIG. 42 has been selected to thereby present job invitation window 535. Window 535 enables the authorized personnel to view and/or edit job invitations that relate to a particular job listed in window 511. Upon completing the information as desired in window 535, the user may select the “preview” button to present the preview window 536 as shown in FIG. 43b. This enables the user to view the invitation in the same form as a would-be recipient and to make further changes as desired. Upon selecting the “send” button, windows 536 and 535 will close, the invitation(s) will be sent, and screen 511 of FIG. 42 will again be presented.

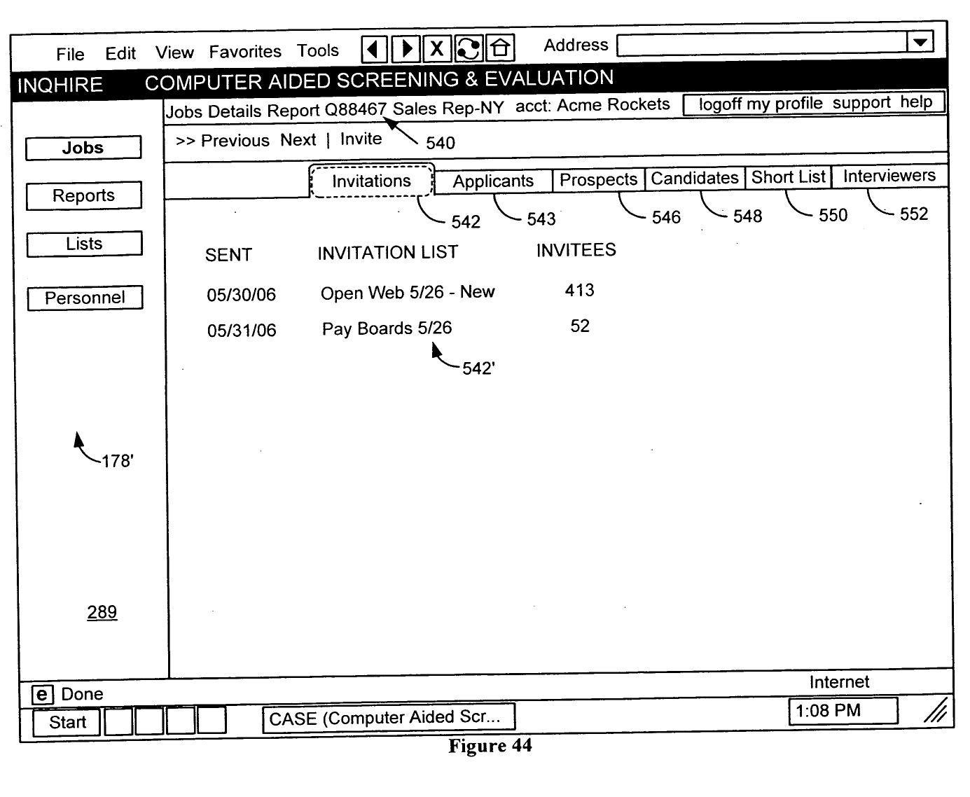

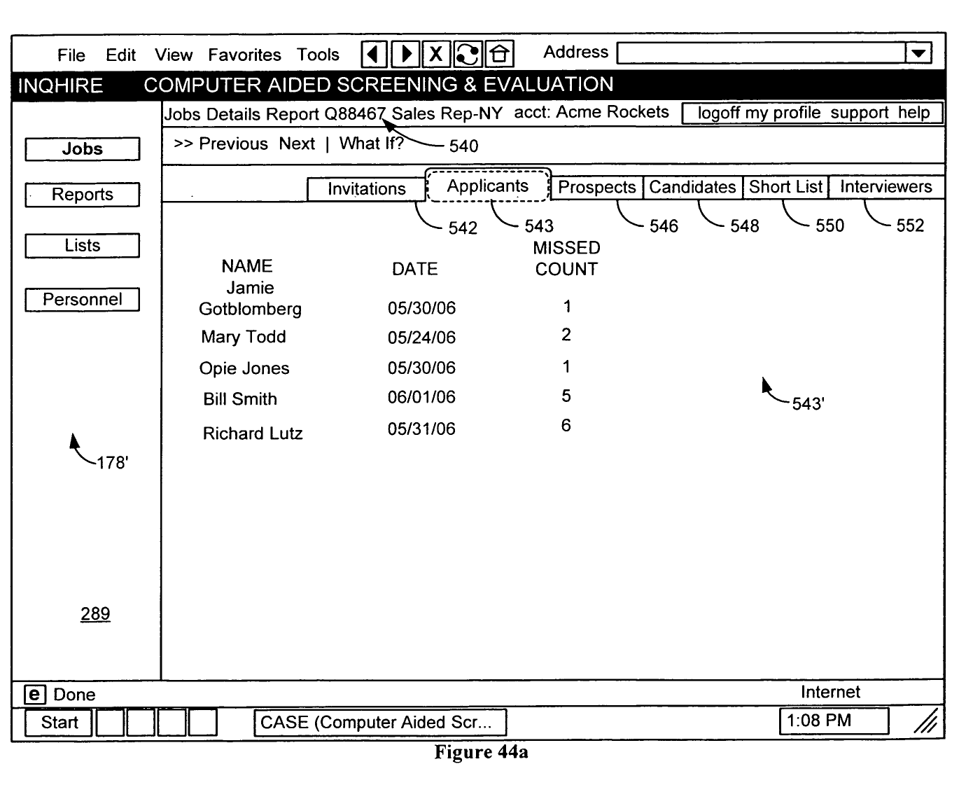

Upon selecting a particular job from the Jobs Summary Report 510 (see, e.g., FIG. 42) followed by the “Details” button 532—or upon simply selecting a numeric entry listed within any of the four applicant processing states (applicant, prospect, candidate or short-list/finalist) of Jobs Summary Report 510, authorized personnel may view a Job Details Report 540 for the selected job as shown in FIG. 44, that includes tabs for Invitations 542, Applicants (543), Prospects 546, Candidates 548, Short-List 550, and Interviewers 552. Screen 540 also includes the name of the job that has been selected, the name of the position to be filled and the associated requisition number for that job. The information presented in the Details Reports 540 is retrieved from the Dossier Database 150 and file server subsystem and presented for easy viewing. In this case, there is shown in columnar form, the dates on which job invitations were sent to prospective employees, an indication of how the invitation list was compiled, and the number of invitations that were sent for the relevant job.

Authorized personnel may also select the “Applicants” tab 543 to display the window 543′ of FIG. 44a and to present, in columnar form, a summary of various metrics for each of the applicants for a given job opening. In the example of FIG. 44a, window 543′ displays the name, application date, and number of evaluation metrics missed by each of the five applicants for the job definition identified at the top of the window. This information is drawn from the relevant dossier of Dossier Database 150. In a preferred form of the invention, the individual's name is linked to the individual Details Report (shown and described above with respect to FIGS. 36 through 41) so that authorized personnel may view the individual Details Report simply by selecting the name of the applicant.

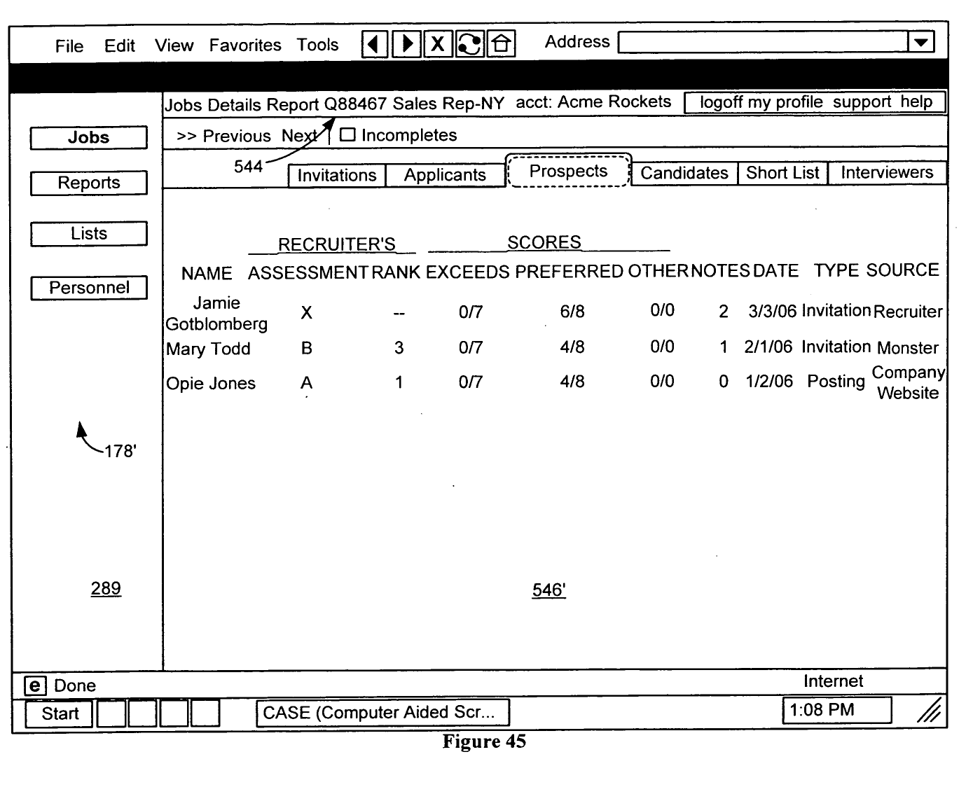

Authorized personnel may also select the “Prospects” tab 546 to display the window 546′ of FIG. 45 and to present, in columnar form, a summary of various metrics for each of the prospective candidates for a given job opening. In the example of FIG. 45, window 546′ displays the name, application date, assessment, and rank of each of the three prospects for the job definition identified at the top of the window. This is accompanied by other system-derived information, including: scores, an indication of the number of notes compiled, the type of mechanism used to attract the prospect, and the source ultimately responsible for the prospect's appearance. This latter information, when aggregated across all jobs, provides an employer with keen insights into which of their sources are most productive. Again, the information presented is drawn from the relevant dossier of Dossier Database 150. In a preferred form of the invention, the individual's name is linked to the individual Details Report (shown and described above with respect to FIGS. 36 through 41) so that authorized personnel may view the individual Details Report simply by selecting the name of the prospect.

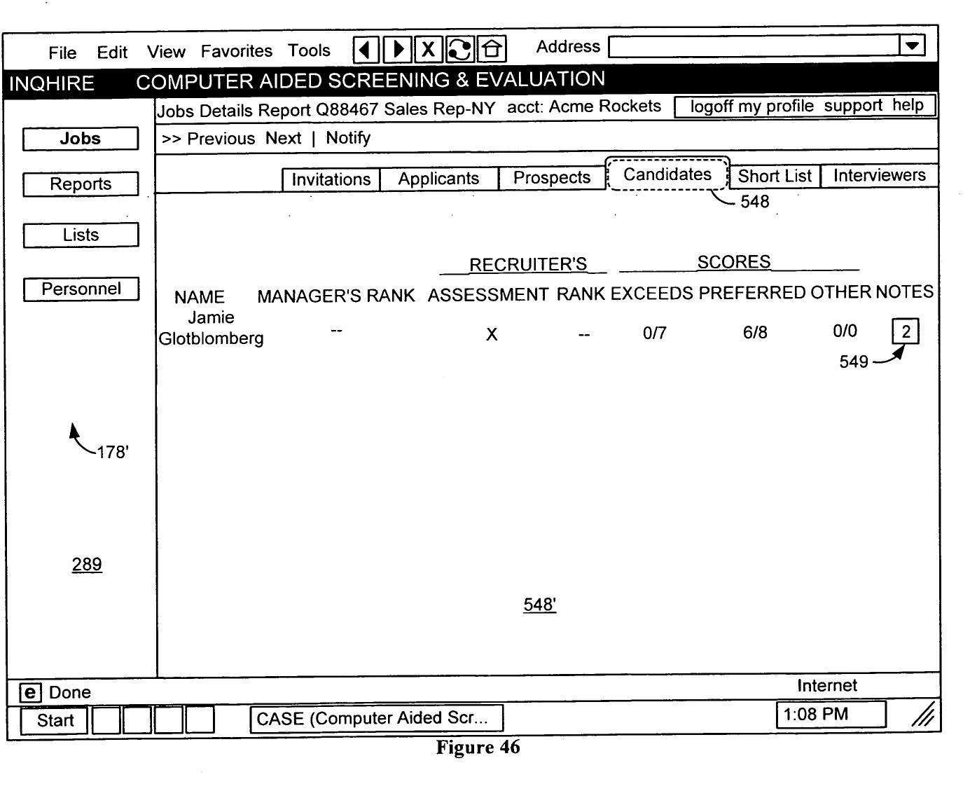

Authorized personnel may also select the “Candidates” tab 548 to display the window 548′ of FIG. 46 and to present, in columnar form, a summary of various metrics for each of the candidates for a given job opening. In the example of FIG. 46, window 548′ displays the name, assessment, and rank of the one candidate for the job definition identified at the top of the window. Additionally, window 548′ presents a summary of the screening criteria exceeded and the evaluation criteria satisfied. As with the information in window 546′, this information corresponds to the information presented in a more detailed form in windows 492 and 494 of FIG. 39. One preferred feature includes the use of a highlight-box 549 to thereby indicate to the user that at least one other system user has added at least one other note that has not yet been viewed by the user. After viewing the content of the new note, highlight box 549 will not be displayed to that user again unless/until another user adds yet another new note. Again, the information presented is drawn from the relevant dossier of Dossier Database 150. In a preferred form of the invention, the individual's name is linked to the individual Details Report (shown and described above with respect to FIGS. 36 through 41) so that authorized personnel may view the individual Details Report simply by selecting the name of the candidate.

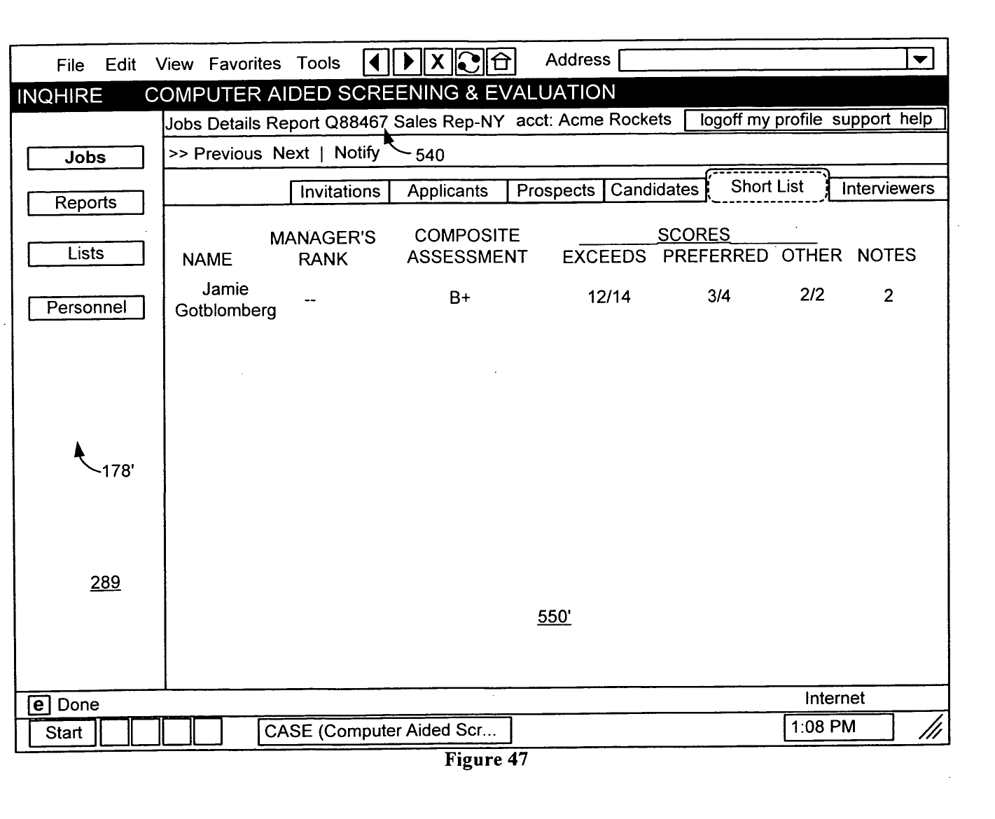

Authorized personnel may also select the “Short List” tab 550 to display window 550′ of FIG. 47 and to present, in columnar form, a summary of various metrics for each of the individuals selected to be interviewed for a given job opening. In particular, window 550′ displays the name, assessment, and rank of each such candidate for the job definition identified at the top of the window. Additionally, window 550′ presents a summary of the screening criteria exceeded and the evaluation criteria satisfy. Again, the information presented is drawn from the relevant dossier of Dossier Database 150. In a preferred form of the invention, the individual's name is linked to the individual Details Report (shown and described above with respect to FIGS. 36 through 41) so that authorized personnel may view the individual Details Report simply by selecting the desired name from the Short-List.

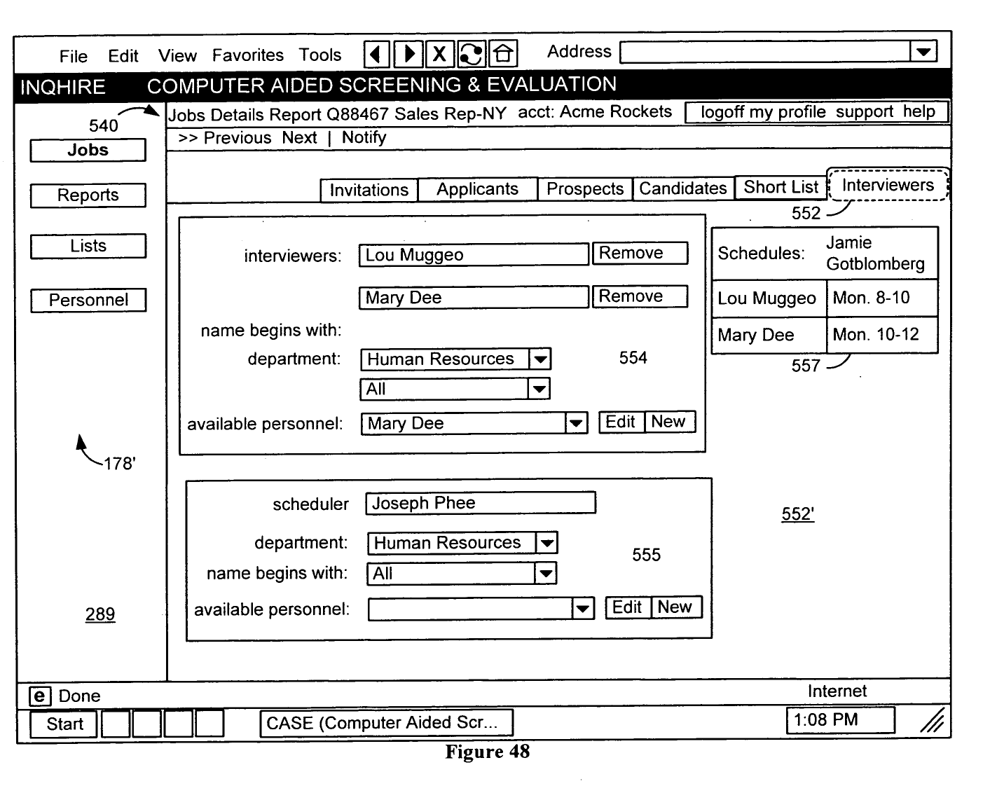

Authorized personnel may also select the “Interviewers” tab 552 to display the interviewers' window 552′ and to present window 554 as shown in FIG. 48. In particular, window 554 enables a hiring manager to assign a scheduler (see window 555) that will create a list of interviewers for a given job opening and to add or delete members from that list as desired (see window 554). Interviewers may be added in any order and from any department of the employer. Individuals not presently assigned to the personnel system may be added dynamically. Additionally, authorized personnel, including managerial assistants that serve as interview schedulers, may access the Interviewers tab 552 for purposes of constructing the entire interview schedule. This schedule is generated dynamically and presented in the Schedules window 557 as both interviewer and candidates are added. Each entry on the schedule provides a day and time for each interview. CASE 106 automatically notifies interviewers of a pending interview prior to its occurrence and, following a scheduled interview, notifies those interviewers whose feedback (one or more notes and an assigned assessment) is missing or incomplete.

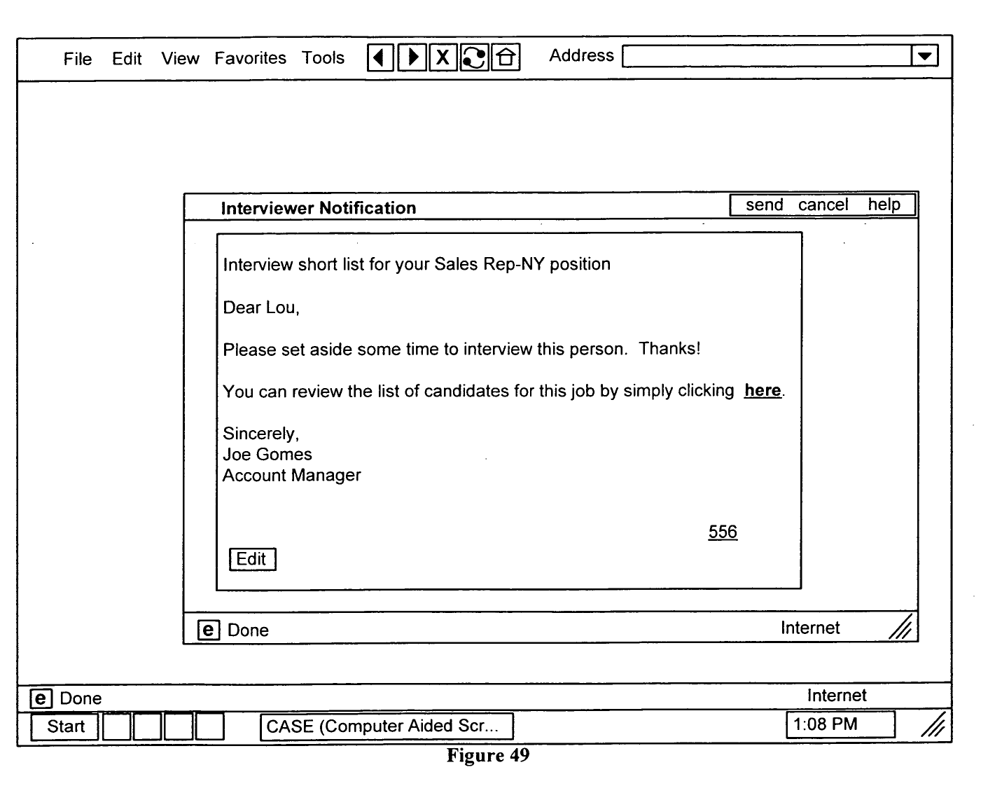

After interviewers have been selected, the hiring manager notifies the interviewers by using the Notify function as displayed in window 554 of FIG. 48. This function automatically generates a separate window 556 of FIG. 49 that enables the hiring manager to generate customized email message to each of the assigned interviewers notifying them of the availability of short-listed finalist dossiers for their review. Each email message contains an embedded link that, upon invocation, provides “one click” access to all short-listed finalists within the Short List tab 550 and to display window 550′ of FIG. 47, thereby enabling them to record notes and ratings for each candidate. These additions are automatically propagated so that both the hiring manager and the recruiter may view updates as they occur. Note that dossier modifications by any authorized individual are immediately and automatically highlighted to bring the new information to the assigned recruiter and or hiring manager's attention. For example, the availability of one or more new (unread with respect to each individual assigned recruiter or hiring manager) prospect, candidate or short-listed finalist notes is highlighted so that assigned recruiters and hiring managers can quickly and easily identify and access such new information. The “new information available” indicator reflects an individual dossier's status with respect to each individual who has been authorized to access the dossier. The “new information available” indicator is automatically removed with respect to each authorized individual following the authorized individual's specific access of the associate newly available information—and not simply as a result of accessing the dossier in general.

### Exchange Profile and Applicant Dossier Rescreening

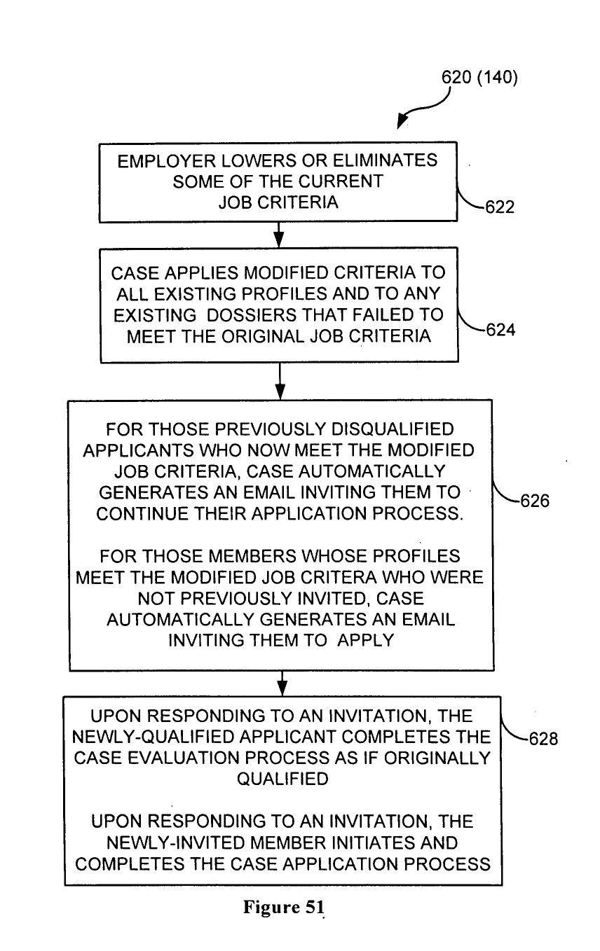

The dynamic nature of the employment recruiting system 100 of the invention is also reflected in a prospective employer's ability (flexibility) to revise a job definition's screening criteria to ensure the availability of a sufficiently large pool of prospects (qualified applicants) without becoming inundated with under-qualified or marginally qualified applicants—while ensuring the consistent application of job screening criteria to all applicants, including in those instances where screening criteria are modified subsequent to the processing of one or more applicants. Optional process 620 of FIG. 51 depicts the preferred manner of executing job criteria “what if” and, if desired, resulting re-screening scenarios (i.e., how many Exchange members and/or currently disqualified job applicants would qualify for further consideration if one or more of the currently enforced job screening criteria were lowered or eliminated). As shown, process 620 will, typically, commence when a prospective employer has determined that an initial set of job criteria has yielded an insufficient number of individuals—or when a prospective employer discovers that a number of otherwise attractive applicants only narrowly failed the screening process due to screening criteria that, in hindsight, did not really need to be so stringent or even included as qualifying criteria at all. In response thereto, the employer may elect to lower or eliminate job criteria that are currently in force at block 622 by modifying or eliminating criteria associated with one or more screening questions (and/or by eliminating entire screening questions) as described above with respect to FIGS. 16a and 21. This is accomplished by selecting the “What If” command to test the resulting outcome and thereby ensure that the outcome meets the prospective employer's expectations; if they do, selecting the “Apply” command invokes the prescribed changes. Upon applying these changes, CASE 106 automatically saves the updated job description, re-applies the newly revised screening criteria to all existing profiles and dossiers that failed to meet the previously established job criteria (process block 624), automatically generates e-mail invitations to invite any newly qualified Exchange members to apply and/or to invite any previously disqualified, but now newly qualified, applicants to continue their applications (process block 626). Finally, the process passes to block 628 where, upon responding to such e-mail invitations, the newly qualified applicants may continue to apply for the job definition just as if they had passed the original screening criteria. Other optional embellishments to process 620 would allow the prospective employer to review various metrics related to re-screening prior to issuance of new e-mail invitations. Such an iterative step, allows a prospective employer to repeatedly tailor the job criteria until a reasonable/desired number of invitations has been achieved. The logic for re-screening profiles and/or dossiers in accordance with the invention shown and described with respect to FIG. 51 is preferably provided by the CASE sub-system 140 of FIG. 4. Those of ordinary skill in the art will readily understand how to code such functionality based on the description contained herein.

While the present invention has been described in connection with what is presently considered to be the most practical and preferred embodiments, it is to be understood that the invention is not limited to the disclosed embodiments, but is intended to encompass the various modifications and equivalent arrangements included within the spirit and scope of the appended claims. With respect to the above description, for example, it is to be realized that the optimum dimensional relationships for the parts of the invention, including variations in size, materials, shape, form, function and manner of operation, assembly and use, are deemed readily apparent to one skilled in the art, and all equivalent relationships to those illustrated in the drawings and described in the specification are intended to be encompassed by the appended claims. Therefore, the foregoing is considered to be an illustrative, not exhaustive, description of the principles of the present invention.

1. A computerized employment recruiting system comprising:
a CASE database of job definitions with at least one prospective employer, each of the job definitions having question-independent subject-level job criteria and job offerings;
a workforce-profile database of individual profiles, each of the profiles having question-independent subject-level individual qualifications and individual preferences;
a communications port for user access to the system; and
an information manager interacting with the CASE database, the workforce-profile database and the communications port comprising a subsystem for a bi-directional subject-level matching between the CASE database and the workforce-profile database and for passing information and queries through the communications port.

2. The employment recruiting system of claim 1 wherein the prospective employer may activate a new job definition and wherein the matching automatically occurs responsive to new job activation.

3. The employment recruiting system of claim 1 wherein the individual may activate a new individual profile and wherein the matching comprises antecedent pre-qualification matching between the new profile and the job definitions.

4. The employment recruiting system of claim 1 wherein the individual may activate a new individual profile, wherein the prospective employer may activate a new job definition and wherein the matching comprises both antecedent pre-qualification matching and matching responsive to new job activation.

5. (canceled)

6. (canceled)

7. The employment recruiting system of claim 1 wherein
the prospective employer and the individuals remain anonymous relative to one another at least until the matching has occurred;
the individual receives automated notification of a match responsive to the matching of the job criteria with the profile qualifications of the individual;
the prospective employer's identity is first revealed to the individual in the notification; and
the individual remains anonymous to the prospective employer until after responding to the notification and after opting to identify himself to the prospective employer.

8. The employment recruiting system of claim 1 further comprising a dossier database that includes a dossier for each individual who has applied for an activated job definition in the CASE database and wherein each dossier includes at least subject-level qualifications and preferences for the respective individual.

9. The employment recruiting system of claim 8 wherein each newly instantiated dossier is at least partially pre-populated with subject-level qualifications and preferences drawn from the profile for the respective individual.

10. The employment recruiting system of claim 8 wherein the subject-level qualifications and preferences of an individual's dossier in the dossier database may be automatically updated in response to the individual's applying for a different activated job definition in the CASE database.

11. The employment recruiting system of claim 1 further comprising a dossier database that includes a dossier for each individual who has applied for an activated job definition in the CASE database, wherein each dossier includes at least subject-level qualifications and preferences for the respective individual and wherein each newly instantiated dossier is at least partially pre-populated with subject-level qualifications and preferences of the profile for the respective individual.

12. The employment recruiting system of claim 1 wherein at least one of the subject-level job criteria of at least one of the job definitions is linked to at least one predetermined synonym.

13. The employment recruiting system of claim 1 wherein the information manager performs subject-level matching between the CASE database and the workforce-profile database responsive to activation of a new job definition.

14. The employment recruiting system of claim 1 wherein the information manager performs subject-level matching between the CASE database and the workforce-profile database responsive to a periodic timer.

15. The employment recruiting system of claim 1 wherein the information manager performs subject-level matching between the CASE database and the workforce-profile database responsive to modification of a previously activated job definition.

16. The employment recruiting system of claim 1 wherein the information manager performs subject-level matching between the CASE database and the workforce-profile database responsive to activation of a new profile.

17. The employment recruiting system of claim 1 wherein the subject-level job criteria and the subject-level individual qualifications are unique and multi-dimensional.

18. The employment recruiting system of claim 1 wherein the subject-level job criteria and the subject-level individual qualifications selectively support multiple orthogonal dimensions selected from the group consisting of years of experience, proficiency, customized answer lists and boolean.

19. An automated method of matching qualified individuals with job definitions using a computerized employment recruiting system of the type having a CASE database of job definitions of a prospective employer, each of the job definitions having question-independent subject-level job criteria and job offerings, having a workforce-profile database of individual profiles, each of the profiles having question-independent subject-level individual qualifications and individual preferences, having a communications port for user access to the system, and having an information manager interacting with the CASE database, the workforce-profile database and the communications port, the method comprising:
comparing the question-independent subject-level job criteria of the CASE database with the question-independent subject-level individual qualifications of the workforce-profile database; and
identifying individuals qualified for the job definition in response to detecting a match between predetermined ones of the question-independent subject-level criteria and qualifications.

20. The method of claim 19 further comprising activating a new job definition by a prospective employer and wherein the step of comparing automatically occurs responsive to new job activation.

21. The method of claim 19 further comprising activating a new individual profile by an individual and wherein the step of comparing comprises antecedent pre-qualification matching between the new profile and the job definitions in response to new profile activation.

22. The method of claim 19 further comprising activating a new individual profile by an individual, further comprising activating a new job definition by a prospective employer and wherein the step of comparing comprises both antecedent pre-qualification matching and matching responsive to new job activation.

23. The method of claim 19 further comprising the step of concealing the identity of the prospective employer from the individuals and the identity of the individuals from the prospective employer at least until the step of identifying qualified individuals has occurred.

24. The method of claim 19 further comprising the steps of notifying qualified individuals in response to the step of identifying qualified individuals and revealing the prospective employer's identity to the qualified individuals in the notification.

25. The method of claim 19 further comprising the steps of receiving a notification response from an individual including an indication that the individual wishes to identify himself to the prospective employer and concealing the individual's identity from the prospective employers until after the step of receiving.

26. The method of claim 19 further comprising the step of instantiating a dossier in a database for each qualified individual who has applied for an activated job definition in the CASE database, wherein each instantiated dossier includes at least subject-level qualifications and preferences for the qualified individual.

27. The method of claim 19 further comprising the step of at least partially pre-populating the newly instantiated dossier with subject-level qualifications and preferences of the profile for the qualified individual.
